(19) United States
(12) Patent Application Publication
(10) Pub. No.: US 2025/0301492 A1
(43) Pub. Date: Sep. 25, 2025

(54) USER EQUIPMENT INFORMATION FOR ENHANCING MULTI-CARRIER COMMUNICATIONS

(71) Applicant: QUALCOMM Incorporated, San Diego, CA (US)

(72) Inventors: Kianoush HOSSEINI, San Diego, CA (US); Umesh PHUYAL, San Diego, CA (US); Jing LEI, San Diego, CA (US); Kazuki TAKEDA, Minato-ku (JP)

(21) Appl. No.: 18/610,991

(22) Filed: Mar. 20, 2024

(51) Int. Cl. H04W 72/52; H04L 5/00

(52) U.S. Cl. CPC H04W 72/52; H04L 5/0035; H04L 5/0053

(57) ABSTRACT

Various aspects of the present disclosure generally relate to wireless communication. In some aspects, a user equipment (UE) may transmit at least one of first information associated with splitting a data volume across a first cell group and a second cell group, or second information associated with sharing UE resources across the first cell group and the second cell group. The UE may communicate via the first cell group and the second cell group in accordance with at least one of a split of the data volume across the first cell group and the second cell group based at least in part on the first information, or an allocation of the UE resources across the first cell group and the second cell group based at least in part on the second information. Numerous other aspects are described.

### FIELD OF THE DISCLOSURE

Aspects of the present disclosure generally relate to wireless communication and specifically relate to techniques, apparatuses, and methods for user equipment information for enhancing multi-carrier communications.

### BACKGROUND

Wireless communication systems are widely deployed to provide various services that may include carrying voice, text, messaging, video, data, and/or other traffic. The services may include unicast, multicast, and/or broadcast services, among other examples. Typical wireless communication systems may employ multiple-access radio access technologies (RATs) capable of supporting communication with multiple users by sharing available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

The above multiple-access RATs have been adopted in various telecommunication standards to provide common protocols that enable different wireless communication devices to communicate on a municipal, national, regional, or global level. An example telecommunication standard is New Radio (NR). NR, which may also be referred to as 5G, is part of a continuous mobile broadband evolution promulgated by the Third Generation Partnership Project (3GPP). NR (and other mobile broadband evolutions beyond NR) may be designed to better support Internet of things (IoT) and reduced capability device deployments, industrial connectivity, millimeter wave (mmWave) expansion, licensed and unlicensed spectrum access, non-terrestrial network (NTN) deployment, sidelink and other device-to-device direct communication technologies (for example, cellular vehicle-to-everything (CV2X) communication), massive multiple-input multiple-output (MIMO), disaggregated network architectures and network topology expansions, multiple-subscriber implementations, high-precision positioning, and/or radio frequency (RF) sensing, among other examples. As the demand for mobile broadband access continues to increase, further improvements in NR may be implemented, and other radio access technologies such as 6G may be introduced, to further advance mobile broadband evolution.

### SUMMARY

Some aspects described herein relate to a user equipment (UE) for wireless communication. The UE may include one or more memories and one or more processors coupled to the one or more memories. The one or more processors may be configured to cause the UE to transmit, to at least one of a first network node associated with a first cell group or a second network node associated with a second cell group, at least one of, first information associated with splitting a data volume across the first cell group and the second cell group, or second information associated with sharing UE resources across the first cell group and the second cell group. The one or more processors may be configured to cause the UE to communicate via the first cell group and the second cell group in accordance with at least one of, a split of the data volume across the first cell group and the second cell group based at least in part on the first information, or an allocation of the UE resources across the first cell group and the second cell group based at least in part on the second information.

Some aspects described herein relate to a first network node for wireless communication. The first network node may include one or more memories and one or more processors coupled to the one or more memories. The one or more processors may be configured to cause the first network node to receive, from a UE, at least one of, first information associated with splitting a data volume across a first cell group associated with the first network node and a second cell group associated with a second network node, or second information associated with sharing UE resources across the first cell group and the second cell group. The one or more processors may be configured to cause the first network node to communicate with the UE in accordance with at least one of, a split of the data volume across the first cell group and the second cell group based at least in part on the first information, or an allocation of the UE resources across the first cell group and the second cell group based at least in part on the second information.

Some aspects described herein relate to a first network node for wireless communication. The first network node may include one or more memories and one or more processors coupled to the one or more memories. The one or more processors may be configured to cause the first network node to receive, from a UE, first channel state information (CSI) associated with the UE and a first cell group. The one or more processors may be configured to cause the first network node to obtain, from a second network node, second CSI associated with the UE and a second cell group. The one or more processors may be configured to cause the first network node to transmit, to the UE, an indication of a split of a data volume across to the first cell group and the second cell group to be used for communications with the UE, wherein the split of the data volume across the first cell group and the second cell group is based at least in part on the first CSI and the second CSI.

Some aspects described herein relate to a method of wireless communication performed by a UE. The method may include transmitting, to at least one of a first network node associated with a first cell group or a second network node associated with a second cell group, at least one of, first information associated with splitting a data volume across the first cell group and the second cell group, or second information associated with sharing UE resources across the first cell group and the second cell group. The method may include communicating via the first cell group and the second cell group in accordance with at least one of, a split of the data volume across the first cell group and the second cell group based at least in part on the first information, or an allocation of the UE resources across the first cell group and the second cell group based at least in part on the second information.

Some aspects described herein relate to a method of wireless communication performed by a first network node. The method may include receiving, from a UE, at least one of, first information associated with splitting a data volume across a first cell group associated with the first network node and a second cell group associated with a second network node, or second information associated with sharing UE resources across the first cell group and the second cell group. The method may include communicating with the UE in accordance with at least one of, a split of the data volume across the first cell group and the second cell group based at least in part on the first information, or an allocation of the UE resources across the first cell group and the second cell group based at least in part on the second information.

Some aspects described herein relate to a method of wireless communication performed by a first network node. The method may include receiving, from a UE, first CSI associated with the UE and a first cell group. The method may include obtaining, from a second network node, second CSI associated with the UE and a second cell group. The method may include transmitting, to the UE, an indication of a split of a data volume across to the first cell group and the second cell group to be used for communications with the UE, wherein the split of the data volume across the first cell group and the second cell group is based at least in part on the first CSI and the second CSI.

Some aspects described herein relate to a non-transitory computer-readable medium that stores a set of instructions for wireless communication by a UE. The set of instructions, when executed by one or more processors of the UE, may cause the UE to transmit, to at least one of a first network node associated with a first cell group or a second network node associated with a second cell group, at least one of, first information associated with splitting a data volume across the first cell group and the second cell group, or second information associated with sharing UE resources across the first cell group and the second cell group. The set of instructions, when executed by one or more processors of the UE, may cause the UE to communicate via the first cell group and the second cell group in accordance with at least one of, a split of the data volume across the first cell group and the second cell group based at least in part on the first information, or an allocation of the UE resources across the first cell group and the second cell group based at least in part on the second information.

Some aspects described herein relate to a non-transitory computer-readable medium that stores a set of instructions for wireless communication by a first network node. The set of instructions, when executed by one or more processors of the first network node, may cause the first network node to receive, from a UE, at least one of, first information associated with splitting a data volume across a first cell group associated with the first network node and a second cell group associated with a second network node, or second information associated with sharing UE resources across the first cell group and the second cell group. The set of instructions, when executed by one or more processors of the first network node, may cause the first network node to communicate with the UE in accordance with at least one of, a split of the data volume across the first cell group and the second cell group based at least in part on the first information, or an allocation of the UE resources across the first cell group and the second cell group based at least in part on the second information.

Some aspects described herein relate to a non-transitory computer-readable medium that stores a set of instructions for wireless communication by a first network node. The set of instructions, when executed by one or more processors of the first network node, may cause the first network node to receive, from a UE, first CSI associated with the UE and a first cell group. The set of instructions, when executed by one or more processors of the first network node, may cause the first network node to obtain, from a second network node, second CSI associated with the UE and a second cell group. The set of instructions, when executed by one or more processors of the first network node, may cause the first network node to transmit, to the UE, an indication of a split of a data volume across to the first cell group and the second cell group to be used for communications with the UE, wherein the split of the data volume across the first cell group and the second cell group is based at least in part on the first CSI and the second CSI.

Some aspects described herein relate to an apparatus for wireless communication. The apparatus may include means for transmitting, to at least one of a first network node associated with a first cell group or a second network node associated with a second cell group, at least one of, first information associated with splitting a data volume across the first cell group and the second cell group, or second information associated with sharing UE resources across the first cell group and the second cell group. The apparatus may include means for communicating via the first cell group and the second cell group in accordance with at least one of, a split of the data volume across the first cell group and the second cell group based at least in part on the first information, or an allocation of the UE resources across the first cell group and the second cell group based at least in part on the second information.

Some aspects described herein relate to an apparatus for wireless communication. The apparatus may include means for receiving, from a UE, at least one of, first information associated with splitting a data volume across a first cell group associated with the apparatus and a second cell group associated with a network node, or second information associated with sharing UE resources across the first cell group and the second cell group. The apparatus may include means for communicating with the UE in accordance with at least one of, a split of the data volume across the first cell group and the second cell group based at least in part on the first information, or an allocation of the UE resources across the first cell group and the second cell group based at least in part on the second information.

Some aspects described herein relate to an apparatus for wireless communication. The apparatus may include means for receiving, from a UE, first CSI associated with the UE and a first cell group. The apparatus may include means for obtaining, from a network node, second CSI associated with the UE and a second cell group. The apparatus may include means for transmitting, to the UE, an indication of a split of a data volume across to the first cell group and the second cell group to be used for communications with the UE, wherein the split of the data volume across the first cell group and the second cell group is based at least in part on the first CSI and the second CSI.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, the specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure, but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network in accordance with the present disclosure.

FIG. 2 is a diagram illustrating an example network node in communication with an example user equipment (UE) in a wireless network in accordance with the present disclosure.

FIG. 3 is a diagram illustrating an example disaggregated base station architecture in accordance with the present disclosure.

FIG. 4 is a diagram illustrating examples of carrier aggregation (CA), in accordance with the present disclosure.

FIG. 5 is a diagram illustrating an example of dual connectivity (DC), in accordance with various aspects of the present disclosure.

FIGS. 6-8 are diagrams illustrating examples associated with enhanced resource management for DC.

FIGS. 9-11 are diagrams illustrating examples associated with enhanced resource management for DC with dynamic sharing of UE resources.

FIG. 12 is a diagram illustrating an example process performed, for example, at a UE or an apparatus of a UE, in accordance with the present disclosure.

FIG. 13 is a diagram illustrating an example process performed, for example, at a first network node or an apparatus of a first network node, in accordance with the present disclosure.

FIG. 14 is a diagram illustrating an example process performed, for example, at a first network node or an apparatus of a first network node, in accordance with the present disclosure.

FIGS. 15-16 are diagrams of example apparatuses for wireless communication, in accordance with the present disclosure.

### DETAILED DESCRIPTION

Various aspects of the present disclosure are described hereinafter with reference to the accompanying drawings. However, aspects of the present disclosure may be embodied in many different forms and is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

A user equipment (UE) may be configured for multi-carrier operations, such as carrier aggregation (CA) and dual connectivity (DC). CA is a multi-carrier operating mode that enables two or more component carriers (CCs) to be combined (e.g., into a single channel) for a UE to enhance data capacity. CCs can be combined in the same or different frequency bands. DC is a multi-carrier operating mode in which a UE may communicate with two network nodes in order to increase bandwidth and decrease traffic latency. One network node acts as a master node (MN) and the other network node acts as a secondary node (SN). In DC, the MN may communicate with the UE via a master cell group (MCG) that may include one or more serving cells (e.g., one or more CCs), and the SN may communicate with the UE via a secondary cell group (SCG) that may include one or more serving cells (e.g., one or more CCs).

DC is widely used in scenarios in which a single distributed unit (DU) cannot control a set of aggregated serving cells, such as in non-co-located deployments and/or inter-frequency range aggregations with different gNB disaggregation (e.g., for FR1+FR2 CA). However, in some examples, assuming the same number of CCs configured/activated for a UE in both CA and DC modes, CA may outperform DC. One reason why CA may outperform DC is that, in CA, a single medium access control (MAC) entity controls all downlink and uplink resources across the aggregated CCs. Hence, with feedback relating to channel conditions from a UE, a DU can make the best decision possible for coordinating resource management for downlink and uplink communications. In DC, each cell group (e.g., the MCG and the SCG) may be controlled by a separate DU. Although there may be some coordination between the MN and the SN (for example, to ensure configuration consistency with UE capabilities and measurements), each DU typically bases decisions for scheduling downlink and uplink communications only on local information associated with that DU. For example, in a scenario in which a UE is configurated with 4 CCs in CA, all 4 CCs are under control of one MAC entity. In this case, the DU is aware of the instantaneous link quality of the UE on each of the 4 CCs in downlink and uplink. In a scenario in which a UE is configured with 4 CCs in DC, 2 CCs are controlled by the MN and 2 CCs are controlled by the SN. The MN DU is aware of the link quality of the UE on each of its own 2 CCs in downlink and uplink, and the SN DU is aware of the link quality of the UE on each of its own 2 CCs in downlink and uplink. However, the MN DU does not know the link quality of the UE on the 2 CCs belonging to the SN, and the SN DU does not know the link quality of the UE on the 2 CCs belonging to the MN.

In CA, the DU can route data with optimal link parameters to transmit the data to the UE or receive the data from the UE based on downlink and uplink channel estimates and buffer status reports (BSRs) across all logical channels. For example, if one CC is in poor condition, all other 3 CCs may be used. In DC, for both downlink and uplink, data may be split across resources in the MCG and the SCG based on reference signal received power (RSRP) and total available bandwidth (BW). However, channel conditions are not considered when deciding whether the MCG and/or the SCG should be used and how much of the resources at the MCG and/or the SCG should be used.

A UE reports capabilities of the UE for band combinations where DC is supported. However, other than reporting the UE capabilities, the UE may have a minimal role in managing how resources of the UE (e.g., including baseband resources, radio frequency (RF) chains, and/or antennas) will be used across CCs of the MCG and the SCG. In particular, in certain conditions, the UE can transmit UE assistance information (UAI) to make a request for change of some configurations, but the final decision can only be made by the network. The UE may only indicate a preference to reduce some configurations, and there is no mechanism for the UE to indicate whether the UE can do more. The UE can indicate a preference for each cell group separately, but there is no joint indication such that a UE can reduce a set of configurations on one cell group, while increasing the set of configurations on the other cell group. The indications are carried via radio resource control (RRC) signaling and their transmissions are subjected to a prohibit timer. The changes, if granted by the network, will take a long time to become effective. Hence, UAI cannot be used to adapt the configurations quickly.

For DC, the network decides how much data goes through which cell group. When the available BW is small, the network uses both the MCG and the SCG to aggregate a larger BW and enhance throughput. For uplink, the network sets a data threshold that determines how much data is to be transmitted on each cell group, and the data threshold is dependent on the RSRP (e.g., the UE location in the cell) and the total BW in the MCG and the SCG. In DC, decisions on how the resources should be used are taken at a slow rate (e.g., as opposed to CA). The MN and the SN may evaluate RSRPs of the UE (and possible exchange values). The MN and SN may then determine a buffer threshold solely based on the total available BW in each cell group. However, from a data rate standpoint, not considering at least the channel conditions in scheduling decisions across all of the resources of MCG and the SCG results in a sub-optimal operating point with reduced throughput and increased latency.

Various aspects relate generally to UE information for enhancing multi-carrier operations. Some aspects more specifically relate to incorporating channel conditions in decisions for splitting a data volume across an MCG and an SCG in DC and/or decisions for allocating UE resources across the MCG and the SCG. The term “data volume,” as used herein, may refer to a certain amount of data. In some aspects, a UE may transmit, to at least one of a first network node or a second network node, first information associated with splitting network resources across a first cell group and a second cell group, and/or second information associated with sharing UE resources across the first cell group and the second cell group. For example, the first information may be associated with splitting a data volume across the first cell group and the second cell group. The UE may communicate via the first cell group and the second cell group in accordance with a split of the data volume across the first cell group and the second cell group based at least in part on the first information and/or an allocation of the UE resources across the first cell group and the second cell group based at least in part on the second information. In some aspects, the first information may be based at least in part on channel estimates for CCs of the first cell group and the second cell group, and the split of the data volume across the first cell group and the second cell group may be determined (e.g., by the UE or at least one of the first network node or the second network node) based at least in part on the first information. In some aspects, the second information may be based at least in part on channel estimates for the CCs of the first cell group and the second cell group, and the allocation of the UE resources across the first cell group and the second cell group may be determined (e.g., by the UE or at least one of the first network node or the second network node) based on the second information.

Particular aspects of the subject matter described in this disclosure can be implemented to realize one or more of the following potential advantages. In some examples, by splitting the data volume in accordance with the first information that is based at least in part on the channel estimates for the first cell group and the second cell group, the described techniques can be used to improve selection of resources across the MCG and the SCG for downlink and uplink, resulting in increased downlink and uplink throughput and reduced latency in DC. In some examples, by allocating UE resources in accordance with the second information that is based at least in part on the channel estimates for the first cell group and the second cell group, the described techniques can be used to improve and/or optimize performance of downlink and uplink in each cell group. This may increase the uplink and downlink throughput and reduce latency in DC, as well as enhance network spectral efficiency and reduce network power consumption by preventing the network from allocating time domain (TD) and/or frequency domain (FD) resources to a UE with a bad channel condition on a link when the UE can be served more efficiently on other links.

Multiple-access radio access technologies (RATs) have been adopted in various telecommunication standards to provide common protocols that enable wireless communication devices to communicate on a municipal, enterprise, national, regional, or global level. For example, 5G New Radio (NR) is part of a continuous mobile broadband evolution promulgated by the Third Generation Partnership Project (3GPP). 5G NR supports various technologies and use cases including enhanced mobile broadband (eMBB), ultra-reliable low-latency communication (URLLC), massive machine-type communication (mMTC), millimeter wave (mmWave) technology, beamforming, network slicing, edge computing, Internet of Things (IoT) connectivity and management, and network function virtualization (NFV).

As the demand for broadband access increases and as technologies supported by wireless communication networks evolve, further technological improvements may be adopted in or implemented for 5G NR or future RATs, such as 6G, to further advance the evolution of wireless communication for a wide variety of existing and new use cases and applications. Such technological improvements may be associated with new frequency band expansion, licensed and unlicensed spectrum access, overlapping spectrum use, small cell deployments, non-terrestrial network (NTN) deployments, disaggregated network architectures and network topology expansion, device aggregation, advanced duplex communication, sidelink and other device-to-device direct communication, IoT (including passive or ambient IoT) networks, reduced capability (RedCap) UE functionality, industrial connectivity, multiple-subscriber implementations, high-precision positioning, RF sensing, and/or artificial intelligence or machine learning (AI/ML), among other examples. These technological improvements may support use cases such as wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples. The methods, operations, apparatuses, and techniques described herein may enable one or more of the foregoing technologies and/or support one or more of the foregoing use cases.

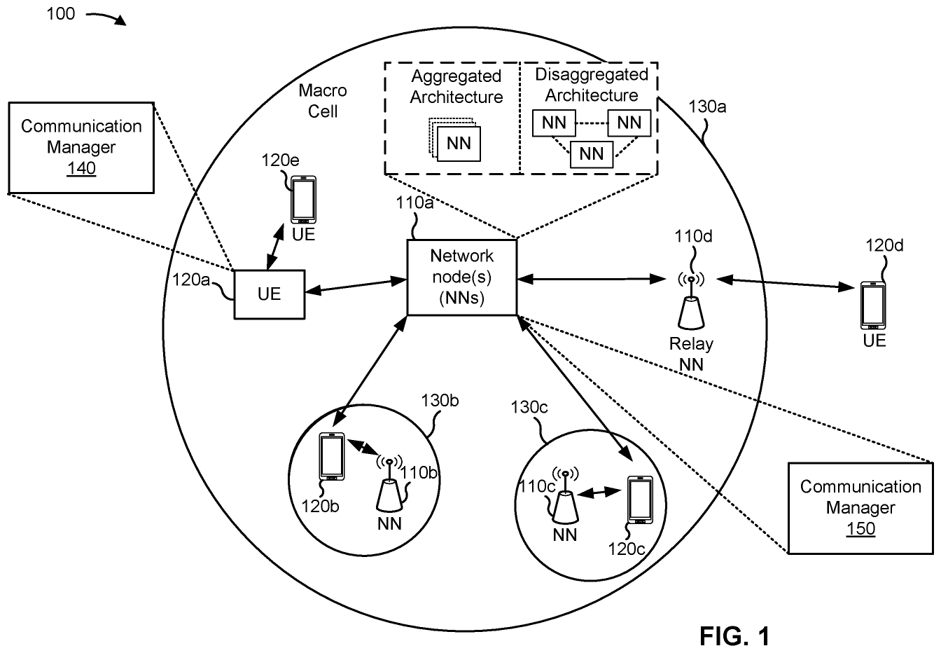

FIG. 1 is a diagram illustrating an example of a wireless communication network 100 in accordance with the present disclosure. The wireless communication network 100 may be or may include elements of a 5G (or NR) network or a 6G network, among other examples. The wireless communication network 100 may include multiple network nodes 110, shown as a network node (NN) 110a, a network node 110b, a network node 110c, and a network node 110d. The network nodes 110 may support communications with multiple UEs 120, shown as a UE 120a, a UE 120b, a UE 120c, a UE 120d, and a UE 120c.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless networks 100 may be deployed in a given geographic area. Each wireless communication network 100 may support a particular RAT (which may also be referred to as an air interface) and may operate on one or more carrier frequencies in one or more frequency ranges. Examples of RATs include a 4G RAT, a 5G/NR RAT, and/or a 6G RAT, among other examples. In some examples, when multiple RATs are deployed in a given geographic area, each RAT in the geographic area may operate on different frequencies to avoid interference with one another.

Various operating bands have been defined as frequency range designations FR1 (410 MHz through 7.125 GHZ), FR2 (24.25 GHz through 52.6 GHz), FR3 (7.125 GHZ through 24.25 GHZ), FR4a or FR4-1 (52.6 GHz through 71 GHZ), FR4 (52.6 GHZ through 114.25 GHZ), and FR5 (114.25 GHz through 300 GHz). Although a portion of FR1 is greater than 6 GHZ, FR1 is often referred to (interchangeably) as a “Sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into mid-band frequencies. Thus, “sub-6 GHz,” if used herein, may broadly refer to frequencies that are less than 6 GHZ, that are within FR1, and/or that are included in mid-band frequencies. Similarly, the term “millimeter wave,” if used herein, may broadly refer to frequencies that are included in mid-band frequencies, that are within FR2, FR4, FR4-a or FR4-1, or FR5, and/or that are within the EHF band. Higher frequency bands may extend 5G NR operation, 6G operation, and/or other RATs beyond 52.6 GHz. For example, each of FR4a, FR4-1, FR4, and FR5 falls within the EHF band. In some examples, the wireless communication network 100 may implement dynamic spectrum sharing (DSS), in which multiple RATs (for example, 4G/LTE and 5G/NR) are implemented with dynamic bandwidth allocation (for example, based on user demand) in a single frequency band. It is contemplated that the frequencies included in these operating bands (for example, FR1, FR2, FR3, FR4, FR4-a, FR4-1, and/or FR5) may be modified, and techniques described herein may be applicable to those modified frequency ranges.

A network node 110 may include one or more devices, components, or systems that enable communication between a UE 120 and one or more devices, components, or systems of the wireless communication network 100. A network node 110 may be, may include, or may also be referred to as an NR network node, a 5G network node, a 6G network node, a Node B, an eNB, a gNB, an access point (AP), a transmission reception point (TRP), a mobility element, a core, a network entity, a network element, a network equipment, and/or another type of device, component, or system included in a radio access network (RAN).

A network node 110 may be implemented as a single physical node (for example, a single physical structure) or may be implemented as two or more physical nodes (for example, two or more distinct physical structures). For example, a network node 110 may be a device or system that implements part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node (having an aggregated architecture), meaning that the network node 110 may implement a full radio protocol stack that is physically and logically integrated within a single node (for example, a single physical structure) in the wireless communication network 100. For example, an aggregated network node 110 may consist of a single standalone base station or a single TRP that uses a full radio protocol stack to enable or facilitate communication between a UE 120 and a core network of the wireless communication network 100.

Alternatively, and as also shown, a network node 110 may be a disaggregated network node (sometimes referred to as a disaggregated base station), meaning that the network node 110 may implement a radio protocol stack that is physically distributed and/or logically distributed among two or more nodes in the same geographic location or in different geographic locations. For example, a disaggregated network node may have a disaggregated architecture. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating base station functionality into multiple units that can be individually deployed.

The network nodes 110 of the wireless communication network 100 may include one or more central units (CUs), one or more DUs, and/or one or more radio units (RUS). A CU may host one or more higher layer control functions, such as RRC functions, packet data convergence protocol (PDCP) functions, and/or service data adaptation protocol (SDAP) functions, among other examples. A DU may host one or more of a radio link control (RLC) layer, a MAC layer, and/or one or more higher physical (PHY) layers depending, at least in part, on a functional split, such as a functional split defined by the 3GPP. In some examples, a DU also may host one or more lower PHY layer functions, such as a fast Fourier transform (FFT), an inverse FFT (iFFT), beamforming, physical random access channel (PRACH) extraction and filtering, and/or scheduling of resources for one or more UEs 120, among other examples. An RU may host RF processing functions or lower PHY layer functions, such as an FFT, an iFFT, beamforming, or PRACH extraction and filtering, among other examples, according to a functional split, such as a lower layer functional split. In such an architecture, each RU can be operated to handle over the air (OTA) communication with one or more UEs 120.

In some aspects, a single network node 110 may include a combination of one or more CUs, one or more DUs, and/or one or more RUs. Additionally or alternatively, a network node 110 may include one or more Near-Real Time (Near-RT) RAN Intelligent Controllers (RICs) and/or one or more Non-Real Time (Non-RT) RICs. In some examples, a CU, a DU, and/or an RU may be implemented as a virtual unit, such as a virtual central unit (VCU), a virtual distributed unit (VDU), or a virtual radio unit (VRU), among other examples. A virtual unit may be implemented as a virtual network function, such as associated with a cloud deployment.

Some network nodes 110 (for example, a base station, an RU, or a TRP) may provide communication coverage for a particular geographic area. In the 3GPP, the term “cell” can refer to a coverage area of a network node 110 or to a network node 110 itself, depending on the context in which the term is used. A network node 110 may support one or multiple (for example, three) cells. In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In some examples, a cell may not necessarily be stationary. For example, the geographic area of the cell may move according to the location of an associated mobile network node 110 (for example, a train, a satellite base station, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. In the example shown in FIG. 1, the network node 110a may be a macro network node for a macro cell 130a, the network node 110b may be a pico network node for a pico cell 130b, and the network node 110c may be a femto network node for a femto cell 130c. Various different types of network nodes 110 may generally transmit at different power levels, serve different coverage areas, and/or have different impacts on interference in the wireless communication network 100 than other types of network nodes 110. For example, macro network nodes may have a high transmit power level (for example, 5 to 40 watts), whereas pico network nodes, femto network nodes, and relay network nodes may have lower transmit power levels (for example, 0.1 to 2 watts).

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink channels may include one or more control channels and one or more data channels. A downlink control channel may be used to transmit downlink control information (DCI) (for example, scheduling information, reference signals, and/or configuration information) from a network node 110 to a UE 120. A downlink data channel may be used to transmit downlink data (for example, user data associated with a UE 120) from a network node 110 to a UE 120. Downlink control channels may include one or more physical downlink control channels (PDCCHs), and downlink data channels may include one or more physical downlink shared channels (PDSCHs). Uplink channels may similarly include one or more control channels and one or more data channels. An uplink control channel may be used to transmit uplink control information (UCI) (for example, reference signals and/or feedback corresponding to one or more downlink transmissions) from a UE 120 to a network node 110. An uplink data channel may be used to transmit uplink data (for example, user data associated with a UE 120) from a UE 120 to a network node 110. Uplink control channels may include one or more physical uplink control channels (PUCCHs), and uplink data channels may include one or more physical uplink shared channels (PUSCHs). The downlink and the uplink may each include a set of resources on which the network node 110 and the UE 120 may communicate.

Downlink and uplink resources may include time domain resources (frames, subframes, slots, and/or symbols), frequency domain resources (frequency bands, component carriers, subcarriers, resource blocks, and/or resource elements), and/or spatial domain resources (particular transmit directions and/or beam parameters). Frequency domain resources of some bands may be subdivided into bandwidth parts (BWPs). A BWP may be a continuous block of frequency domain resources (for example, a continuous block of resource blocks) that are allocated for one or more UEs 120. A UE 120 may be configured with both an uplink BWP and a downlink BWP (where the uplink BWP and the downlink BWP may be the same BWP or different BWPs). A BWP may be dynamically configured (for example, by a network node 110 transmitting a DCI configuration to the one or more UEs 120) and/or reconfigured, which means that a BWP can be adjusted in real-time (or near-real-time) based on changing network conditions in the wireless communication network 100 and/or based on the specific requirements of the one or more UEs 120. This enables more efficient use of the available frequency domain resources in the wireless communication network 100 because fewer frequency domain resources may be allocated to a BWP for a UE 120 (which may reduce the quantity of frequency domain resources that a UE 120 is required to monitor), leaving more frequency domain resources to be spread across multiple UEs 120. Thus, BWPs may also assist in the implementation of lower-capability UEs 120 by facilitating the configuration of smaller bandwidths for communication by such UEs 120.

As described above, in some aspects, the wireless communication network 100 may be, may include, or may be included in, an IAB network. In an IAB network, at least one network node 110 is an anchor network node that communicates with a core network. An anchor network node 110 may also be referred to as an IAB donor (or “IAB-donor”). The anchor network node 110 may connect to the core network via a wired backhaul link. For example, an Ng interface of the anchor network node 110 may terminate at the core network. Additionally or alternatively, an anchor network node 110 may connect to one or more devices of the core network that provide a core access and mobility management function (AMF). An IAB network also generally includes multiple non-anchor network nodes 110, which may also be referred to as relay network nodes or simply as IAB nodes (or “IAB-nodes”). Each non-anchor network node 110 may communicate directly with the anchor network node 110 via a wireless backhaul link to access the core network, or may communicate indirectly with the anchor network node 110 via one or more other non-anchor network nodes 110 and associated wireless backhaul links that form a backhaul path to the core network. Some anchor network node 110 or other non-anchor network node 110 may also communicate directly with one or more UEs 120 via wireless access links that carry access traffic. In some examples, network resources for wireless communication (such as time resources, frequency resources, and/or spatial resources) may be shared between access links and backhaul links.

In some examples, any network node 110 that relays communications may be referred to as a relay network node, a relay station, or simply as a relay. A relay may receive a transmission of a communication from an upstream station (for example, another network node 110 or a UE 120) and transmit the communication to a downstream station (for example, a UE 120 or another network node 110). In this case, the wireless communication network 100 may include or be referred to as a “multi-hop network.” In the example shown in FIG. 1, the network node 110d (for example, a relay network node) may communicate with the network node 110a (for example, a macro network node) and the UE 120d in order to facilitate communication between the network node 110a and the UE 120d. Additionally or alternatively, a UE 120 may be or may operate as a relay station that can relay transmissions to or from other UEs 120. A UE 120 that relays communications may be referred to as a UE relay or a relay UE, among other examples.

The UEs 120 may be physically dispersed throughout the wireless communication network 100, and each UE 120 may be stationary or mobile. A UE 120 may be, may include, or may be included in an access terminal, another terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, and/or smart jewelry, such as a smart ring or a smart bracelet), an entertainment device (for example, a music device, a video device, and/or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

A UE 120 and/or a network node 110 may include one or more chips, system-on-chips (SoCs), chipsets, packages, or devices that individually or collectively constitute or comprise a processing system. The processing system includes processor (or “processing”) circuitry in the form of one or multiple processors, microprocessors, processing units (such as central processing units (CPUs), graphics processing units (GPUs), neural processing units (NPUs) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set, or may include the group of processors all being configured or configurable to perform the set of functions.

The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code (such as software) that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G, or 6G compliant) modem). In some implementations, one or more processors of the processing system include or implement one or more of the modems. The processing system may further include or be coupled with multiple radios (collectively “the radio”), multiple RF chains, or multiple transceivers, each of which may in turn be coupled with one or more of multiple antennas. In some implementations, one or more processors of the processing system include or implement one or more of the radios, RF chains or transceivers. The UE 120 may include or may be included in a housing that houses components associated with the UE 120 including the processing system.

Some UEs 120 may be considered machine-type communication (MTC) UEs, evolved or enhanced machine-type communication (eMTC), UEs, further enhanced eMTC (feMTC) UEs, or enhanced feMTC (efeMTC) UEs, or further evolutions thereof, all of which may be simply referred to as “MTC UEs”. An MTC UE may be, may include, or may be included in or coupled with a robot, an uncrewed aerial vehicle, a remote device, a sensor, a meter, a monitor, and/or a location tag. Some UEs 120 may be considered IoT devices and/or may be implemented as NB-IoT (narrowband IoT) devices. An IoT UE or NB-IoT device may be, may include, or may be included in or coupled with an industrial machine, an appliance, a refrigerator, a doorbell camera device, a home automation device, and/or a light fixture, among other examples. Some UEs 120 may be considered Customer Premises Equipment, which may include telecommunications devices that are installed at a customer location (such as a home or office) to enable access to a service provider's network (such as included in or in communication with the wireless communication network 100).

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, enhanced mobile broadband (eMBB), and/or precise positioning in the wireless communication network 100, among other examples. A third category of UEs 120 may have mid-tier complexity and/or capability (for example, a capability between UEs 120 of the first category and UEs 120 of the second capability). A UE 120 of the third category may be referred to as a reduced capacity UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, and/or cameras that are associated with a limited bandwidth, power capacity, and/or transmission range, among other examples. RedCap UEs may support healthcare environments, building automation, electrical distribution, process automation, transport and logistics, and/or smart city deployments, among other examples.

In some examples, two or more UEs 120 (for example, shown as UE 120a and UE 120c) may communicate directly with one another using sidelink communications (for example, without communicating by way of a network node 110 as an intermediary). As an example, the UE 120a may directly transmit data, control information, or other signaling as a sidelink communication to the UE 120c. This is in contrast to, for example, the UE 120a first transmitting data in an UL communication to a network node 110, which then transmits the data to the UE 120e in a DL communication. In various examples, the UEs 120 may transmit and receive sidelink communications using peer-to-peer (P2P) communication protocols, device-to-device (D2D) communication protocols, vehicle-to-everything (V2X) communication protocols (which may include vehicle-to-vehicle (V2V) protocols, vehicle-to-infrastructure (V2I) protocols, and/or vehicle-to-pedestrian (V2P) protocols), and/or mesh network communication protocols. In some deployments and configurations, a network node 110 may schedule and/or allocate resources for sidelink communications between UEs 120 in the wireless communication network 100. In some other deployments and configurations, a UE 120 (instead of a network node 110) may perform, or collaborate or negotiate with one or more other UEs to perform, scheduling operations, resource selection operations, and/or other operations for sidelink communications.

In various examples, some of the network nodes 110 and the UEs 120 of the wireless communication network 100 may be configured for full-duplex operation in addition to half-duplex operation. A network node 110 or a UE 120 operating in a half-duplex mode may perform only one of transmission or reception during particular time resources, such as during particular slots, symbols, or other time periods. Half-duplex operation may involve time-division duplexing (TDD), in which DL transmissions of the network node 110 and UL transmissions of the UE 120 do not occur in the same time resources (that is, the transmissions do not overlap in time). In contrast, a network node 110 or a UE 120 operating in a full-duplex mode can transmit and receive communications concurrently (for example, in the same time resources). By operating in a full-duplex mode, network nodes 110 and/or UEs 120 may generally increase the capacity of the network and the radio access link. In some examples, full-duplex operation may involve frequency-division duplexing (FDD), in which DL transmissions of the network node 110 are performed in a first frequency band or on a first component carrier and transmissions of the UE 120 are performed in a second frequency band or on a second component carrier different than the first frequency band or the first component carrier, respectively. In some examples, full-duplex operation may be enabled for a UE 120 but not for a network node 110. For example, a UE 120 may simultaneously transmit an UL transmission to a first network node 110 and receive a DL transmission from a second network node 110 in the same time resources. In some other examples, full-duplex operation may be enabled for a network node 110 but not for a UE 120. For example, a network node 110 may simultaneously transmit a DL transmission to a first UE 120 and receive an UL transmission from a second UE 120 in the same time resources. In some other examples, full-duplex operation may be enabled for both a network node 110 and a UE 120.

In some examples, the UEs 120 and the network nodes 110 may perform MIMO communication. “MIMO” generally refers to transmitting or receiving multiple signals (such as multiple layers or multiple data streams) simultaneously over the same time and frequency resources. MIMO techniques generally exploit multipath propagation. MIMO may be implemented using various spatial processing or spatial multiplexing operations. In some examples, MIMO may support simultaneous transmission to multiple receivers, referred to as multi-user MIMO (MU-MIMO). Some RATs may employ advanced MIMO techniques, such as mTRP operation (including redundant transmission or reception on multiple TRPs), reciprocity in the time domain or the frequency domain, single-frequency-network (SFN) transmission, or non-coherent joint transmission (NC-JT).

In some aspects, the UE 120 may include a communication manager 140. As described in more detail elsewhere herein, the communication manager 140 may transmit, to at least one of a first network node associated with a first cell group or a second network node associated with a second cell group, at least one of first information associated with splitting a data volume across the first cell group and the second cell group, or second information associated with sharing UE resources across the first cell group and the second cell group; and communicate via the first cell group and the second cell group in accordance with at least one of a split of the data volume across the first cell group and the second cell group based at least in part on the first information, or an allocation of the UE resources across the first cell group and the second cell group based at least in part on the second information. Additionally, or alternatively, the communication manager 140 may perform one or more other operations described herein.

In some aspects, the network node 110 may include a communication manager 150. As described in more detail elsewhere herein, the communication manager 150 may receive, from a UE, at least one of first information associated with splitting a data volume across a first cell group associated with the network node 110 and a second cell group associated with another network node, or second information associated with sharing UE resources across the first cell group and the second cell group; and communicate with the UE in accordance with at least one of a split of the data volume across the first cell group and the second cell group based at least in part on the first information, or an allocation of the UE resources across the first cell group and the second cell group based at least in part on the second information.

Additionally, or alternatively, as described in more detail elsewhere herein, the communication manager 150 may receive, from a UE, first channel state information (CSI) associated with the UE and a first cell group; obtain, from another network node, second CSI associated with the UE and a second cell group; and transmit, to the UE, an indication of a split of data volume across to the first cell group and the second cell group to be used for communications with the UE, wherein the split of the data volume across the first cell group and the second cell group is based at least in part on the first CSI and the second CSI. Additionally, or alternatively, the communication manager 150 may perform one or more other operations described herein.

As indicated above, FIG. 1 is provided as an example. Other examples may differ from what is described with regard to FIG. 1.

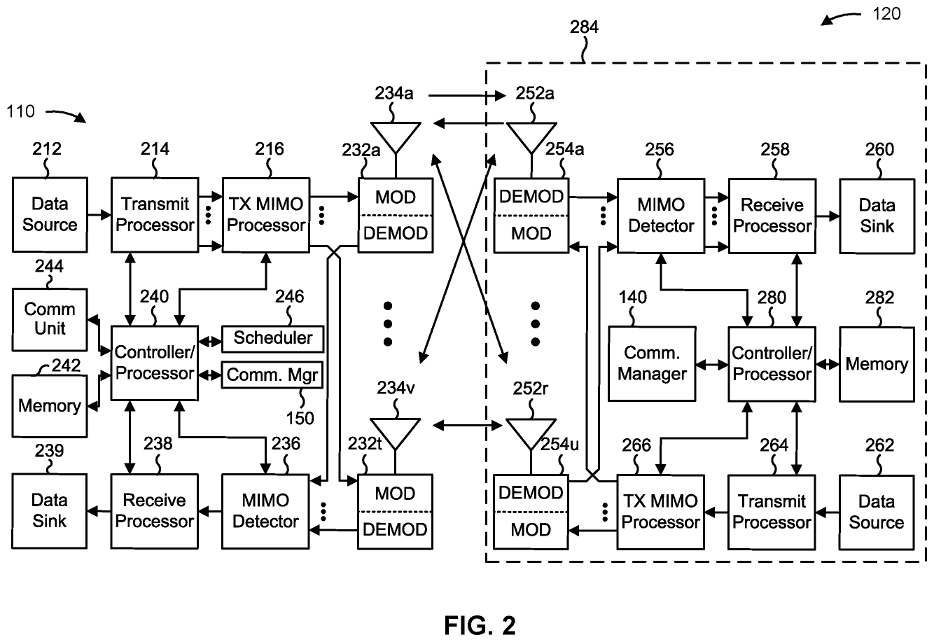

FIG. 2 is a diagram illustrating an example network node 110 in communication with an example UE 120 in a wireless network in accordance with the present disclosure.

As shown in FIG. 2, the network node 110 may include a data source 212, a transmit processor 214, a transmit (TX) MIMO processor 216, a set of modems 232 (shown as 232a through 232t, where t≥1), a set of antennas 234 (shown as 234a through 234v, where v≥1), a MIMO detector 236, a receive processor 238, a data sink 239, a controller/processor 240, a memory 242, a communication unit 244, a scheduler 246, and/or a communication manager 150, among other examples. In some configurations, one or a combination of the antenna(s) 234, the modem(s) 232, the MIMO detector 236, the receive processor 238, the transmit processor 214, and/or the TX MIMO processor 216 may be included in a transceiver of the network node 110. The transceiver may be under control of and used by one or more processors, such as the controller/processor 240, and in some aspects in conjunction with processor-readable code stored in the memory 242, to perform aspects of the methods, processes, and/or operations described herein. In some aspects, the network node 110 may include one or more interfaces, communication components, and/or other components that facilitate communication with the UE 120 or another network node.

The terms “processor,” “controller,” or “controller/processor” may refer to one or more controllers and/or one or more processors. For example, reference to “a/the processor,” “a/the controller/processor,” or the like (in the singular) should be understood to refer to any one or more of the processors described in connection with FIG. 2, such as a single processor or a combination of multiple different processors. Reference to “one or more processors” should be understood to refer to any one or more of the processors described in connection with FIG. 2. For example, one or more processors of the network node 110 may include transmit processor 214, TX MIMO processor 216, MIMO detector 236, receive processor 238, and/or controller/processor 240. Similarly, one or more processors of the UE 120 may include MIMO detector 256, receive processor 258, transmit processor 264, TX MIMO processor 266, and/or controller/processor 280.

In some aspects, a single processor may perform all of the operations described as being performed by the one or more processors. In some aspects, a first set of (one or more) processors of the one or more processors may perform a first operation described as being performed by the one or more processors, and a second set of (one or more) processors of the one or more processors may perform a second operation described as being performed by the one or more processors. The first set of processors and the second set of processors may be the same set of processors or may be different sets of processors. Reference to “one or more memories” should be understood to refer to any one or more memories of a corresponding device, such as the memory described in connection with FIG. 2. For example, operation described as being performed by one or more memories can be performed by the same subset of the one or more memories or different subsets of the one or more memories.

For downlink communication from the network node 110 to the UE 120, the transmit processor 214 may receive data (“downlink data”) intended for the UE 120 (or a set of UEs that includes the UE 120) from the data source 212 (such as a data pipeline or a data queue). In some examples, the transmit processor 214 may select one or more MCSs for the UE 120 in accordance with one or more channel quality indicators (CQIs) received from the UE 120. The network node 110 may process the data (for example, including encoding the data) for transmission to the UE 120 on a downlink in accordance with the MCS(s) selected for the UE 120 to generate data symbols. The transmit processor 214 may process system information (for example, semi-static resource partitioning information (SRPI)) and/or control information (for example, CQI requests, grants, and/or upper layer signaling) and provide overhead symbols and/or control symbols. The transmit processor 214 may generate reference symbols for reference signals (for example, a cell-specific reference signal (CRS), a demodulation reference signal (DMRS), or a CSI reference signal (CSI-RS)) and/or synchronization signals (for example, a primary synchronization signal (PSS) or a secondary synchronization signals (SSS)).

The TX MIMO processor 216 may perform spatial processing (for example, precoding) on the data symbols, the control symbols, the overhead symbols, and/or the reference symbols, if applicable, and may provide a set of output symbol streams (for example, T output symbol streams) to the set of modems 232. For example, each output symbol stream may be provided to a respective modulator component (shown as MOD) of a modem 232. Each modem 232 may use the respective modulator component to process (for example, to modulate) a respective output symbol stream (for example, for orthogonal frequency division multiplexing (OFDM)) to obtain an output sample stream. Each modem 232 may further use the respective modulator component to process (for example, convert to analog, amplify, filter, and/or upconvert) the output sample stream to obtain a time domain downlink signal. The modems 232a through 232t may together transmit a set of downlink signals (for example, T downlink signals) via the corresponding set of antennas 234.

A downlink signal may include a DCI communication, a MAC control element (MAC-CE) communication, an RRC communication, a downlink reference signal, or another type of downlink communication. Downlink signals may be transmitted on a PDCCH, a PDSCH, and/or on another downlink channel. A downlink signal may carry one or more transport blocks (TBs) of data. A TB may be a unit of data that is transmitted over an air interface in the wireless communication network 100. A data stream (for example, from the data source 212) may be encoded into multiple TBs for transmission over the air interface. The quantity of TBs used to carry the data associated with a particular data stream may be associated with a TB size common to the multiple TBs. The TB size may be based on or otherwise associated with radio channel conditions of the air interface, the MCS used for encoding the data, the downlink resources allocated for transmitting the data, and/or another parameter. In general, the larger the TB size, the greater the amount of data that can be transmitted in a single transmission, which reduces signaling overhead. However, larger TB sizes may be more prone to transmission and/or reception errors than smaller TB sizes, but such errors may be mitigated by more robust error correction techniques.

For uplink communication from the UE 120 to the network node 110, uplink signals from the UE 120 may be received by an antenna 234, may be processed by a modem 232 (for example, a demodulator component, shown as DEMOD, of a modem 232), may be detected by the MIMO detector 236 (for example, a receive (Rx) MIMO processor) if applicable, and/or may be further processed by the receive processor 238 to obtain decoded data and/or control information. The receive processor 238 may provide the decoded data to a data sink 239 (which may be a data pipeline, a data queue, and/or another type of data sink) and provide the decoded control information to a processor, such as the controller/processor 240.

The network node 110 may use the scheduler 246 to schedule one or more UEs 120 for downlink or uplink communications. In some aspects, the scheduler 246 may use DCI to dynamically schedule DL transmissions to the UE 120 and/or UL transmissions from the UE 120. In some examples, the scheduler 246 may allocate recurring time domain resources and/or frequency domain resources that the UE 120 may use to transmit and/or receive communications using an RRC configuration (for example, a semi-static configuration), for example, to perform semi-persistent scheduling (SPS) or to configure a configured grant (CG) for the UE 120.

One or more of the transmit processor 214, the TX MIMO processor 216, the modem 232, the antenna 234, the MIMO detector 236, the receive processor 238, and/or the controller/processor 240 may be included in an RF chain of the network node 110. An RF chain may include one or more filters, mixers, oscillators, amplifiers, analog-to-digital converters (ADCs), and/or other devices that convert between an analog signal (such as for transmission or reception via an air interface) and a digital signal (such as for processing by one or more processors of the network node 110). In some aspects, the RF chain may be or may be included in a transceiver of the network node 110.

In some examples, the network node 110 may use the communication unit 244 to communicate with a core network and/or with other network nodes. The communication unit 244 may support wired and/or wireless communication protocols and/or connections, such as Ethernet, optical fiber, common public radio interface (CPRI), and/or a wired or wireless backhaul, among other examples. The network node 110 may use the communication unit 244 to transmit and/or receive data associated with the UE 120 or to perform network control signaling, among other examples. The communication unit 244 may include a transceiver and/or an interface, such as a network interface.

The UE 120 may include a set of antennas 252 (shown as antennas 252a through 252r, where r≥1), a set of modems 254 (shown as modems 254a through 254u, where u≥1), a MIMO detector 256, a receive processor 258, a data sink 260, a data source 262, a transmit processor 264, a TX MIMO processor 266, a controller/processor 280, a memory 282, and/or a communication manager 140, among other examples. One or more of the components of the UE 120 may be included in a housing 284. In some aspects, one or a combination of the antenna(s) 252, the modem(s) 254, the MIMO detector 256, the receive processor 258, the transmit processor 264, or the TX MIMO processor 266 may be included in a transceiver that is included in the UE 120. The transceiver may be under control of and used by one or more processors, such as the controller/processor 280, and in some aspects in conjunction with processor-readable code stored in the memory 282, to perform aspects of the methods, processes, or operations described herein. In some aspects, the UE 120 may include another interface, another communication component, and/or another component that facilitates communication with the network node 110 and/or another UE 120.

For downlink communication from the network node 110 to the UE 120, the set of antennas 252 may receive the downlink communications or signals from the network node 110 and may provide a set of received downlink signals (for example, R received signals) to the set of modems 254. For example, each received signal may be provided to a respective demodulator component (shown as DEMOD) of a modem 254. Each modem 254 may use the respective demodulator component to condition (for example, filter, amplify, downconvert, and/or digitize) a received signal to obtain input samples. Each modem 254 may use the respective demodulator component to further demodulate or process the input samples (for example, for OFDM) to obtain received symbols. The MIMO detector 256 may obtain received symbols from the set of modems 254, may perform MIMO detection on the received symbols if applicable, and may provide detected symbols. The receive processor 258 may process (for example, decode) the detected symbols, may provide decoded data for the UE 120 to the data sink 260 (which may include a data pipeline, a data queue, and/or an application executed on the UE 120), and may provide decoded control information and system information to the controller/processor 280.

For uplink communication from the UE 120 to the network node 110, the transmit processor 264 may receive and process data (“uplink data”) from a data source 262 (such as a data pipeline, a data queue, and/or an application executed on the UE 120) and control information from the controller/processor 280. The control information may include one or more parameters, feedback, one or more signal measurements, and/or other types of control information. In some aspects, the receive processor 258 and/or the controller/processor 280 may determine, for a received signal (such as received from the network node 110 or another UE), one or more parameters relating to transmission of the uplink communication. The one or more parameters may include an RSRP parameter, a received signal strength indicator (RSSI) parameter, a reference signal received quality (RSRQ) parameter, a CQI parameter, or a transmit power control (TPC) parameter, among other examples. The control information may include an indication of the RSRP parameter, the RSSI parameter, the RSRQ parameter, the CQI parameter, the TPC parameter, and/or another parameter. The control information may facilitate parameter selection and/or scheduling for the UE 120 by the network node 110.

The transmit processor 264 may generate reference symbols for one or more reference signals, such as an uplink DMRS, an uplink sounding reference signal (SRS), and/or another type of reference signal. The symbols from the transmit processor 264 may be precoded by the TX MIMO processor 266, if applicable, and further processed by the set of modems 254 (for example, for DFT-s-OFDM or CP-OFDM). The TX MIMO processor 266 may perform spatial processing (for example, precoding) on the data symbols, the control symbols, the overhead symbols, and/or the reference symbols, if applicable, and may provide a set of output symbol streams (for example, U output symbol streams) to the set of modems 254. For example, each output symbol stream may be provided to a respective modulator component (shown as MOD) of a modem 254. Each modem 254 may use the respective modulator component to process (for example, to modulate) a respective output symbol stream (for example, for OFDM) to obtain an output sample stream. Each modem 254 may further use the respective modulator component to process (for example, convert to analog, amplify, filter, and/or upconvert) the output sample stream to obtain an uplink signal.

The modems 254a through 254u may transmit a set of uplink signals (for example, R uplink signals or U uplink symbols) via the corresponding set of antennas 252. An uplink signal may include a UCI communication, a MAC-CE communication, an RRC communication, or another type of uplink communication. Uplink signals may be transmitted on a PUSCH, a PUCCH, and/or another type of uplink channel. An uplink signal may carry one or more TBs of data. Sidelink data and control transmissions (that is, transmissions directly between two or more UEs 120) may generally use similar techniques as were described for uplink data and control transmission, and may use sidelink-specific channels such as a physical sidelink shared channel (PSSCH), a physical sidelink control channel (PSCCH), and/or a physical sidelink feedback channel (PSFCH).

One or more antennas of the set of antennas 252 or the set of antennas 234 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 2. As used herein, “antenna” can refer to one or more antennas, one or more antenna panels, one or more antenna groups, one or more sets of antenna elements, or one or more antenna arrays. “Antenna panel” can refer to a group of antennas (such as antenna elements) arranged in an array or panel, which may facilitate beamforming by manipulating parameters of the group of antennas. “Antenna module” may refer to circuitry including one or more antennas, which may also include one or more other components (such as filters, amplifiers, or processors) associated with integrating the antenna module into a wireless communication device.

In some examples, each of the antenna elements of an antenna 234 or an antenna 252 may include one or more sub-elements for radiating or receiving radio frequency signals. For example, a single antenna element may include a first sub-element cross-polarized with a second sub-element that can be used to independently transmit cross-polarized signals. The antenna elements may include patch antennas, dipole antennas, and/or other types of antennas arranged in a linear pattern, a two-dimensional pattern, or another pattern. A spacing between antenna elements may be such that signals with a desired wavelength transmitted separately by the antenna elements may interact or interfere constructively and destructively along various directions (such as to form a desired beam). For example, given an expected range of wavelengths or frequencies, the spacing may provide a quarter wavelength, a half wavelength, or another fraction of a wavelength of spacing between neighboring antenna elements to allow for the desired constructive and destructive interference patterns of signals transmitted by the separate antenna elements within that expected range.

The amplitudes and/or phases of signals transmitted via antenna elements and/or sub-elements may be modulated and shifted relative to each other (such as by manipulating phase shift, phase offset, and/or amplitude) to generate one or more beams, which is referred to as beamforming. The term “beam” may refer to a directional transmission of a wireless signal toward a receiving device or otherwise in a desired direction. “Beam” may also generally refer to a direction associated with such a directional signal transmission, a set of directional resources associated with the signal transmission (for example, an angle of arrival, a horizontal direction, and/or a vertical direction), and/or a set of parameters that indicate one or more aspects of a directional signal, a direction associated with the signal, and/or a set of directional resources associated with the signal. In some implementations, antenna elements may be individually selected or deselected for directional transmission of a signal (or signals) by controlling amplitudes of one or more corresponding amplifiers and/or phases of the signal(s) to form one or more beams. The shape of a beam (such as the amplitude, width, and/or presence of side lobes) and/or the direction of a beam (such as an angle of the beam relative to a surface of an antenna array) can be dynamically controlled by modifying the phase shifts, phase offsets, and/or amplitudes of the multiple signals relative to each other.

Different UEs 120 or network nodes 110 may include different numbers of antenna elements. For example, a UE 120 may include a single antenna element, two antenna elements, four antenna elements, eight antenna elements, or a different number of antenna elements. As another example, a network node 110 may include eight antenna elements, 24 antenna elements, 64 antenna elements, 128 antenna elements, or a different number of antenna elements. Generally, a larger number of antenna elements may provide increased control over parameters for beam generation relative to a smaller number of antenna elements, whereas a smaller number of antenna elements may be less complex to implement and may use less power than a larger number of antenna elements. Multiple antenna elements may support multiple-layer transmission, in which a first layer of a communication (which may include a first data stream) and a second layer of a communication (which may include a second data stream) are transmitted using the same time and frequency resources with spatial multiplexing.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

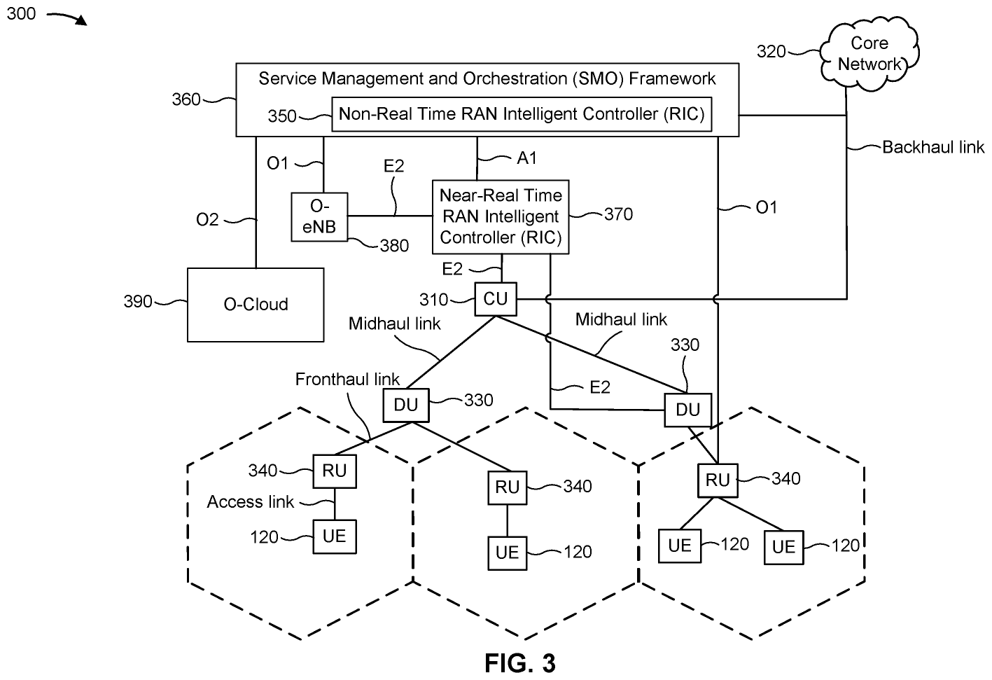

FIG. 3 is a diagram illustrating an example disaggregated base station architecture 300 in accordance with the present disclosure. One or more components of the example disaggregated base station architecture 300 may be, may include, or may be included in one or more network nodes (such one or more network nodes 110). The disaggregated base station architecture 300 may include a CU 310 that can communicate directly with a core network 320 via a backhaul link, or that can communicate indirectly with the core network 320 via one or more disaggregated control units, such as a Non-RT RIC 350 associated with a Service Management and Orchestration (SMO) Framework 360 and/or a Near-RT RIC 370 (for example, via an E2 link). The CU 310 may communicate with one or more DUs 330 via respective midhaul links, such as via F1 interfaces. Each of the DUs 330 may communicate with one or more RUs 340 via respective fronthaul links. Each of the RUs 340 may communicate with one or more UEs 120 via respective RF access links. In some deployments, a UE 120 may be simultaneously served by multiple RUs 340.

Each of the components of the disaggregated base station architecture 300, including the CUs 310, the DUs 330, the RUs 340, the Near-RT RICs 370, the Non-RT RICs 350, and the SMO Framework 360, may include one or more interfaces or may be coupled with one or more interfaces for receiving or transmitting signals, such as data or information, via a wired or wireless transmission medium.

In some aspects, the CU 310 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 310 may be deployed to communicate with one or more DUs 330, as necessary, for network control and signaling. Each DU 330 may correspond to a logical unit that includes one or more base station functions to control the operation of one or more RUs 340. For example, a DU 330 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 330, or for communicating signals with the control functions hosted by the CU 310. Each RU 340 may implement lower layer functionality. In some aspects, real-time and non-real-time aspects of control and user plane communication with the RU(s) 340 may be controlled by the corresponding DU 330.

The SMO Framework 360 may support RAN deployment and provisioning of non-virtualized and virtualized network elements. For non-virtualized network elements, the SMO Framework 360 may support the deployment of dedicated physical resources for RAN coverage requirements, which may be managed via an operations and maintenance interface, such as an O1 interface. For virtualized network elements, the SMO Framework 360 may interact with a cloud computing platform (such as an open cloud (O-Cloud) platform 390) to perform network element life cycle management (such as to instantiate virtualized network elements) via a cloud computing platform interface, such as an O2 interface. A virtualized network element may include, but is not limited to, a CU 310, a DU 330, an RU 340, a non-RT RIC 350, and/or a Near-RT RIC 370. In some aspects, the SMO Framework 360 may communicate with a hardware aspect of a 4G RAN, a 5G NR RAN, and/or a 6G RAN, such as an open eNB (O-cNB) 380, via an O1 interface. Additionally or alternatively, the SMO Framework 360 may communicate directly with each of one or more RUs 340 via a respective O1 interface. In some deployments, this configuration can enable each DU 330 and the CU 310 to be implemented in a cloud-based RAN architecture, such as a vRAN architecture.

The Non-RT RIC 350 may include or may implement a logical function that enables non-real-time control and optimization of RAN elements and resources, AI/ML workflows including model training and updates, and/or policy-based guidance of applications and/or features in the Near-RT RIC 370. The Non-RT RIC 350 may be coupled to or may communicate with (such as via an A1 interface) the Near-RT RIC 370. The Near-RT RIC 370 may include or may implement a logical function that enables near-real-time control and optimization of RAN elements and resources via data collection and actions via an interface (such as via an E2 interface) connecting one or more CUs 310, one or more DUs 330, and/or an O-eNB with the Near-RT RIC 370.

In some aspects, to generate AI/ML models to be deployed in the Near-RT RIC 370, the Non-RT RIC 350 may receive parameters or external enrichment information from external servers. Such information may be utilized by the Near-RT RIC 370 and may be received at the SMO Framework 360 or the Non-RT RIC 350 from non-network data sources or from network functions. In some examples, the Non-RT RIC 350 or the Near-RT RIC 370 may tune RAN behavior or performance. For example, the Non-RT RIC 350 may monitor long-term trends and patterns for performance and may employ AI/ML models to perform corrective actions via the SMO Framework 360 (such as reconfiguration via an O1 interface) or via creation of RAN management policies (such as A1 interface policies).

As indicated above, FIG. 3 is provided as an example. Other examples may differ from what is described with regard to FIG. 3.

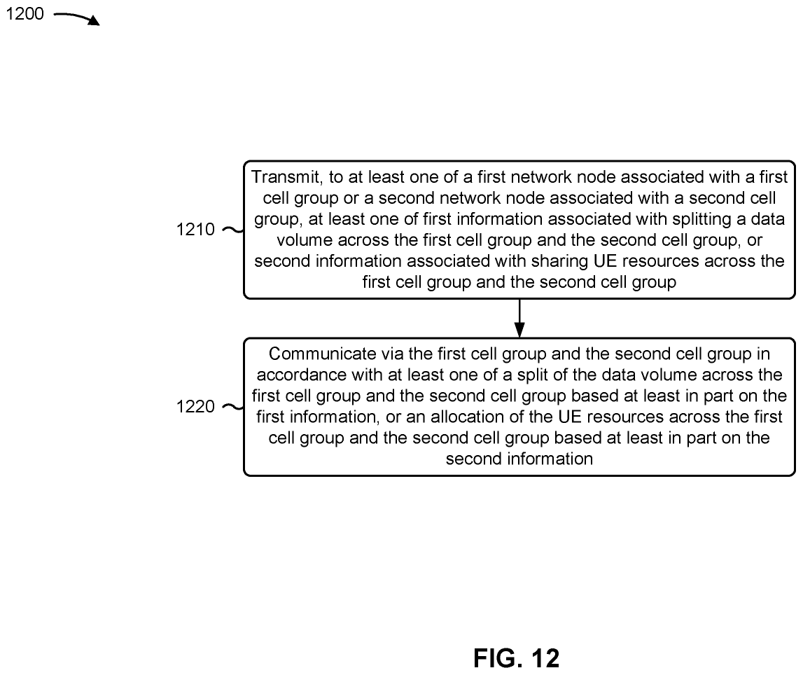

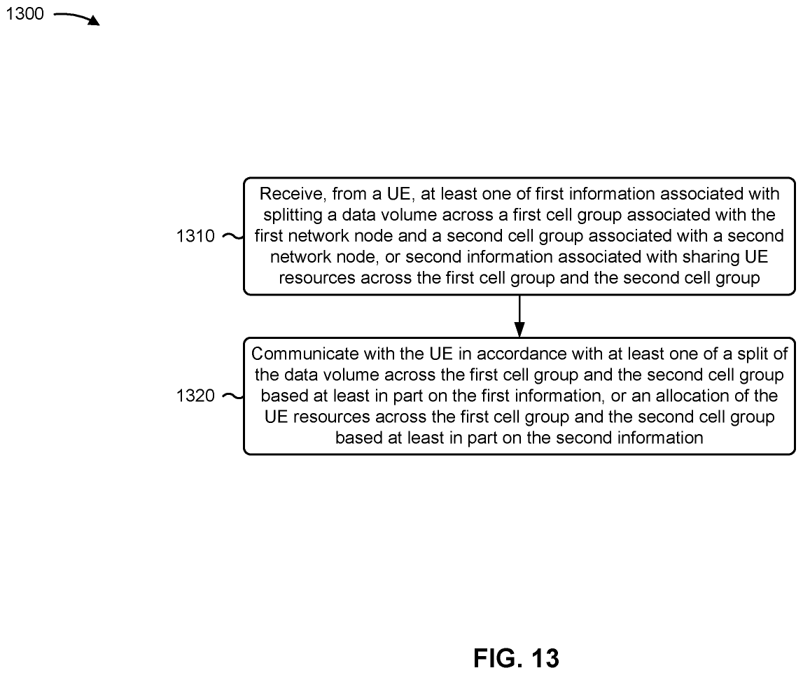

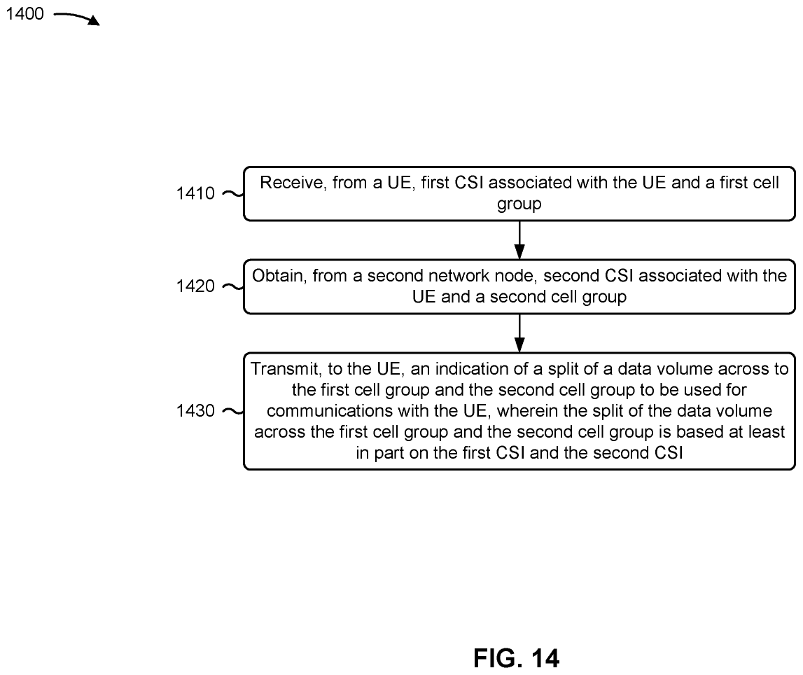

The network node 110, the controller/processor 240 of the network node 110, the UE 120, the controller/processor 280 of the UE 120, the CU 310, the DU 330, the RU 340, or any other component(s) of FIG. 1, 2, or 3 may implement one or more techniques or perform one or more operations associated with UE information for enhancing multi-carrier communications, as described in more detail elsewhere herein. For example, the controller/processor 240 of the network node 110, the controller/processor 280 of the UE 120, any other component(s) of FIG. 2, the CU 310, the DU 330, or the RU 340 may perform or direct operations of, for example, process 1200 of FIG. 12, process 1300 of FIG. 13, process 1400 of FIG. 14, or other processes as described herein (alone or in conjunction with one or more other processors). The memory 242 may store data and program codes for the network node 110, the network node 110, the CU 310, the DU 330, or the RU 340. The memory 282 may store data and program codes for the UE 120. In some examples, the memory 242 or the memory 282 may include a non-transitory computer-readable medium storing a set of instructions (for example, code or program code) for wireless communication. The memory 242 may include one or more memories, such as a single memory or multiple different memories (of the same type or of different types). The memory 282 may include one or more memories, such as a single memory or multiple different memories (of the same type or of different types). For example, the set of instructions, when executed (for example, directly, or after compiling, converting, or interpreting) by one or more processors of the network node 110, the UE 120, the CU 310, the DU 330, or the RU 340, may cause the one or more processors to perform process 1200 of FIG. 12, process 1300 of FIG. 13, process 1400 of FIG. 14, or other processes as described herein. In some examples, executing instructions may include running the instructions, converting the instructions, compiling the instructions, and/or interpreting the instructions, among other examples.

In some aspects, a UE (e.g., the UE 120) includes means for transmitting, to at least one of a first network node associated with a first cell group or a second network node associated with a second cell group, at least one of: first information associated with splitting a data volume across the first cell group and the second cell group, or second information associated with sharing UE resources across the first cell group and the second cell group; and/or means for communicating via the first cell group and the second cell group in accordance with at least one of: a split of the data volume across the first cell group and the second cell group based at least in part on the first information, or an allocation of the UE resources across the first cell group and the second cell group based at least in part on the second information. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a network node (e.g., the network node 110) includes means for receiving, from a UE, at least one of: first information associated with splitting a data volume across a first cell group associated with the network node and a second cell group associated with another network node, or second information associated with sharing UE resources across the first cell group and the second cell group; and/or means for communicating with the UE in accordance with at least one of: a split of the data volume across the first cell group and the second cell group based at least in part on the first information, or an allocation of the UE resources across the first cell group and the second cell group based at least in part on the second information.

In some aspects, a network node (e.g., the network node 110) includes means for receiving, from a UE, first CSI associated with the UE and a first cell group; means for obtaining, from another network node, second CSI associated with the UE and a second cell group; and/or means for transmitting, to the UE, an indication of a split of a data volume across to the first cell group and the second cell group to be used for communications with the UE, wherein the split of the data volume across the first cell group and the second cell group is based at least in part on the first CSI and the second CSI. The means for the network node to perform operations described herein may include, for example, one or more of communication manager 150, transmit processor 214, TX MIMO processor 216, modem 232, antenna 234, MIMO detector 236, receive processor 238, controller/processor 240, memory 242, or scheduler 246.

As indicated above, FIG. 3 is provided as an example. Other examples may differ from what is described with regard to FIG. 3.

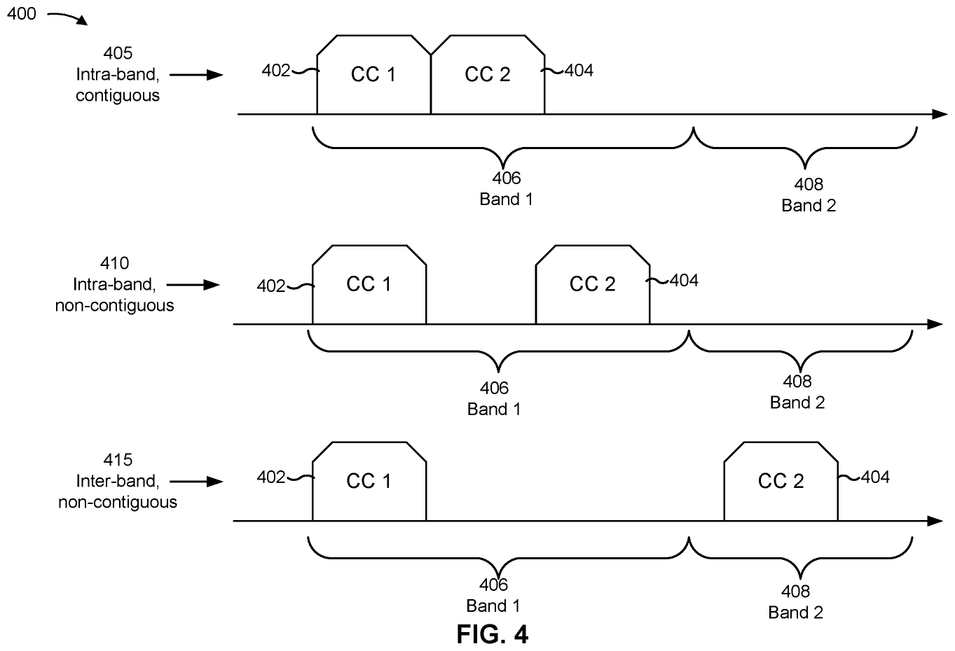

FIG. 4 is a diagram illustrating examples 400 of CA, in accordance with the present disclosure.

CA is a technology that enables two or more CCs (sometimes referred to as “carriers”) to be combined (e.g., into a single channel) for a single UE 120 to enhance data capacity. As shown, carriers (shown as a first carrier (CC 1) 402 and a second carrier (CC 2) 404) can be combined in the same or different frequency bands (shown as a first band (Band 1) 406 and a second band (Band 2) 408). Additionally, or alternatively, contiguous or non-contiguous carriers can be combined. A network node 110 may configure carrier aggregation for a UE 120, such as in an RRC message, DCI, and/or another signaling message.

As shown by reference number 405, in some aspects, carrier aggregation may be configured in an intra-band contiguous mode where the aggregated carriers (e.g., CC 1 402 and CC 2 404) are contiguous to one another and are in the same band (e.g., Band 1 406). As shown by reference number 410, in some aspects, carrier aggregation may be configured in an intra-band non-contiguous mode where the aggregated carriers (e.g., CC 1 402 and CC 2 404) are non-contiguous to one another and are in the same band (e.g., Band 1 406). As shown by reference number 415, in some aspects, carrier aggregation may be configured in an inter-band non-contiguous mode where the aggregated carriers (e.g., CC 1 402 and CC 2 404) are non-contiguous to one another and are in different bands (e.g., Band 1 406 and Band 2 408).

In carrier aggregation, a UE 120 may be configured with a primary carrier or primary cell (PCell) and one or more secondary carriers or secondary cells (SCells). In some aspects, the primary carrier may carry control information (e.g., downlink control information and/or scheduling information) for scheduling data communications on one or more secondary carriers, which may be referred to as cross-carrier scheduling. In some aspects, a carrier (e.g., a primary carrier or a secondary carrier) may carry control information for scheduling data communications on the carrier, which may be referred to as self-carrier scheduling or carrier self-scheduling.

As indicated above, FIG. 4 is provided as an example. Other examples may differ from what is described with regard to FIG. 4.

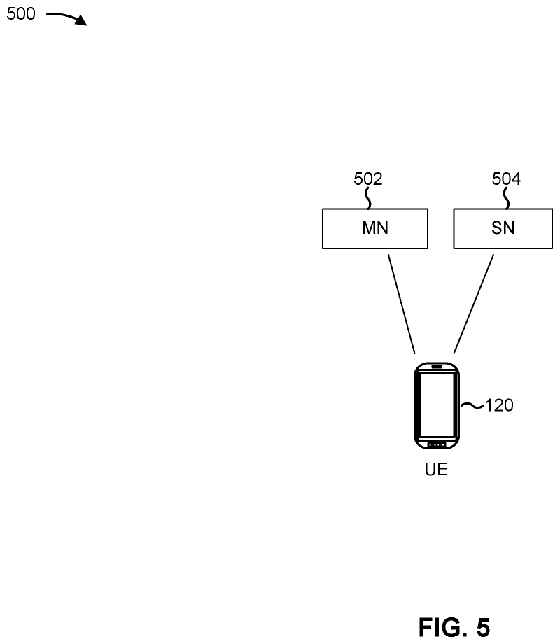

FIG. 5 is a diagram illustrating an example 500 of DC, in accordance with various aspects of the present disclosure.

As shown in FIG. 5, in NR, DC is a feature in which a UE 120 may communicate with two network nodes in order to increase bandwidth and decrease traffic latency. One network node acts as an MN 502 and the other network node acts as an SN 504. The MN 502 may be an eNB (e.g., a 4G network node, LTE network node, or the like), a gNB DU (e.g., a 5G network node, NR network node, or the like), or a 6G network node, among other examples. The SN 504 may be a gNB DU (e.g., a 5G network node, NR network node, or the like) or a 6G network node, among other examples. The MN 502 and the SN 504 may communicate (e.g., directly or indirectly) with a 4G/LTE core network, a 5G/NR core network (e.g., via a gNB CU), and/or a 6G core network, among other examples.

In some cases, DC may be used together with CA. When CA is used, there may be a number of serving cells (e.g., one for each carrier). The coverage of the serving cells may differ, for example due to different carriers on different frequency bands experiencing different pathloss.

In DC, the MN 502 may communicate with the UE 120 via an MCG. The MCG may include multiple serving cells (e.g., a Pcell and one or more Scells) when CA is activated. The MCG may include a single serving cell when CA is not activated. The SN 504 may communicate with the UE 120 via an SCG. The SCG may include multiple serving cells (e.g., a primary secondary cell (PScell) and one or more Scells) when CA is activated. The SCG may include a single serving cell when CA is not activated.

As indicated above, FIG. 5 is provided as an example. Other examples may differ from what is described with regard to FIG. 5.

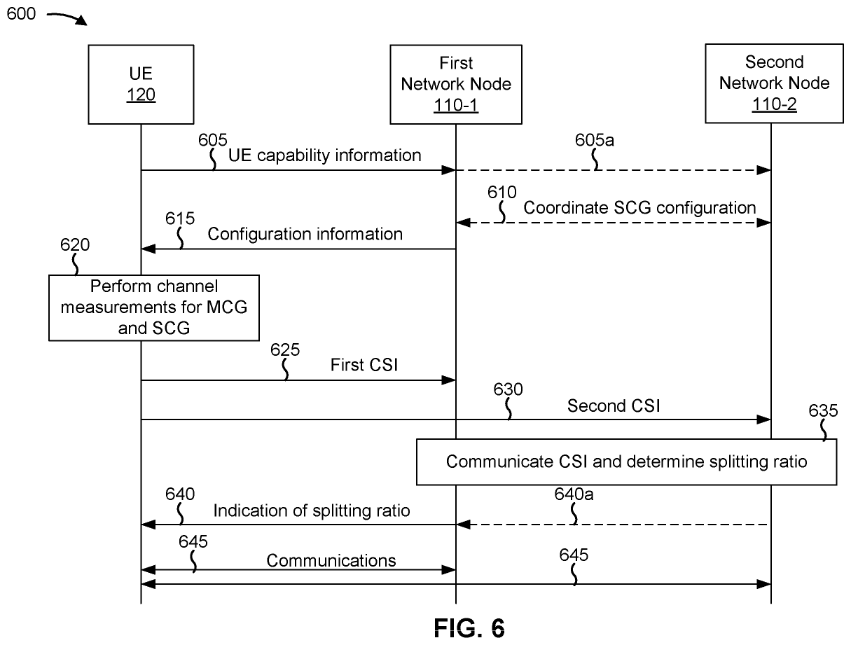

FIG. 6 is a diagram illustrating an example 600 associated with enhanced resource management for DC. As shown in FIG. 6, a UE 120 may communicate with a first network node 110-1 and a second network node 110-2. In some aspects, the first network node 110-1, the second network node 110-2, and the UE 120 may be part of a wireless network (e.g., wireless network 100). The UE 120 may have established a wireless connection with the first network node 110-1 and the second network node 110-2 prior to operations shown in FIG. 6. In some aspects, the first network node 110-1 is an MN and the second network node 110-2 is an SN for dual connectivity communications with the UE 120. In some aspects, the second network node 110-2 is the MN and the first network node 110-1 is the SN for dual connectivity communications with the UE 120. In some aspects, the first network node 110-1 and the second network node 110-2 may be non-co-located.

As shown by reference number 605, the UE 120 may transmit, and the first network node 110-1 may receive, UE capability information. For example, the UE may transmit, and the first network node 110-1 may receive, a capability report including the UE capability information. Additionally, or alternatively, as shown by reference number 605a, the second network node 110-2 may receive the UE capability information. In some examples, the second network node 110-2 may receive the UE capability information from the first network node 110-1 (e.g., the first network node 110-1 may forward the UE capability information to the second network node 110-2). In some other examples, the second network node 110-2 may receive the UE capability information from the UE 120 (e.g., in addition to or instead of the first network node 110-1 receiving the UE capability information).

The UE capability information may indicate one or more capabilities associated with DC. For example, the UE capability information may indicate whether the UE 120 supports (e.g., is capable of) DC communication. In some aspects, the UE capability information may indicate one or more band combinations for which DC is supported by the UE 120. In some aspects, the UE capability information may indicate capabilities of the UE 120 for feature sets and/or maximum power in FR1 and FR2.

As further shown in FIG. 6, and by reference number 610, in some aspects, the first network node 110-1 and the second network node 110-2 may coordinate to determine an SCG configuration for the UE 120. In some aspects, the MN (e.g., the first network node 110-1) and the SN (e.g., the second network node 110-2) may coordinate to determine the SCG configuration for the UE 120 based at least in part on the UE capability information. For example, the MN may oversee resolving dependency between an MCG configuration and the SCG configuration of the UE 120. The MN may determine the MCG configuration and a list of possible configurations for the SCG, and the MN may transmit the list of possible configurations for the SCG to the SN. The list of possible configurations for the SCG may include possible DC band combinations and/or feature sets based at least in part on the UE capability information. In some examples, the SN may select an SCG configuration from the list of possible configurations for the SCG and report the selected SCG configuration to the MN. Alternatively, the SN may negotiate with the MN about the selection of the SCG configuration. For example, the SN may initiate a modification of the list of possible SCG configurations and indicate one or more desired SCG configurations (e.g., desired band combinations and/or feature sets) outside of the list of possible SCG configurations selected by the MN. The final determination of the SCG configuration may then be made by the MN.

As further shown in FIG. 6, and by reference number 615, the first network node 110-1 may transmit, and the UE 120 may receive, configuration information. In some examples, the MN (e.g., the first network node 110-1) may transmit the configuration information to the UE 120. In some examples, the UE 120 may receive the configuration information from the SN or from both the MN and the SN. In some aspects, the UE 120 may receive the configuration information via one or more RRC messages. Additionally, or alternatively, the UE 120 may receive the configuration information via system information (e.g., a master information block (MIB) and/or a system information block (SIB), among other examples), one or more MAC-CEs, and/or DCI, among other examples.

In some aspects, the configuration information may indicate one or more candidate configurations and/or communication parameters. In some aspects, the one or more candidate configurations and/or communication parameters may be selected, activated, and/or deactivated by a subsequent indication. For example, the subsequent indication may select a candidate configuration and/or communication parameter from the one or more candidate configurations and/or communication parameters. In some aspects, the subsequent indication may include a dynamic indication, such as one or more MAC-CEs and/or one or more DCI messages, among other examples.

In some aspects, the configuration information may configure the UE 120 for DC communications. For example, the configuration information may include the MCG configuration and the SCG configuration for the UE 120. In some examples, the configuration information may indicate the CCs (or cells) in each cell group, the activated BWPs for the CCs in each cell group, and/or the number of MIMO layers to be used for each cell group, among other examples. In some examples, the configuration information may configure an allocation of how UE resources are to be used across the MCG and SCG. For example, the UE resources may include BB resources, RF resources (e.g., RF chains), and/or antennas of the UE 120.

In some aspects, the configuration information may configure the UE 120 to perform channel measurements and report the channel measurements. For example, the configuration information may include configurations for one or more CSI-RSs to be measured by the UE 120 and configurations for one or more CSI reports to be transmitted by the UE 120. In some aspects, the configuration information may configure the UE 120 to measure one or more first CSI-RSs associated with a first cell group (e.g., the MCG) and to measure one or more second CSI-RSs associated with a second cell group (e.g., the SCG). In such examples, the configuration information may configure the UE 120 to report first CSI associated with the first cell group (e.g., the MCG) to the first network node 110-1 (e.g., the MN) and to report second CSI associated with the second cell group (e.g., the SCG) to the second network node 110-2 (e.g., the SN).

As further shown in FIG. 6, and by reference number 620, the UE 120 may perform channel measurements for the MCG and the SCG. For example, the first network node 110-1 may transmit the one or more first CSI-RSs via the first cell group (e.g., the MCG), and the UE 120 may perform channel measurements on the one or more first CSI-RSs. The UE 120 may determine or derive first CSI based at least in part on the channel measurements performed on the one or more first CSI-RSs. The first CSI may include one or more estimates and/or measurements of channel conditions (e.g., downlink channel conditions) on the UE channel to the first cell group (e.g., the MCG). The UE 120 may perform channel measurements for each CC of the first cell group, and the first CSI may include CSI for each CC of the first cell group. The second network node may transmit the one or more second CSI-RSs via the second cell group (e.g., the SCG), and the UE 120 may perform channel measurements on the one or more second CSI-RSs. The UE 120 may determine or derive second CSI based at least in part on the channel measurements performed on the one or more second CSI-RSs. The second CSI may include one or more estimates and/or measurements of channel conditions (e.g., downlink channel conditions) on the UE channel to the second cell group (e.g., the SCG). The UE 120 may perform channel measurements for each CC of the second cell group, and the second CSI may include CSI for each CC of the second cell group.

As further shown in FIG. 6, and by reference number 625, the UE 120 may transmit, and the first network node 110-1 may receive, the first CSI. For example, the UE 120 may transmit, to the first network node 110-1, a first CSI report including the first CSI. The first CSI is associated with the UE 120 and the first cell group (e.g., the MCG). That is, the first CSI indicates, to the first network node 110-1, the channel conditions for the downlink channel between the first network node 110-1 and the UE 120 (e.g., the UE channel to the first cell group). In some other examples, in a case in which downlink/uplink reciprocity holds between the UE 120 and the first network node 110-1, the first network node 110-1 may determine the channel conditions for the downlink channel between the first network node 110-1 and the UE 120 via uplink channel sounding.

As further shown in FIG. 6, and by reference number 630, the UE 120 may transmit, and the second network node 110-2 may receive, the second CSI. For example, the UE 120 may transmit, to the second network node 110-2, a second CSI report including the second CSI. The second CSI is associated with the UE 120 and the second cell group (e.g., the SCG). That is, the second CSI indicates, to the second network node 110-2, the channel conditions for the downlink channel between the second network node 110-2 and the UE 120 (e.g., the UE channel to the second cell group). In some other examples, in a case in which downlink/uplink reciprocity holds between the UE 120 and the second network node 110-2, the second network node 110-2 may determine the channel conditions for the downlink channel between the second network node 110-2 and the UE 120 via uplink channel sounding.

As further shown in FIG. 6, and by reference number 635, the first network node 110-1 and/or the second network node 110-2 may communicate the CSI received from the UE 120, and the first network node 110-1 and/or the second network node 110-2 may determine a splitting ratio (or splitting factor) for splitting network resources across the first cell group (e.g., the MCG) and the second cell group (e.g., the SCG).

In some aspects, the MN and the SN may exchange their local CSI (e.g., the CSI associated with the MCG and the CSI associated with the SCG). For example, the first network node 110-1 may transmit the first CSI to the second network node 110-2 and obtain (e.g., receive) the second CSI from the second network node 110-2, and the second network node 110-2 may transmit the second CSI to the first network node 110-1 and obtain (e.g., receive) the first CSI from the first network node 110-1. In some other aspects, one of the MN or the SN may transmit the local CSI received from the UE 120 to the other one of the MN or the SN. In some examples, the first network node 110-1 may obtain the second CSI from the second network node 110-2 (e.g., the second network node 110-2 may transmit the second CSI to the first network node 110-1). In some other examples, the second network node 110-2 may obtain the first CSI from the first network node 110-1 (e.g., the first network node 110-1 may transmit the first CSI to the second network node 110-2). In some aspects, the CSI transmitted by the MN (e.g., the first network node 110-1) and/or the SN (e.g., the second network node 110-2) may include or be transmitted with information identifying the UE 120 and each serving cell of the UE 120 (e.g., information associating the CSI with the UE 120 and each serving cell of the UE 120). In some other aspects, the UE 120 may be configured to report the CSI (or some parts of CSI, such as a CQI, a precoding matrix indicator (PMI), or a layer 1 RSRP (L1-RSRP), among other examples) of one cell group to the other cell group. For example, the UE 120 may transmit the second CSI to both the second cell group (e.g., the SCG) and the first cell group (e.g., the MCG). In such examples, there may be no need for the first network node 110-1 (e.g., the MN) and the second network node 110-2 (e.g., the SN) to exchange the CSI.

The first network node 110-1 and/or the second network node 110-2 may determine the splitting ratio (or splitting factor) based at least in part on the first CSI and the second CSI. The splitting ratio is a ratio used to split a data/traffic volume across the first cell group (e.g., the MCG) and the second cell group (e.g., the SCG). Accordingly, the splitting ratio indicates a split of a data volume across the first cell group and the second cell group. In some examples, the splitting ratio may be based at least in part on a split of network resources across the first cell group and the second cell group determined by the first network node 110-1 and/or the second network node 110-2. The splitting ratio may be used by the first network node 110-1 and the second network node 110-2 to split downlink data between the first cell group and the second cell group, and the splitting ratio may be used by the UE 120 to split uplink data between the first cell group and the second cell group. In some aspects, the first network node 110-1 and/or the second network node 110-2 may determine the same splitting ratio for downlink and uplink, or the first network node 110-1 and/or the second network node 110-2 may determine different splitting ratios for downlink and uplink. In some examples, the first network node 110-1 and/or the second network node 110-2 may determine/select the splitting ratio based on the first CSI, the second CSI, and the available bandwidth for the UE 120 in each cell group. In some examples, the first network node 110-1 and/or the second network node 110-2 may determine/select the splitting ratio based on the first CSI, the second CSI, the available bandwidth for the UE 120 in each cell group, and/or other information, such as cell loading information. In some examples, the first network node 110-1 and/or the second network node 110-2 may determine the splitting ratio to favor use of a cell group (e.g., MCG or SCG) having the better channel conditions, such that more of a data volume will be transmitted and/or received by the UE 120 using the cell group having the better channel conditions.

In some aspects, one of the MN or the SN may determine or select the splitting ratio. In some examples, the first network node 110-1 may determine the splitting ratio. In such examples, the first network node 110-1 may obtain the second CSI from the second network node 110-2, and the first network node 110-1 may determine the splitting ratio based at least on the first CSI (received from the UE 120) and the second CSI. In this case, the first network node 110-1 may report the determined splitting ratio to the second network node 110-2. In some other examples, the second network node 110-2 may determine the splitting ratio. In such examples, the second network node 110-2 may obtain the first CSI from the first network node 110-1, and the second network node 110-2 may determine the splitting ratio based at least on the first CSI and the second CSI (received from the UE 120). In this case, the second network node 110-2 may report the determined splitting ratio to the first network node 110-1. In some aspects, the MN and the SN may coordinate to determine the splitting ratio. For example, the first network node 110-1 and the second network node 110-2 may exchange CSI information and then perform negotiation and/or handshaking communications to determine the splitting ratio based at least in part on the first CSI information and the second CSI information.

As further shown in FIG. 6, and by reference number 640, the first network node 110-1 may transmit, and the UE 120 may receive, an indication of the splitting ratio (or splitting factor). Additionally, or alternatively, as shown by reference number 640a, the second network node 110-2 may transmit, and the UE 120 may receive, the indication of the splitting ratio. In some examples, the indication of the splitting ratio may be transmitted to the UE 120 via the first cell group (e.g., from the first network node 110-1), via the second cell group (e.g., from the second network node 110-2), or via both the first cell group and the second cell group. In some aspects, the indication of the splitting ratio may be included in a MAC-CE or DCI. For example, the MAC-CE or DCI including the indication of the splitting ratio may be carried via the MCG (e.g., the first cell group), via the SCG (e.g., the second cell group), or via both the MCG and the SCG.

In some aspects, the splitting ratio (or splitting factor) may be indicated to the UE 120 as a splitting threshold. For example, the indication of the splitting factor may indicate the splitting threshold. In such examples, the UE 120 may apply the splitting ratio by transmitting a portion of a data volume via one of the first cell group (e.g., the MCG) or the second cell group (e.g., the SCG) until the splitting threshold is reached, and transmitting a remaining portion of the data volume via the other one of the first cell group (e.g., the MCG) or the second cell group (e.g., the SCG). In some examples, the splitting threshold may be expressed in terms of a number of bytes (e.g., a number of megabytes). For example, an indication of the splitting threshold transmitted to the UE 120 via the MCG may be an indication for the UE 120 to transmit a data volume (e.g., of uplink data) up to the splitting threshold via the MCG and transmit a remaining data volume (exceeding the splitting threshold) via the SCG. An indication of the splitting threshold transmitted to the UE 120 via the SCG may be an indication for the UE 120 to transmit a data volume (e.g., of uplink data) up to the splitting threshold via the SCG and transmit a remaining data volume (exceeding the splitting threshold) via the MCG.

As further shown in FIG. 6, and by reference number 645, the UE 120 may communicate with the first network node 110-1 and the second network node 110-2 via the first cell group and the second cell group, respectively, in accordance with the indication of the splitting ratio. In some examples, the UE 120 may transmit uplink communications to the first network node 110-1 (e.g., the MN) via the first cell group (e.g., the MCG) and to the second network node 110-2 (e.g., the SN) via the second cell group in accordance with the indication of the splitting ratio. For example, the UE 120 may split uplink data between the first cell group and the second cell group in accordance with the indicated splitting ratio. In a case in which the splitting ratio is indicated to the UE 120 as the splitting threshold, the UE 120 may transmit a data volume up to the splitting threshold via one of the first cell group or the second cell group and transmit a remaining data volume (exceeding the splitting threshold) via the other one of the first cell group or the second cell group.

In some examples, the first network node 110-1 may transmit downlink communications to the UE 120 via the first cell group and the second network node 110-2 may transmit downlink to the UE 120 via the second cell group in accordance with the indicated splitting ratio. For example, the first network node 110-1 and the second network node 110-2 may split downlink data between the first cell group and the second cell group in accordance with the splitting ratio. The UE 120 may receive downlink communications split across the first cell group and the second cell group in accordance with the indicated splitting ratio. In a case in which the splitting ratio is indicated to the UE 120 as the splitting threshold, the UE 120 may receive a data volume of downlink data up to the splitting threshold via one of the first cell group or the second cell group and receive a remaining data volume of downlink data (exceeding the splitting threshold) via the other one of the first cell group or the second cell group.

As discussed above with reference to FIG. 6, the MN and/or the SN may exchange CSI associated with the MCG and CSI associated with the SCG, and the MN and/or the SN may determine the splitting ratio based at least in part on the CSI associated with the MCG and the CSI associated with the SCG. In some examples, the splitting ratio may be selected to favor use of a cell group (e.g., MCG or SCG) having the better channel conditions, such that more of a data volume is transmitted using the cell group having the better channel conditions. Therefore, the MN and/or the SN may consider the channel conditions (e.g., link quality) for the UE 120 on the CCs of the MCG and the SCG when managing network resources (e.g., when determining the splitting ratio) for DC communications for the UE 120. As a result, downlink and uplink throughput may be enhanced/increased for the DC communications. In some examples, the amount of throughput gains may be conditional on: the information exchange between the MN and the SN being fast enough (e.g., including negotiating and/or handshaking operations); and the splitting ratio for uplink being indicated to the UE 120 quickly (e.g., using a MAC-CE or DCI, which may be carried via the MCG, the SCG, or both the MCG and the SCG).

Although the operations discussed above with reference to FIG. 6 are described in connection with DC, the operations discussed above with reference to FIG. 6 may be similarly applied to a dual stack (DS) scenario. In a DS scenario, the UE 120 may be connected to two networks independently. For example, the two networks may be associated with the same or different operators. The UE 120 may have two subscriber identity modules (SIMs) (e.g., two SIM cards), with each SIM used for connecting to a different network. In the DS scenario, the first network node 110-1 may be associated with a first network, and the second network node 110-2 may be associated with a second network. The UE 120 may connect to the first network via a first link with the first network node 110-1 and the second network via a second link the second network node 110-2. In some examples, some applications executing on the UE 120 may use the first link, and some applications executing on the UE 120 may use the second link. However, there may be little to no coordination across the two networks. Accordingly, in an example in which the operations discussed above with reference to FIG. 6 are applied in the DS scenario, the UE 120 may transmit the CSI of one network to the network node associated with the other network. For example, in the DS scenario, the UE 120 may transmit the CSI of the first network to the second network node 110-2, and/or the UE 120 may transmit the CSI of the second network to the first network node 110-1.

As indicated above, FIG. 6 is provided as an example. Other examples may differ from what is described with respect to FIG. 6.

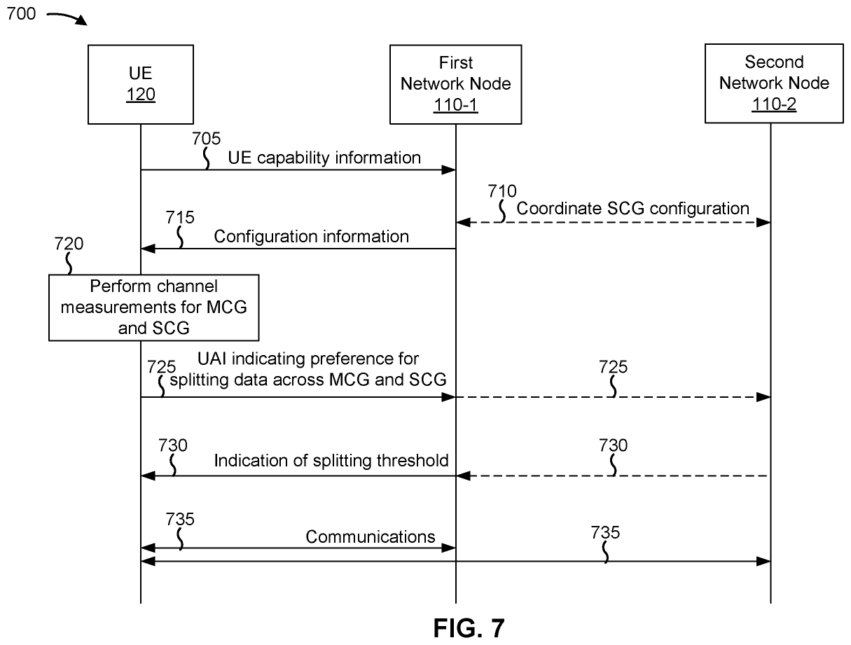

FIG. 7 is a diagram illustrating an example 700 associated with enhanced resource management for DC. As shown in FIG. 7, a UE 120 may communicate with a first network node 110-1 and a second network node 110-2. In some aspects, the first network node 110-1, the second network node 110-2, and the UE 120 may be part of a wireless network (e.g., wireless network 100). The UE 120 may have established a wireless connection with the first network node 110-1 and the second network node 110-2 prior to operations shown in FIG. 7. In some aspects, the first network node 110-1 is an MN and the second network node 110-2 is an SN for dual connectivity communications with the UE 120. In such examples, a first cell group associated with the first network node 110-1 may be an MCG and a second cell group associated with the second network node 110-2 may be an SCG. In some aspects, the second network node 110-2 is the MN and the first network node 110-1 is the SN for dual connectivity communications with the UE 120. In such examples, the second cell group may be the MCG and the first cell group may be the SCG. In some aspects, the first network node 110-1 and the second network node 110-2 may be non-co-located.

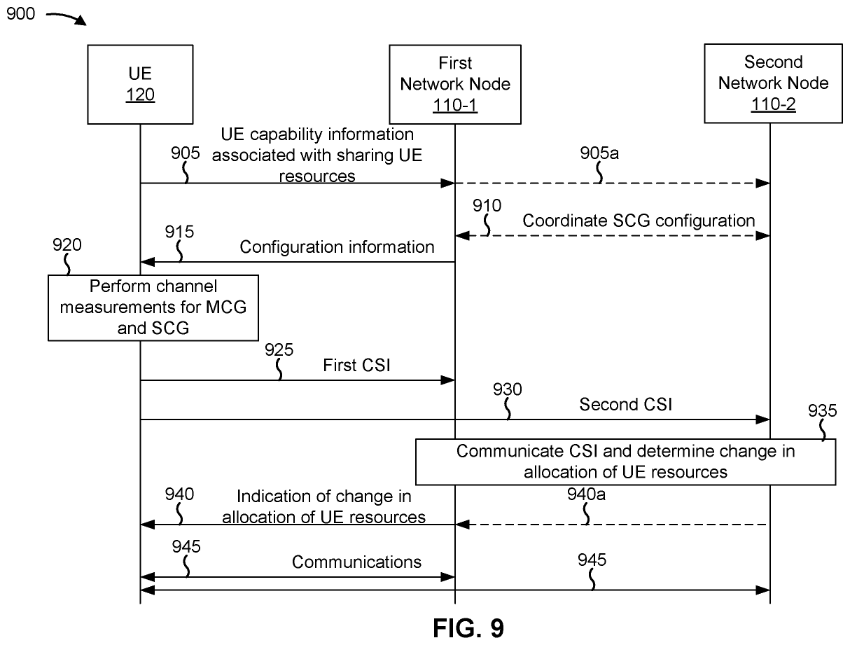

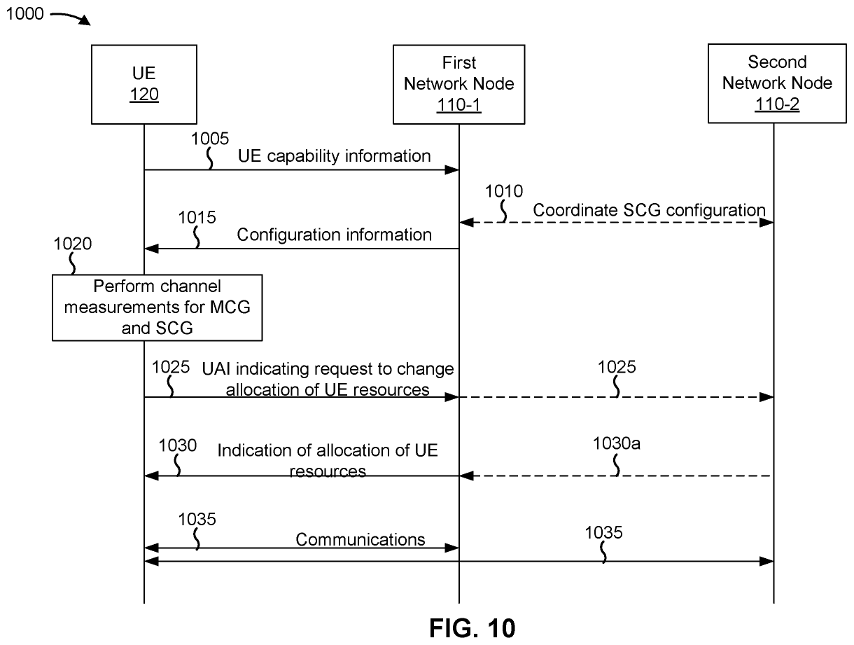

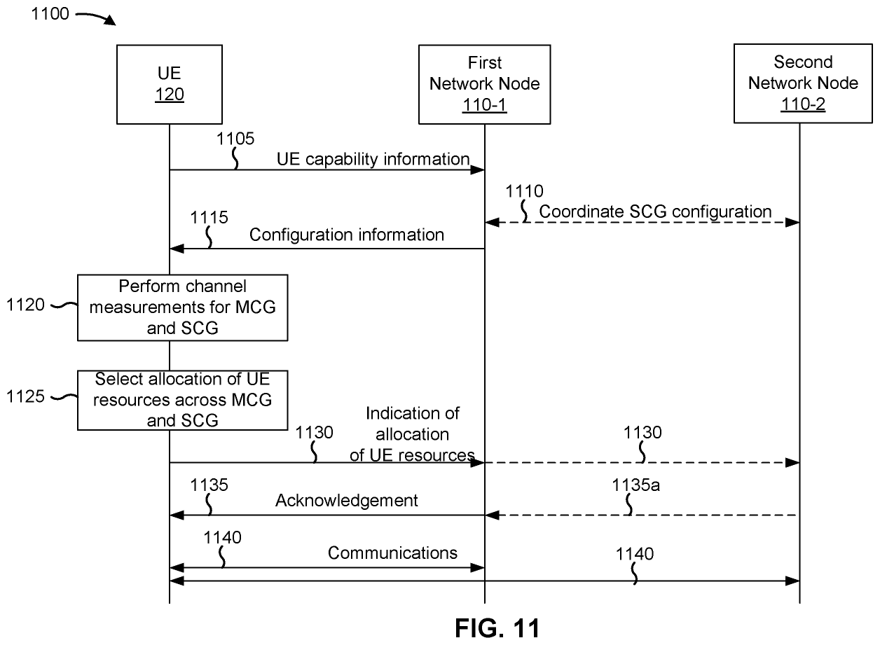

In some aspects, such as in example 700 of FIG. 7, the UE 120 may transmit, and at least one of the first network node 110-1 or the second network node 110-2 may receive, first information associated with splitting a data volume across the first cell group and the second cell group. In such examples, the UE 120 may communicate with the first network node 110-1 via the first cell group and the second network node 110-2 via the second cell group in accordance with a split of the data volume across the first cell group and the second cell group that is based at least in part on the first information. In example 700, the first information may include or be included in enhanced UAI. For example, the first information may include UAI that indicates a UE preference for splitting the data volume across the first cell group and the second cell group. In some aspects, the operations discussed with reference to FIG. 7 may be performed without dynamic sharing of UE resources across the first cell group and the second cell group. In such examples, the UE 120 may transmit the first information (e.g., the enhanced UAI), and the UE 120 may refrain from transmitting second information associated with sharing UE resources across the first cell group and the second cell group. In some other aspects, the operations discussed with reference to FIG. 7 may be performed together with dynamic sharing of UE resources across the first cell group and the second cell group. For example, the operations discussed with reference to FIG. 7 may be combined with the operations discussed with reference to FIG. 9, FIG. 10, or FIG. 11. In such examples, the UE 120 may transmit the first information (e.g., the enhanced UAI), and the UE 120 may also transmit second information associated with sharing UE resources across the first cell group and the second cell group, as discussed with reference to FIG. 9, FIG. 10, or FIG. 11.

As shown in FIG. 7, and by reference number 705, the UE 120 may transmit, and the first network node 110-1 may receive, UE capability information. For example, the UE may transmit, and the first network node 110-1 may receive, a capability report including the UE capability information. Additionally, or alternatively, the second network node 110-2 may receive the UE capability information. In some examples, the second network node 110-2 may receive the UE capability information from the first network node 110-1 (e.g., the first network node 110-1 may forward the UE capability information to the second network node 110-2). In some other examples, the second network node 110-2 may receive the UE capability information from the UE 120 (e.g., in addition to or instead of the first network node 110-1 receiving the UE capability information).

The UE capability information may indicate one or more capabilities associated with DC. For example, the UE capability information may indicate whether the UE 120 supports (e.g., is capable of) DC communication. In some aspects, the UE capability information may indicate one or more band combinations for which DC is supported by the UE 120. In some aspects, the UE capability information may indicate capabilities of the UE 120 for feature sets and/or maximum power in FR1 and FR2.

As further shown in FIG. 7, and by reference number 710, in some aspects, the first network node 110-1 and the second network node 110-2 may coordinate to determine an SCG configuration for the UE 120. In some aspects, the MN (e.g., the first network node 110-1) and the SN (e.g., the second network node 110-2) may coordinate to determine the SCG configuration for the UE 120 based at least in part on the UE capability information. For example, the MN may oversee resolving dependency between an MCG configuration and the SCG configuration of the UE 120. The MN may determine the MCG configuration and a list of possible configurations for the SCG, and the MN may transmit the list of possible configurations for the SCG to the SN. The list of possible configurations for the SCG may include possible DC band combinations and/or feature sets based at least in part on the UE capability information. In some examples, the SN may select an SCG configuration from the list of possible configurations for the SCG and report the selected SCG configuration to the MN. Alternatively, the SN may negotiate with the MN about the selection of the SCG configuration. For example, the SN may initiate a modification of the list of possible SCG configurations and indicate one or more desired SCG configurations (e.g., desired band combinations and/or feature sets) outside of the list of possible SCG configurations selected by the MN. The final determination of the SCG configuration may then be made by the MN.

As further shown in FIG. 7, and by reference number 715, the first network node 110-1 may transmit, and the UE 120 may receive, configuration information. In some examples, the MN (e.g., the first network node 110-1) may transmit the configuration information to the UE 120. In some examples, the UE 120 may receive the configuration information from the SN or from both the MN and the SN. In some aspects, the UE 120 may receive the configuration information via one or more RRC messages. Additionally, or alternatively, the UE 120 may receive the configuration information via system information (e.g., an MIB and/or an SIB, among other examples), one or more MAC-CEs, and/or DCI, among other examples.

In some aspects, the configuration information may indicate one or more candidate configurations and/or communication parameters. In some aspects, the one or more candidate configurations and/or communication parameters may be selected, activated, and/or deactivated by a subsequent indication. For example, the subsequent indication may select a candidate configuration and/or communication parameter from the one or more candidate configurations and/or communication parameters. In some aspects, the subsequent indication may include a dynamic indication, such as one or more MAC-CEs and/or one or more DCI messages, among other examples.

In some aspects, the configuration information may configure the UE 120 for DC communications. For example, the configuration information may include the MCG configuration and the SCG configuration for the UE 120. In some examples, the configuration information may indicate the CCs (or cells) in each cell group, the activated BWPs for the CCs in each cell group, and/or the number of MIMO layers to be used for each cell group, among other examples. In some examples, the configuration information may configure an allocation of how UE resources are to be used across the MCG and SCG. For example, the UE resources may include BB resources, RF resources (e.g., RF chains), and/or antennas of the UE 120.

In some aspects, the configuration information may configure the UE 120 to perform channel measurements and report the channel measurements. For example, the configuration information may include configurations for one or more CSI-RSs to be measured by the UE 120 and configurations for one or more CSI reports to be transmitted by the UE 120. In some aspects, the configuration information may configure the UE 120 to measure one or more first CSI-RSs associated with a first cell group (e.g., the MCG) and to measure one or more second CSI-RSs associated with a second cell group (e.g., the SCG). In such examples, the configuration information may configure the UE 120 to report first CSI associated with the first cell group (e.g., the MCG) to the first network node 110-1 (e.g., the MN) and to report second CSI associated with the second cell group (e.g., the SCG) to the second network node 110-2 (e.g., the SN).

As further shown in FIG. 7, and by reference number 720, the UE 120 may perform channel measurements for the MCG and the SCG. For example, the first network node 110-1 may transmit the one or more first CSI-RSs via the first cell group (e.g., the MCG), and the UE 120 may perform channel measurements on the one or more first CSI-RSs. The UE 120 may determine or derive first CSI based at least in part on the channel measurements performed on the one or more first CSI-RSs. The first CSI may include one or more estimates and/or measurements of channel conditions (e.g., downlink channel conditions) on the UE channel to the first cell group (e.g., the MCG). The UE 120 may perform channel measurements for each CC of the first cell group, and the first CSI may include CSI for each CC of the first cell group. The second network node may transmit the one or more second CSI-RSs via the second cell group (e.g., the SCG), and the UE 120 may perform channel measurements on the one or more second CSI-RSs. The UE 120 may determine or derive second CSI based at least in part on the channel measurements performed on the one or more second CSI-RSs. The second CSI may include one or more estimates and/or measurements of channel conditions (e.g., downlink channel conditions) on the UE channel to the second cell group (e.g., the SCG). The UE 120 may perform channel measurements for each CC of the second cell group, and the second CSI may include CSI for each CC of the second cell group.

In some aspects, the UE 120 may transmit, and the first network node 110-1 may receive, the first CSI. For example, the UE 120 may transmit, to the first network node 110-1, a first CSI report including the first CSI. In some aspects, the UE 120 may transmit, and the second network node 110-2 may receive, the second CSI. For example, the UE 120 may transmit, to the second network node 110-2, a second CSI report including the second CSI.

As further shown in FIG. 7, and by reference number 725, the UE 120 may transmit, and at least one of the first network node 110-1 or the second network node 110-2 may receive, UAI indicating a preference for splitting data across the MCG (e.g., the first cell group) and the SCG (e.g., the second cell group). For example, the UE 120 may transmit a UAI message including the UAI indicating the preference for splitting a data volume across the MCG and the SCG. The UE 120 may have access to the channel conditions (e.g., the first CSI) between the UE 120 and the MN on each of the CCs configured for the MCG and the channel conditions (e.g., the second CSI) between the UE 120 and the SN on each of the CCs configured for the SCG. In some aspects, the UE 120 may determine a preference for how to split data across the MCG and SCG resources (e.g., a preferred slit of the data volume between MCG and the SCG) based at least in part on the channel conditions associated with the MCG and the SCG. For example, the UE 120 may determine a preference for which path (e.g., the MCG or the SCG) to use for what portion of available data to be transmitted by the UE 120 based at least in part on the first CSI associated with the MCG, the second CSI associated with the SCG, a total bandwidth available on each cell group (e.g., each leg or path), and/or one or more configurations selected for the UE 120 (e.g., a number of layers configured in the MCG and the SCG). For example, the UE 120 may determine a preferred path (e.g., the MCG or the SCG) for all or a portion of a data volume. In some examples, the UE 120 may determine the preference to favor use of a cell group (e.g., MCG or SCG) having the better channel conditions, such that more of a data volume is transmitted using the cell group having the better channel conditions.

The UE 120 may signal the preference for the split of a data volume across the MCG (e.g., the first cell group) and the SCG (e.g., the second cell group) via UAI. In some aspects, the UAI may indicate a preferred splitting threshold for splitting a data volume across the MCG (e.g., the first cell group) and the SCG (e.g., the second cell group). That is, the UAI may include an indication of a specific preferred splitting threshold to be applied to split data across the MCG and the SCG. In some examples, the UAI may include an indication of a preferred path for downlink or uplink data. In some other aspects, the UAI may indicate a request to increase or decrease a previously signaled splitting threshold for splitting a data volume across the first cell group and the second cell group. For example, the UAI may include an indication of whether an increase or a reduction of the previously signaled splitting threshold is requested and an indication a cell group parameter (e.g., cellGroup) that indicates whether the data volume up to the splitting threshold is to be transmitted via the MCG or the SCG. In some aspects, the UAI may indicate a preference for upgrading/increasing one or more parameters configured for the DC communications. For example, the UAI may include a preference to increase a maximum bandwidth associated with the first cell group (e.g., the MCG) or the second cell group (e.g., the SCG), a maximum number of MIMO layers associated with the first cell group (e.g., the MCG) or the second cell group (e.g., the SCG), and/or a maximum number of cells (e.g., CCs) associated with the first cell group (e.g., the MCG) or the second cell group (e.g., the MCG).

The UAI described herein may be referred to as “enhanced UAI” due to the enhancements over legacy UAI. For example, unlike the legacy UAI, the UAI described herein may enable the UE 120 to indicate the preference for splitting a data volume across the MCG and the SCG and/or enable the UE 120 to signal a preference for increase. Furthermore, the UAI described herein may be used by the UE 120 to change (e.g., increase/upgrade) one or more parameters to enhance DC resource management (e.g., to increase throughput), rather than for power saving.

The UE 120 may transmit the UAI message including the UAI to the MN, the SN, or both the MN and the SN. In some aspects, because the UAI message impacts both MN/MCG and SN/SCG configurations and scheduling decisions, the UAI message may terminate at the MN even if the UE 120 transmits the UAI message to the SN. For example, in a case in which the UE 120 transmits the UAI message to the SN, but not to the MN, the SN may transfer/forward the UAI message to the MN via a backhaul interface.

As further shown in FIG. 7, and by reference number 730, the first network node 110-1 and/or the second network node 110-2 may transmit, and the UE 120 may receive, an indication of a splitting threshold. The splitting threshold may indicate a split of the a data volume across the first cell group (e.g., the MCG) and the second cell group (e.g., the SCG) to be applied for uplink and/or downlink communications. In some aspects, the indication of the splitting threshold may be based at least in part on the UAI indicating the preference for splitting the data volume across the first cell group and the second cell group. In some examples, the first network node 110-1 or the second network node 110-2 may determine the splitting threshold by selecting the preferred splitting threshold indicated in the UAI, or otherwise based at least in part on the preferred splitting threshold indication in the UAI. In some examples, the splitting threshold may be based at least in part on a split of network resource across the first cell group and the second cell group that is determined, by the first network node 110-1 or the second network node 110-2, based at least in part on the preferred splitting threshold indication in the UAI. In some other examples, the first network node 110-1 or the second network node 110-2 may determine the splitting threshold by increasing or decreasing a previously signaled splitting threshold based at least in part on the request, indicated in the UAI, to increase or decrease the previously signaled splitting threshold. In some other examples, the first network node 110-1 and/or the second network node 110-2 may indicate one or more updated (e.g., increased) parameters for DC communications based at least in part on the request to upgrade/increase one or more parameters included in the UAI.

As further shown in FIG. 7, and by reference number 735, the UE 120 may communicate with the first network node 110-1 and the second network node 110-2 via the first cell group and the second cell group, respectively, in accordance with the indication of the splitting threshold (e.g., the indication of the split of the data volume across the first cell group and the second cell group). In some examples, the UE 120 may transmit uplink communications to the first network node 110-1 (e.g., the MN) via the first cell group (e.g., the MCG) and to the second network node 110-2 (e.g., the SN) via the second cell group in accordance with the indication of the splitting threshold. For example, the UE 120 may transmit a portion of a data volume via one of the first cell group or the second cell group until the splitting threshold is reached, and transmit a remaining portion of the data volume via the other one of the first cell group or the second cell group.

In some examples, the first network node 110-1 may transmit downlink communications to the UE 120 via the first cell group and the second network node 110-2 may transmit downlink to the UE 120 via the second cell group in accordance with the indicated splitting threshold. The first network node 110-1 and the second network node 110-2 may split downlink data between the first cell group and the second cell group in accordance with the splitting threshold. The UE 120 may receive downlink communications split across the first cell group and the second cell group in accordance with the indicated splitting threshold. For example, the UE 120 may receive a portion of a data volume of downlink data via one of the first cell group or the second cell group until the splitting threshold is reached, and receive a remaining portion of the data volume of downlink data via the other one of the first cell group or the second cell group.

As discussed with reference to FIG. 7, the UE 120 may determine a preference for splitting a data volume across the MCG and the SCG based at least in part on the channel conditions (e.g., the first CSI and the second CSI) for the UE 120 on the CCs of the MCG and the SCG. In some examples, the UE 120 may determine the preference to favor use of a cell group (e.g., MCG or SCG) having the better channel conditions, such that more of a data volume is transmitted using the cell group having the better channel conditions. The UE 120 may transmit the preference to the MN and/or the SN via UAI, and the MN or the SN may determine the splitting ratio based at least in part on the preference indicated via the UAI. As a result, downlink and uplink throughput may be enhanced/increased for the DC communications. Furthermore, because the UE 120 determines and signals the preference instead of relying on an exchange of CSI between the MN and the SN, backhaul signaling overhead between the MN and the SN may be reduced and latency due to the exchange of the CSI information between the MN and the SN may be reduced, as compared to the operations discussed above with reference to FIG. 6.

Although the operations discussed above with reference to FIG. 7 are described in connection with DC, the operations discussed above with reference to FIG. 7 may be similarly applied to a DS scenario. In a DS scenario, the UE 120 may be connected to two networks independently. For example, the two networks may be associated with the same or different operators. The UE 120 may have two SIMs (e.g., two SIM cards), with each SIM used for connecting to a different network. In the DS scenario, the first network node 110-1 may be associated with a first network, and the second network node 110-2 may be associated with a second network. The UE 120 may connect to the first network via a first link with the first network node 110-1 and the second network via a second link the second network node 110-2. In such examples, the UE 120 may determine a preference for splitting a data volume between the first network and the second network, and the UE 120 may transmit the preference for splitting the data volume between the first network and the second network to the first network node 110-1 and/or the second network node 110-2, as described above with reference to FIG. 7.

As indicated above, FIG. 7 is provided as an example. Other examples may differ from what is described with respect to FIG. 7.

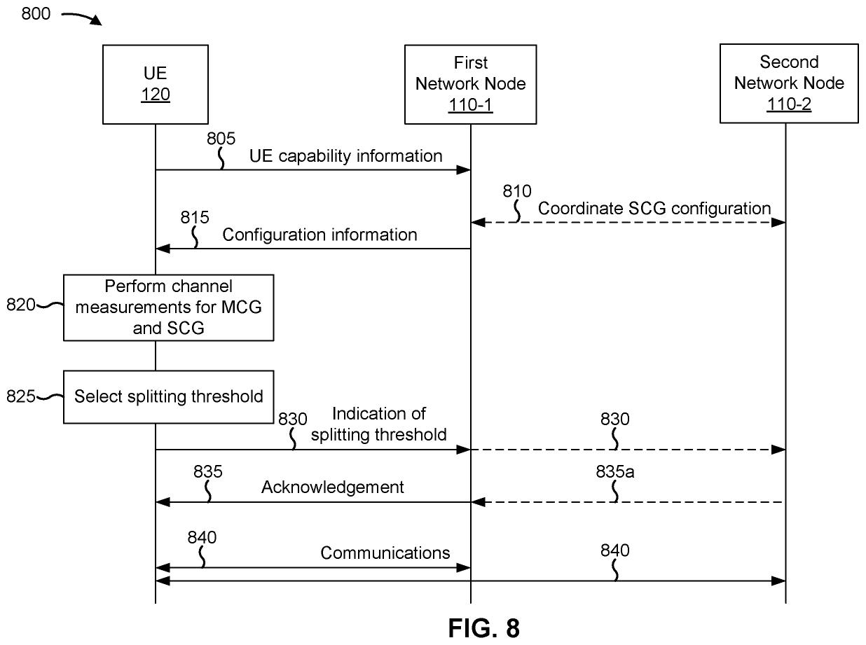

FIG. 8 is a diagram illustrating an example 800 associated with enhanced resource management for DC. As shown in FIG. 8, a UE 120 may communicate with a first network node 110-1 and a second network node 110-2. In some aspects, the first network node 110-1, the second network node 110-2, and the UE 120 may be part of a wireless network (e.g., wireless network 100). The UE 120 may have established a wireless connection with the first network node 110-1 and the second network node 110-2 prior to operations shown in FIG. 8. In some aspects, the first network node 110-1 is an MN and the second network node 110-2 is an SN for dual connectivity communications with the UE 120. In such examples, a first cell group associated with the first network node 110-1 may be an MCG and a second cell group associated with the second network node 110-2 may be an SCG. In some aspects, the second network node 110-2 is the MN and the first network node 110-1 is the SN for dual connectivity communications with the UE 120. In such examples, the second cell group may be the MCG and the first cell group may be the SCG. In some aspects, the first network node 110-1 and the second network node 110-2 may be non-co-located.

In some aspects, such as in example 800 of FIG. 8, the UE 120 may transmit, and at least one of the first network node 110-1 or the second network node 110-2 may receive, first information associated with splitting a data volume across the first cell group and the second cell group. In such examples, the UE 120 may communicate with the first network node 110-1 via the first cell group and the second network node 110-2 via the second cell group in accordance with a split of the data volume across the first cell group and the second cell group that is based at least in part on the first information. In example 800, the first information may indicate the split of the data volume across the first cell group and the second cell group to be used for DC communications (e.g., uplink and/or downlink communications). For example, the first information may include an indication of a splitting threshold, determined by the UE 120, that is to be applied for splitting data across the first cell group and the second cell group (e.g., a splitting ratio that indicates the split of the data volume across the first cell group and the second cell group). In some aspects, the operations discussed with reference to FIG. 8 may be performed without dynamic sharing of UE resources across the first cell group and the second cell group. In such examples, the UE 120 may transmit the first information (e.g., the indication of the splitting threshold), and the UE 120 may refrain from transmitting second information associated with sharing UE resources across the first cell group and the second cell group. In some other aspects, the operations discussed with reference to FIG. 8 may be performed together with dynamic sharing of UE resources across the first cell group and the second cell group. For example, the operations discussed with reference to FIG. 8 may be combined with the operations discussed herein with reference to FIG. 9, FIG. 10, or FIG. 11. In such examples, the UE 120 may transmit the first information (e.g., the indication of the splitting threshold), and the UE 120 may also transmit second information associated with sharing UE resources across the first cell group and the second cell group, as discussed with reference to FIG. 9, FIG. 10, or FIG. 11.

As shown in FIG. 8, and by reference number 805, the UE 120 may transmit, and the first network node 110-1 may receive, UE capability information. For example, the UE may transmit, and the first network node 110-1 may receive, a capability report including the UE capability information. Additionally, or alternatively, the second network node 110-2 may receive the UE capability information. In some examples, the second network node 110-2 may receive the UE capability information from the first network node 110-1 (e.g., the first network node 110-1 may forward the UE capability information to the second network node 110-2). In some other examples, the second network node 110-2 may receive the UE capability information from the UE 120 (e.g., in addition to or instead of the first network node 110-1 receiving the UE capability information).

The UE capability information may indicate one or more capabilities associated with DC. For example, the UE capability information may indicate whether the UE 120 supports (e.g., is capable of) DC communication. In some aspects, the UE capability information may indicate one or more band combinations for which DC is supported by the UE 120. In some aspects, the UE capability information may indicate capabilities of the UE 120 for feature sets and/or maximum power in FR1 and FR2. In some aspects, the UE capability information may indicate a capability of the UE 120 for determining or selecting a split (e.g., a splitting threshold) of a data volume across cell groups (e.g., the MCG and the SCG) for DC communications.

As further shown in FIG. 8, and by reference number 810, in some aspects, the first network node 110-1 and the second network node 110-2 may coordinate to determine an SCG configuration for the UE 120. In some aspects, the MN (e.g., the first network node 110-1) and the SN (e.g., the second network node 110-2) may coordinate to determine the SCG configuration for the UE 120 based at least in part on the UE capability information. For example, the MN may oversee resolving dependency between an MCG configuration and the SCG configuration of the UE 120. The MN May determine the MCG configuration and a list of possible configurations for the SCG, and the MN may transmit the list of possible configurations for the SCG to the SN. The list of possible configurations for the SCG may include possible DC band combinations and/or feature sets based at least in part on the UE capability information. In some examples, the SN may select an SCG configuration from the list of possible configurations for the SCG and report the selected SCG configuration to the MN. Alternatively, the SN may negotiate with the MN about the selection of the SCG configuration. For example, the SN may initiate a modification of the list of possible SCG configurations and indicate one or more desired SCG configurations (e.g., desired band combinations and/or feature sets) outside of the list of possible SCG configurations selected by the MN. The final determination of the SCG configuration may then be made by the MN.

As further shown in FIG. 8, and by reference number 815, the first network node 110-1 may transmit, and the UE 120 may receive, configuration information. In some examples, the MN (e.g., the first network node 110-1) may transmit the configuration information to the UE 120. In some examples, the UE 120 may receive the configuration information from the SN or from both the MN and the SN. In some aspects, the UE 120 may receive the configuration information via one or more RRC messages. Additionally, or alternatively, the UE 120 may receive the configuration information via system information (e.g., an MIB and/or an SIB, among other examples), one or more MAC-CEs, and/or DCI, among other examples.

In some aspects, the configuration information may indicate one or more candidate configurations and/or communication parameters. In some aspects, the one or more candidate configurations and/or communication parameters may be selected, activated, and/or deactivated by a subsequent indication. For example, the subsequent indication may select a candidate configuration and/or communication parameter from the one or more candidate configurations and/or communication parameters. In some aspects, the subsequent indication may include a dynamic indication, such as one or more MAC-CEs and/or one or more DCI messages, among other examples.

In some aspects, the configuration information may configure the UE 120 for DC communications. For example, the configuration information may include the MCG configuration and the SCG configuration for the UE 120. In some examples, the configuration information may indicate the CCs (or cells) in each cell group, the activated BWPs for the CCs in each cell group, and/or the number of MIMO layers to be used for each cell group, among other examples. In some examples, the configuration information may configure an allocation of how UE resources are to be used across the MCG and SCG. For example, the UE resources may include BB resources, RF resources (e.g., RF chains), and/or antennas of the UE 120.

In some aspects, the configuration information may configure the UE 120 to perform channel measurements and report the channel measurements. For example, the configuration information may include configurations for one or more CSI-RSs to be measured by the UE 120 and configurations for one or more CSI reports to be transmitted by the UE 120. In some aspects, the configuration information may configure the UE 120 to measure one or more first CSI-RSs associated with a first cell group (e.g., the MCG) and to measure one or more second CSI-RSs associated with a second cell group (e.g., the SCG). In such examples, the configuration information may configure the UE 120 to report first CSI associated with the first cell group (e.g., the MCG) to the first network node 110-1 (e.g., the MN) and to report second CSI associated with the second cell group (e.g., the SCG) to the second network node 110-2 (e.g., the SN).

In some aspects, the configuration information may include configuration information associated with selecting a split (e.g., a splitting threshold) of a data volume across the first cell group (e.g., the MCG) and the second cell group (e.g., the SCG). That is, the configuration information may configure the UE 120 to select the split of a data volume across the MCG and the SCG. For example, the configuration information may configure one or more parameters and/or conditions to facilitate the selection of the split (e.g., the splitting threshold) by the UE 120 and/or to constrain the solution (e.g., the selected splitting threshold) within boundaries that are in control of the network. In some examples, the configuration information associated with selecting the split may define (or indicate) a metric and/or algorithm to be used by the UE 120 for selecting the splitting threshold. For example, the configuration information may indicate one or more inputs to the algorithm (e.g., how to derive channel estimates to be used, which reference signals to use to derive the channel estimates, how to perform TD and/or FD filtering of the channel estimates, and/or which ranks, number of layers, and/or modulation and coding schemes (MCSs) to consider, among other examples). For example, the metric may be indicated as one or more relevant thresholds for triggering a change in the splitting threshold (e.g., if the filtered channel of the SCG is better than the filtered channel of the MCG by X dB, then trigger the change in the splitting threshold), among other examples. For example, the determination that a filtered channel of a cell group (e.g., the MCG or the SCG) is better than a filtered channel of another cell group may be based at least in part on the filtered channel of the cell group having a higher RSRP and/or a higher SINR than the filtered channel of the other cell group, among other examples. In some aspects, the configuration information associated with selecting the split may be determined by the MN, the SN, or both the MN and the SN (e.g., involving negotiations and/or handshaking), and the configuration information associated with selecting the split may be transmitted to the UE 120 by the MN, the SN, or both the MN and the SN. For example, the configuration information associated with selecting the split may be signaled via layer 3 (L3) signaling (e.g., one or more RRC messages), layer 2 (L2) signaling (e.g., one or more MAC-CEs), and/or layer 1 (L1) signaling (e.g., DCI).

As further shown in FIG. 8, and by reference number 820, the UE 120 may perform channel measurements for the MCG and the SCG. For example, the first network node 110-1 may transmit one or more first CSI-RSs via the first cell group (e.g., the MCG), and the UE 120 may perform channel measurements on the one or more first CSI-RSs. The UE 120 may determine or derive first CSI based at least in part on the channel measurements performed on the one or more first CSI-RSs. The first CSI may include one or more channel estimates and/or measurements of channel conditions (e.g., downlink channel conditions) on the UE channel to the first cell group (e.g., the MCG). For example, the first CSI may include one or more channel estimates, indicated in the configuration information, that are to be used by the UE 120 for selecting the split (e.g., the splitting threshold) of a data volume across the first cell group and the second cell group. The UE 120 may perform channel measurements for each CC of the first cell group, and the first CSI may include CSI for each CC of the first cell group.

The second network node may transmit one or more second CSI-RSs via the second cell group (e.g., the SCG), and the UE 120 may perform channel measurements on the one or more second CSI-RSs. The UE 120 may determine or derive second CSI based at least in part on the channel measurements performed on the one or more second CSI-RSs. The second CSI may include one or more channel estimates and/or measurements of channel conditions (e.g., downlink channel conditions) on the UE channel to the second cell group (e.g., the SCG). For example, the second CSI may include one or more channel estimates, indicated in the configuration information, that are to be used by the UE 120 for selecting the split (e.g., the splitting threshold) of a data volume across the first cell group and the second cell group. The UE 120 may perform channel measurements for each CC of the second cell group, and the second CSI may include CSI for each CC of the second cell group.

In some aspects, the UE 120 may transmit, and the first network node 110-1 may receive, the first CSI. For example, the UE 120 may transmit, to the first network node 110-1, a first CSI report including the first CSI. In some aspects, the UE 120 may transmit, and the second network node 110-2 may receive, the second CSI. For example, the UE 120 may transmit, to the second network node 110-2, a second CSI report including the second CSI.

As further shown in FIG. 8, and by reference number 825, the UE 120 may select a splitting threshold. In some aspects, the UE 120 may select a split of a data volume across the first cell group (e.g., the MCG) and the second cell group (e.g., the SCG) to be used for uplink and/or downlink communications. For example, the UE 120 may select the splitting threshold to be applied to split the data volume across the first cell group (e.g., the MCG) and the second cell group (e.g., the SCG) (e.g., to split data to be transmitted across the MCG and the SCG). In some aspects, the UE 120 may select a splitting threshold to be applied for both uplink and downlink communications. In some examples, the UE 120 may select a preferred path (e.g., the MCG or the SCG) for downlink or uplink communications. In some examples, the UE 120 may select the splitting threshold to favor use of a cell group (e.g., MCG or SCG) having the better channel conditions, such that more of a data volume is transmitted using the cell group having the better channel conditions.

In some aspects, the UE 120 may determine the splitting threshold based at least in part on channel estimates associated with the first cell group (e.g., the MCG) and channel estimates associated with the second cell group (e.g., the SCG). For example, the channel estimates associated with the first cell group may be included in the first CSI and the channel estimates associated with the second cell group may be included in the second CSI. In some examples, the channel estimates associated with the MCG and the SCG may be defined or indicated in the configuration information associated with selecting the split (e.g., the splitting threshold). In some examples, the UE 120 may select the splitting ratio so as to favor use of a cell group (e.g., MCG or SCG) having the better channel conditions, such that more of a data volume is transmitted using the cell group having the better channel conditions. In some aspects, the UE 120 may select/determine the splitting threshold using a metric or an algorithm defined in the configuration information. In some aspects, the UE 120 may be triggered to select the splitting threshold in connection with a trigger condition for changing the splitting threshold being satisfied. For example, the trigger condition for changing the splitting threshold may be defined in the configuration information associated with selecting the split (e.g., the splitting threshold).

As further shown FIG. 8, and by reference number 830, the UE 120 may transmit, and at least one of the first network node 110-1 or the second network node 110-2 may receive, an indication of the splitting threshold selected by the UE 120. For example, the indication of the splitting threshold may indicate a split of a data volume across the first cell group (e.g., the MCG) and the second cell group (e.g., the SCG) to be applied for uplink and downlink communications. In some aspects, the UE 120 may transmit the indication of the splitting threshold via L3 signaling (e.g., an RRC message), L2 signaling (e.g., a MAC-CE), or L1 signaling (e.g., UCI). In some aspects, the UE 120 may transmit the indication of the splitting threshold to the MN, the SN, or both the MN and the SN.

As further shown in FIG. 8, and by reference number 835, the first network node 110-1 may transmit, and the UE 120 may receive, an acknowledgement of the indication of the splitting threshold. Additionally, or alternatively, as shown by reference number 835a, the second network node 110-2 may transmit, and the UE 120 may receive, an acknowledgement of the indication of the splitting threshold. In some aspects, the UE 120 may be applying the splitting threshold selected by the UE 120 (e.g., for uplink and/or downlink communications) in connection with receiving the acknowledgement.

As further shown in FIG. 8, and by reference number 840, the UE 120 may communicate with the first network node 110-1 and the second network node 110-2 via the first cell group and the second cell group, respectively, in accordance with the indication of the splitting threshold selected by the UE 120 (e.g., the indication of the split of a data volume across the first cell group and the second cell group selected by the UE 120). In some examples, the UE 120 may transmit uplink communications to the first network node 110-1 (e.g., the MN) via the first cell group (e.g., the MCG) and to the second network node 110-2 (e.g., the SN) via the second cell group in accordance with the indication of the splitting threshold. For example, the UE 120 may transmit a portion of a data volume via one of the first cell group or the second cell group until the splitting threshold is reached, and transmit a remaining portion of the data volume via the other one of the first cell group or the second cell group. In some aspects, a BSR requesting scheduling of the uplink communications to be transmitted by the UE 120 may be based on the splitting threshold selected by the UE 120. For example, the UE 120 may transmit, to at least one of the first network node 110-1 or the second network node 110-2, the BSR based on the splitting threshold selected by the UE 120. In this way, the splitting threshold selected by the UE 120 (and the corresponding slitting ratio resulting from applying the splitting threshold selected by the UE 120) may be enforced for the uplink communications.

In some examples, the first network node 110-1 may transmit downlink communications to the UE 120 via the first cell group and the second network node 110-2 may transmit downlink to the UE 120 via the second cell group in accordance with the indication of the splitting threshold selected by the UE 120. The first network node 110-1 and the second network node 110-2 may split downlink data between the first cell group and the second cell group in accordance with the splitting threshold. The UE 120 may receive downlink communications split across the first cell group and the second cell group in accordance with the indicated splitting threshold. For example, the UE 120 may receive a portion of a data volume of downlink data via one of the first cell group or the second cell group until the splitting threshold is reached, and receive a remaining portion of the data volume of downlink data via the other one of the first cell group or the second cell group. In some examples, the splitting threshold selected by the UE 120 may not be enforceable for downlink communications transmitted by the first network node 110-1 and the second network node 110-2. However, by using the splitting threshold selected by the UE 120 for downlink communications, the first network node 110-1 and the second network node 110-2 reduce wasting network resources for downlink communications to the UE 120 on a poor quality link when the UE 120 can be better served on other links.

As discussed above with reference to FIG. 8, the UE 120 may select the splitting threshold to be applied for splitting a data volume across the MCG and the SCG based at least in part on the channel conditions (e.g., the first CSI and the second CSI) for the UE 120 on the CCs of the MCG and the SCG. In some examples, the UE 120 may select the splitting threshold to favor use of a cell group (e.g., MCG or SCG) having the better channel conditions, such that more of a data volume is transmitted using the cell group having the better channel conditions. The UE 120 may transmit an indication of the selected splitting threshold to the MN and/or the SN. As a result, downlink and uplink throughput may be enhanced/increased for the DC communications. Furthermore, because the determination of the splitting threshold does not involve significant coordination between the MN and the SN, latency may be reduced and throughput May be further increased, as compared to the operations discussed above with reference to FIGS. 6 and 7.

Although the operations discussed above with reference to FIG. 8 are described in connection with DC, the operations discussed above with reference to FIG. 8 may be similarly applied to a DS scenario. In a DS scenario, the UE 120 may be connected to two networks independently. For example, the two networks may be associated with the same or different operators. The UE 120 may have two SIMs (e.g., two SIM cards), with each SIM used for connecting to a different network. In the DS scenario, the first network node 110-1 may be associated with a first network, and the second network node 110-2 may be associated with a second network. The UE 120 may connect to the first network via a first link with the first network node 110-1 and the second network via a second link the second network node 110-2. In such examples, the UE 120 may determine a splitting threshold for splitting a data volume between the first network and the second network, and the UE 120 may transmit an indication of the splitting threshold to the first network node 110-1 and/or the second network node 110-2, as described above with reference to FIG. 8.

As indicated above, FIG. 8 is provided as an example. Other examples may differ from what is described with respect to FIG. 8.

FIG. 9 is a diagram illustrating an example 900 associated with enhanced resource management for DC with dynamic sharing of UE resources. As shown in FIG. 9, a UE 120 may communicate with a first network node 110-1 and a second network node 110-2. In some aspects, the first network node 110-1, the second network node 110-2, and the UE 120 may be part of a wireless network (e.g., wireless network 100). The UE 120 may have established a wireless connection with the first network node 110-1 and the second network node 110-2 prior to operations shown in FIG. 9. In some aspects, the first network node 110-1 is an MN and the second network node 110-2 is an SN for dual connectivity communications with the UE 120. In such examples, a first cell group associated with the first network node 110-1 may be an MCG and a second cell group associated with the second network node 110-2 may be an SCG. In some aspects, the second network node 110-2 is the MN and the first network node 110-1 is the SN for dual connectivity communications with the UE 120. In such examples, the second cell group may be the MCG and the first cell group may be the SCG. In some aspects, the first network node 110-1 and the second network node 110-2 may be non-co-located.

In some aspects, such as in example 900 of FIG. 9, the UE 120 may transmit, and at least one of the first network node 110-1 or the second network node 110-2 may receive, second information associated with sharing UE resources (e.g., baseband resources, RF resources, and/or antennas of the UE 120, among other examples) across the first cell group and the second cell group. In such examples, the UE 120 may communicate with the first network node 110-1 via the first cell group and the second network node 110-2 via the second cell group in accordance with an allocation of the UE resources across the first cell group and the second cell group based at least in part on the second information.

In example 900, the second information may include or be included in UE capability information. For example, the second information may include UE capability information associated with a capability of the UE 120 for sharing the UE resources across the first cell group and the second cell group. In some aspects, the operations discussed with reference to FIG. 9 may be performed without management of the split of a data volume across the first cell group and the second cell group, as discussed above with reference to FIGS. 6-8. In some other aspects, the operations discussed with reference to FIG. 9 may be performed together with management of the split of a data volume across the first cell group and the second cell group. For example, the operations discussed with reference to FIG. 9 may be combined with the operations discussed with reference to FIG. 6, FIG. 7, or FIG. 8.

As shown in FIG. 9, and by reference number 905, the UE 120 may transmit, and the first network node 110-1 may receive, UE capability information. For example, the UE may transmit, and the first network node 110-1 may receive, a capability report including the UE capability information. Additionally, or alternatively, as shown by reference number 905a, the second network node 110-2 may receive the UE capability information. In some examples, the second network node 110-2 may receive the UE capability information from the first network node 110-1 (e.g., the first network node 110-1 may forward the UE capability information to the second network node 110-2). In some other examples, the second network node 110-2 may receive the UE capability information from the UE 120 (e.g., in addition to or instead of the first network node 110-1 receiving the UE capability information).

The UE capability information may indicate one or more capabilities associated with DC. For example, the UE capability information may indicate whether the UE 120 supports (e.g., is capable of) DC communication. In some aspects, the UE capability information may indicate one or more band combinations for which DC is supported by the UE 120. In some aspects, the UE capability information may indicate capabilities of the UE 120 for feature sets and/or maximum power in FR1 and FR2.

In some aspects, the UE capability information may include capability information associated with a capability of the UE 120 for sharing UE resources (e.g., baseband resources, RF resources, and/or antennas, among other examples) across the first cell group and the second cell group (e.g., sharing UE resources for communications via the first cell group and the second cell group). In some aspects, the capability information associated with the capability of the UE 120 for sharing UE resources may include a plurality of sharing capability profiles supported by the UE 120. For example, each sharing capability profile may correspond to a different sharing state (e.g., a different allocation of the UE resources for communications via different cell groups).

As further shown in FIG. 9, and by reference number 910, in some aspects, the first network node 110-1 and the second network node 110-2 may coordinate to determine an SCG configuration for the UE 120. In some aspects, the MN (e.g., the first network node 110-1) and the SN (e.g., the second network node 110-2) may coordinate to determine the SCG configuration for the UE 120 based at least in part on the UE capability information. For example, the MN may oversee resolving dependency between an MCG configuration and the SCG configuration of the UE 120. The MN may determine the MCG configuration and a list of possible configurations for the SCG, and the MN may transmit the list of possible configurations for the SCG to the SN. The list of possible configurations for the SCG may include possible DC band combinations and/or feature sets based at least in part on the UE capability information. In some examples, the SN may select an SCG configuration from the list of possible configurations for the SCG and report the selected SCG configuration to the MN. Alternatively, the SN may negotiate with the MN about the selection of the SCG configuration. For example, the SN may initiate a modification of the list of possible SCG configurations and indicate one or more desired SCG configurations (e.g., desired band combinations and/or feature sets) outside of the list of possible SCG configurations selected by the MN. The final determination of the SCG configuration may then be made by the MN.

As further shown in FIG. 9, and by reference number 915, the first network node 110-1 may transmit, and the UE 120 may receive, configuration information. In some examples, the MN (e.g., the first network node 110-1) may transmit the configuration information to the UE 120. In some examples, the UE 120 may receive the configuration information from the SN or from both the MN and the SN. In some aspects, the UE 120 may receive the configuration information via one or more RRC messages. Additionally, or alternatively, the UE 120 may receive the configuration information via system information (e.g., an MIB and/or an SIB, among other examples), one or more MAC-CEs, and/or DCI, among other examples.

In some aspects, the configuration information may indicate one or more candidate configurations and/or communication parameters. In some aspects, the one or more candidate configurations and/or communication parameters may be selected, activated, and/or deactivated by a subsequent indication. For example, the subsequent indication may select a candidate configuration and/or communication parameter from the one or more candidate configurations and/or communication parameters. In some aspects, the subsequent indication may include a dynamic indication, such as one or more MAC-CEs and/or one or more DCI messages, among other examples.

In some aspects, the configuration information may configure the UE 120 for DC communications. For example, the configuration information may include the MCG configuration and the SCG configuration for the UE 120. In some examples, the configuration information may indicate the CCs (or cells) in each cell group, the activated BWPs for the CCs in each cell group, and/or the number of MIMO layers to be used for each cell group, among other examples.

In some aspects, the configuration information may configure the UE 120 to perform channel measurements and report the channel measurements. For example, the configuration information may include configurations for one or CSI-RSs to be measured by the UE 120 and configurations for one or more CSI reports to be transmitted by the UE 120. In some aspects, the configuration information may configure the UE 120 to measure one or more first CSI-RSs associated with a first cell group (e.g., the MCG) and to measure one or more second CSI-RSs associated with a second cell group (e.g., the SCG). In such examples, the configuration information may configure the UE 120 to report first CSI associated with the first cell group (e.g., the MCG) to the first network node 110-1 (e.g., the MN) and to report second CSI associated with the second cell group (e.g., the SCG) to the second network node 110-2 (e.g., the SN).

In some aspects, the configuration information may indicate a set of candidate allocations of UE resources. Each candidate allocation of the set of candidate allocations may correspond to a respective possible allocation of how UE resources (e.g., BB resources, RF resources, and/or antennas of the UE 120, among other examples) are to be used across the MCG and SCG. The set of candidate allocations may be based at least in part on the plurality of sharing capability profiles indicated in the UE capability information. For example, each candidate allocation, in the set of candidate allocations, may correspond to sharing capability profile supported by the UE 120. In some aspects, the configuration information may indicate a mapping between each candidate allocation, of the set of candidate allocations, and a respective set of parameters to be used for that candidate allocation. For example, the respective set of parameters that is mapped to a candidate allocation may include parameters such as SRS resources, CSI feedback, and/or DCI sizes and/or formats to monitor, among other examples. In some aspects, the configuration information may indicate an initial or default allocation of UE resources that is selected from the set of candidate allocations.

As further shown in FIG. 9, and by reference number 920, the UE 120 may perform channel measurements for the MCG and the SCG. For example, the first network node 110-1 may transmit the one or more first CSI-RSs via the first cell group (e.g., the MCG), and the UE 120 may perform channel measurements on the one or more first CSI-RSs. The UE 120 may determine or derive first CSI based at least in part on the channel measurements performed on the one or more first CSI-RSs. The first CSI may include one or more estimates and/or measurements of channel conditions (e.g., downlink channel conditions) on the UE channel to the first cell group (e.g., the MCG). The UE 120 may perform channel measurements for each CC of the first cell group, and the first CSI may include CSI for each CC of the first cell group. The second network node may transmit the one or more second CSI-RSs via the second cell group (e.g., the SCG), and the UE 120 may perform channel measurements on the one or more second CSI-RSs. The UE 120 may determine or derive second CSI based at least in part on the channel measurements performed on the one or more second CSI-RSs. The second CSI may include one or more estimates and/or measurements of channel conditions (e.g., downlink channel conditions) on the UE channel to the second cell group (e.g., the SCG). The UE 120 may perform channel measurements for each CC of the second cell group, and the second CSI may include CSI for each CC of the second cell group.

As further shown in FIG. 9, and by reference number 925, the UE 120 may transmit, and the first network node 110-1 may receive, the first CSI. For example, the UE 120 may transmit, to the first network node 110-1, a first CSI report including the first CSI. The first CSI is associated with the UE 120 and the first cell group (e.g., the MCG). That is, the first CSI indicates, to the first network node 110-1, the channel conditions for the downlink channel between the first network node 110-1 and the UE 120 (e.g., the UE channel to the first cell group). In some aspects, the UE 120 may transmit the first CSI based at least in part on a CSI reporting configuration included in the configuration information. In some aspects, the UE 120 may transmit the first CSI in connection with receiving a request from the first network node 110-1 or being configured with a specific setting for CSI associated with coordinating sharing of the UE resources. In some other examples, in a case in which downlink/uplink reciprocity holds between the UE 120 and the first network node 110-1, the first network node 110-1 may determine the channel conditions for the downlink channel between the first network node 110-1 and the UE 120 via uplink channel sounding.

As further shown in FIG. 9, and by reference number 930, the UE 120 may transmit, and the second network node 110-2 may receive, the second CSI. For example, the UE 120 may transmit, to the second network node 110-2, a second CSI report including the second CSI. The second CSI is associated with the UE 120 and the second cell group (e.g., the SCG). That is, the second CSI indicates, to the second network node 110-2, the channel conditions for the downlink channel between the second network node 110-2 and the UE 120 (e.g., the UE channel to the second cell group). In some aspects, the UE 120 may transmit the second CSI based at least in part on a CSI reporting configuration included in the configuration information. In some aspects, the UE 120 may transmit the second CSI in connection with receiving a request from the second network node 110-2 or being configured with a specific setting for CSI associated with coordinating sharing of the UE resources. In some other examples, in a case in which downlink/uplink reciprocity holds between the UE 120 and the second network node 110-2, the second network node 110-2 may determine the channel conditions for the downlink channel between the second network node 110-2 and the UE 120 via uplink channel sounding.

As further shown in FIG. 9, and by reference number 935, the first network node 110-1 and/or the second network node 110-2 may communicate the CSI received from the UE 120, and the first network node 110-1 and/or the second network node 110-2 may determine a change in the allocation of UE resources (e.g., baseband resources, RF resource, and/or antennas, among other examples) across the first cell group (e.g., the MCG) and the second cell group (e.g., the SCG).

In some aspects, the MN and the SN may exchange their local CSI (e.g., the CSI associated with the MCG and the CSI associated with the SCG). For example, the first network node 110-1 may transmit the first CSI to the second network node 110-2, and the second network node 110-2 may transmit the second CSI to the first network node 110-1. In some other aspects, one of the MN or the SN may transmit the local CSI received from the UE 120 to the other one of the MN or the SN. In some examples, the first network node 110-1 may obtain the second CSI from the second network node 110-2 (e.g., the second network node 110-2 may transmit the second CSI to the first network node 110-1). In some other examples, the second network node 110-2 may obtain the first CSI from the first network node 110-1 (e.g., the first network node 110-1 may transmit the first CSI to the second network node 110-2). In some aspects, the CSI transmitted by the MN (e.g., the first network node 110-1) and/or the SN (e.g., the second network node 110-2) may include or be transmitted with information identifying the UE 120 and each serving cell of the UE 120 (e.g., information associating the CSI with the UE 120 and each serving cell of the UE 120). In some other aspects, the UE 120 may be configured to report the CSI (or some parts of CSI, such as a CQI, a PMI, or an L1-RSRP, among other examples) of one cell group to the other cell group. For example, the UE 120 may transmit the second CSI to both the second cell group (e.g., the SCG) and the first cell group (e.g., the MCG). In such examples, there may be no need for the first network node 110-1 (e.g., the MN) and the second network node 110-2 (e.g., the SN) to exchange the CSI.

The first network node 110-1 and/or the second network node 110-2 may determine a change in the allocation of the UE resources to be applied by the UE 120 across the MCG and the SCG. For example, the first network node 110-1 and/or the second network node 110-2 may determine a change from a previous allocation of the UE resources across the first cell group and the second cell group to a new allocation of the UE resources across the first cell group and the second cell group based at least in part on the UE capability information (e.g., the supported possible allocations indicated in the UE capability information), the first CSI, and the second CSI. In some aspects, the first network node 110-1 and/or the second network node 110-2 may select the new allocation of the UE resources from the set of candidate allocations indicated in the configuration information. For example, the previous allocation may correspond to a first candidate allocation of the set of allocations, and the new allocation may correspond to a second candidate allocation of the set of allocations.

In some aspects, one of the MN or the SN may determine the change in the allocation of the UE resources. In some examples, the first network node 110-1 may determine the change in the allocation of the UE resources. In such examples, the first network node 110-1 may obtain the second CSI from the second network node 110-2, and the first network node 110-1 may determine the change in the allocation of the UE resources across the first cell group and the second cell group based at least on the first CSI (received from the UE 120) and the second CSI. In some other examples, the second network node 110-2 may determine the change in the allocation of the UE resources. In such examples, the second network node 110-2 may obtain the first CSI from the first network node 110-1, and the second network node 110-2 may determine the change in the allocation of the UE resources based at least on the first CSI and the second CSI (received from the UE 120). In some aspects, the MN and the SN may coordinate to determine the change in the allocation of the UE resources. For example, the first network node 110-1 and the second network node 110-2 may exchange CSI information and then perform negotiation and/or handshaking communications to determine the change in the allocation of the UE resources based at least in part on the first CSI information and the second CSI information. In some examples, the first network node 110-1 and the second network node 110-2 may determine the change in allocation of the UE resources to increase UE resources (e.g., baseband resources, RF resource, and/or antennas, among other examples) allocated for a cell group (e.g., MCG or SCG) having the better channel conditions.

In some aspects, the UE 120 may provide relevant feedback (e.g., the second CSI) targeted to the SN (e.g., the second network node 110-2) or to the MN (e.g., the first network node 110-1) as well as the SN. In such examples, the MN (e.g., the first network node 110-1) may determine the change in the allocation of the UE resources and then inform the SN (e.g., the second network node 110-2) about the change in settings associated with the change in the allocation of the UE resources. This may reduce latency incurred during the CSI exchange, negotiation, and handshaking across the MN and the SN.

As further shown in FIG. 9, and by reference number 940, the first network node 110-1 may transmit, and the UE 120 may receive, an indication of the change in allocation of the UE resources across the first cell group and the second cell group. Additionally, or alternatively, as shown by reference number 940a, the second network node 110-2 may transmit, and the UE 120 may receive, the indication of the change in allocation of the UE resources across the first cell group and the second cell group. In some examples, the indication of the change in allocation of the UE resources may be transmitted to the UE 120 via the first cell group (e.g., from the first network node 110-1), via the second cell group (e.g., from the second network node 110-2), or via both the first cell group and the second cell group. In some aspects, the indication of the change in allocation of the UE resources may include an indication of a candidate allocation, of the set of candidate allocations indicated in the configuration information, that corresponds to the new allocation. For example, the indication of the change in allocation of the UE resources may indicate a change from a first candidate allocation of the set of candidate allocations to a second candidate allocation of the set of candidate allocations. In some examples, the change in allocation of the UE resources may increase UE resources (e.g., baseband resources, RF resource, and/or antennas, among other examples) allocated for a cell group (e.g., MCG or SCG) having the better channel conditions. For example, the change in the allocation of the UE resources from the first candidate allocation to the second candidate allocation may increase UE resources (e.g., baseband resources, RF resource, and/or antennas, among other examples) allocated for a cell group (e.g., MCG or SCG) having the better channel conditions by re-allocating UE resources previously allocated for the other cell group having the worse channel conditions in the first candidate allocation.

In some aspects, the indication of the change in allocation of the UE resources may be included in an RRC message (e.g., an RRC reconfiguration message). In some other aspects, the indication of the change in allocation of the UE resources may be transmitted via L2 signaling (e.g., in a MAC-CE) or L1 signaling (e.g., in DCI). In some aspects, such as when the indication of the change in allocation of the UE resources is transmitted via L1 or L2 signaling, the set of parameters that is mapped to the candidate allocation, of the set of candidate allocations, that corresponds to the new allocation may be used by the UE 120 when applying the new allocation of the UE resources. For example, the new allocation may correspond to a change in a number of layers and/or antennas per CC of a cell group, and the set of parameters that is mapped to the candidate allocation corresponding to the new allocation may include parameters indicating SRS resources, CSI feedback, and/or DCI sizes and/or formats to monitor. As a result of the mapping of the set of parameters to the candidate allocation, the UE 120 may update parameters in connection with receiving the indication of the change in the allocation of the UE resources, without applying a full RRC reconfiguration, which reduces latency.

As further shown in FIG. 9, and by reference number 945, the UE 120 may communicate with the first network node 110-1 and the second network node 110-2 via the first cell group and the second cell group, respectively, in accordance with the new allocation of the UE resources (e.g., baseband resources, RF resources, and/or antennas, among other examples) across the first cell group and the second cell group. In some examples, the UE 120 may apply the new allocation of the UE resources across the first cell group and the second cell group for transmission of uplink communications to the first network node 110-1 (e.g., the MN) via the first cell group (e.g., the MCG) and to the second network node 110-2 (e.g., the SN) via the second cell group. In some examples, the first network node 110-1 may transmit downlink communications to the UE 120 via the first cell group and the second network node 110-2 may transmit downlink to the UE 120 via the second cell group. In such examples, the UE 120 may apply the new allocation of the UE resources across the first cell group and the second cell group for reception of the downlink communications transmitted from the first network node 110-1 (e.g., the MN) via the first cell group (e.g., the MCG) and from the second network node 110-2 (e.g., the SN) via the second cell group (e.g., the SCG).

As discussed above with reference to FIG. 9, the MN and/or the SN may exchange CSI associated with the MCG and CSI associated with the SCG, and the MN and/or the SN may determine a change in the allocation of UE resources based at least in part on the CSI associated with the MCG, the CSI associated with the SCG, and capability information indicating resource allocations supported by the UE 120. In some examples, the change in allocation of the UE resources may be determined to increase UE resources allocated for a cell group (e.g., MCG or SCG) having the better channel conditions. Therefore, the MN and/or the SN may manage dynamic sharing of UE resources, by the UE 120, based at least in part on the channel conditions (e.g., link quality) for the UE 120 on the CCs of the MCG and the SCG. As a result, downlink and uplink throughput may be enhanced/increased for the DC communications.

Although the operations discussed above with reference to FIG. 9 are described in connection with DC, the operations discussed above with reference to FIG. 9 may be similarly applied to a DS scenario. In a DS scenario, the UE 120 may be connected to two networks independently. For example, the two networks may be associated with the same or different operators. The UE 120 may have two SIMs (e.g., two SIM cards), with each SIM used for connecting to a different network. In the DS scenario, the first network node 110-1 may be associated with a first network, and the second network node 110-2 may be associated with a second network. The UE 120 may connect to the first network via a first link with the first network node 110-1 and the second network via a second link the second network node 110-2. In such examples, the UE 120 may transmit, to the first network node 110-1 and/or the second network node 110-2, UE capability information associated with sharing UE resources across the first network and the second network, as described above with reference to FIG. 9. In such examples, the UE 120 may transmit the CSI of one network to the network node associated with the other network. For example, the UE 120 may transmit the CSI of the first network to the second network node 110-2, and/or the UE 120 may transmit the CSI of the second network to the first network node 110-1.

As indicated above, FIG. 9 is provided as an example. Other examples may differ from what is described with respect to FIG. 9.

FIG. 10 is a diagram illustrating an example 1000 associated with enhanced resource management for DC with dynamic sharing of UE resources. As shown in FIG. 10, a UE 120 may communicate with a first network node 110-1 and a second network node 110-2. In some aspects, the first network node 110-1, the second network node 110-2, and the UE 120 may be part of a wireless network (e.g., wireless network 100). The UE 120 may have established a wireless connection with the first network node 110-1 and the second network node 110-2 prior to operations shown in FIG. 10. In some aspects, the first network node 110-1 is an MN and the second network node 110-2 is an SN for dual connectivity communications with the UE 120. In such examples, a first cell group associated with the first network node 110-1 may be an MCG and a second cell group associated with the second network node 110-2 may be an SCG. In some aspects, the second network node 110-2 is the MN and the first network node 110-1 is the SN for dual connectivity communications with the UE 120. In such examples, the second cell group may be the MCG and the first cell group may be the SCG. In some aspects, the first network node 110-1 and the second network node 110-2 may be non-co-located.

In some aspects, such as in example 1000 of FIG. 10, the UE 120 may transmit, and at least one of the first network node 110-1 or the second network node 110-2 may receive, second information associated with sharing UE resources (e.g., baseband resources, RF resources, and/or antennas of the UE 120, among other examples) across the first cell group and the second cell group. In such examples, the UE 120 may communicate with the first network node 110-1 via the first cell group and the second network node 110-2 via the second cell group in accordance with an allocation of the UE resources across the first cell group and the second cell group based at least in part on the second information. In example 1000, the second information may include or be included in enhanced UAI. For example, the second information may include UAI that indicates a request for increasing UE resources allocated for a first one of the first cell group or the second cell group and/or a request for decreasing UE resources allocated for a second one or the first cell group or the second cell group. In some aspects, the operations discussed with reference to FIG. 10 may be performed without management of the split of a data volume across the first cell group and the second cell group, as discussed above with reference to FIGS. 6-8. In some other aspects, the operations discussed with reference to FIG. 10 may be performed together with management of the split of a data volume across the first cell group and the second cell group. For example, the operations discussed with reference to FIG. 10 may be combined with the operations discussed with reference to FIG. 6, FIG. 7, or FIG. 8.

As shown in FIG. 10, and by reference number 1005, the UE 120 may transmit, and the first network node 110-1 may receive, UE capability information. For example, the UE may transmit, and the first network node 110-1 may receive, a capability report including the UE capability information. Additionally, or alternatively, the second network node 110-2 may receive the UE capability information. In some examples, the second network node 110-2 may receive the UE capability information from the first network node 110-1 (e.g., the first network node 110-1 may forward the UE capability information to the second network node 110-2). In some other examples, the second network node 110-2 may receive the UE capability information from the UE 120 (e.g., in addition to or instead of the first network node 110-1 receiving the UE capability information).

The UE capability information may indicate one or more capabilities associated with DC. For example, the UE capability information may indicate whether the UE 120 supports (e.g., is capable of) DC communication. In some aspects, the UE capability information may indicate one or more band combinations for which DC is supported by the UE 120. In some aspects, the UE capability information may indicate capabilities of the UE 120 for feature sets and/or maximum power in FR1 and FR2.

In some aspects, the UE capability information may include capability information associated with a capability of the UE 120 for sharing UE resources (e.g., baseband resources, RF resources, and/or antennas, among other examples) across the first cell group and the second cell group (e.g., sharing UE resources for communications via the first cell group and the second cell group). In some aspects, the capability information associated with the capability of the UE 120 for sharing UE resources may include a plurality of sharing capability profiles supported by the UE 120. For example, each sharing capability profile may correspond to a different sharing state (e.g., a different allocation of the UE resources for communications via different cell groups).

As further shown in FIG. 10, and by reference number 1010, in some aspects, the first network node 110-1 and the second network node 110-2 may coordinate to determine an SCG configuration for the UE 120. In some aspects, the MN (e.g., the first network node 110-1) and the SN (e.g., the second network node 110-2) may coordinate to determine the SCG configuration for the UE 120 based at least in part on the UE capability information. For example, the MN may oversee resolving dependency between an MCG configuration and the SCG configuration of the UE 120. The MN may determine the MCG configuration and a list of possible configurations for the SCG, and the MN may transmit the list of possible configurations for the SCG to the SN. The list of possible configurations for the SCG may include possible DC band combinations and/or feature sets based at least in part on the UE capability information. In some examples, the SN may select an SCG configuration from the list of possible configurations for the SCG and report the selected SCG configuration to the MN. Alternatively, the SN may negotiate with the MN about the selection of the SCG configuration. For example, the SN may initiate a modification of the list of possible SCG configurations and indicate one or more desired SCG configurations (e.g., desired band combinations and/or feature sets) outside of the list of possible SCG configurations selected by the MN. The final determination of the SCG configuration may then be made by the MN.

As further shown in FIG. 10, and by reference number 1015, the first network node 110-1 may transmit, and the UE 120 may receive, configuration information. In some examples, the MN (e.g., the first network node 110-1) may transmit the configuration information to the UE 120. In some examples, the UE 120 may receive the configuration information from the SN or from both the MN and the SN. In some aspects, the UE 120 may receive the configuration information via one or more RRC messages. Additionally, or alternatively, the UE 120 may receive the configuration information via system information (e.g., an MIB and/or an SIB, among other examples), one or more MAC-CEs, and/or DCI, among other examples.

In some aspects, the configuration information may indicate one or more candidate configurations and/or communication parameters. In some aspects, the one or more candidate configurations and/or communication parameters may be selected, activated, and/or deactivated by a subsequent indication. For example, the subsequent indication may select a candidate configuration and/or communication parameter from the one or more candidate configurations and/or communication parameters. In some aspects, the subsequent indication may include a dynamic indication, such as one or more MAC-CEs and/or one or more DCI messages, among other examples.

In some aspects, the configuration information may configure the UE 120 for DC communications. For example, the configuration information may include the MCG configuration and the SCG configuration for the UE 120. In some examples, the configuration information may indicate the CCs (or cells) in each cell group, the activated BWPs for the CCs in each cell group, and/or the number of MIMO layers to be used for each cell group, among other examples.

In some aspects, the configuration information may configure the UE 120 to perform channel measurements and report the channel measurements. For example, the configuration information may include configurations for one or more CSI-RSs to be measured by the UE 120 and configurations for one or more CSI reports to be transmitted by the UE 120. In some aspects, the configuration information may configure the UE 120 to measure one or more first CSI-RSs associated with a first cell group (e.g., the MCG) and to measure one or more second CSI-RSs associated with a second cell group (e.g., the SCG). In such examples, the configuration information may configure the UE 120 to report first CSI associated with the first cell group (e.g., the MCG) to the first network node 110-1 (e.g., the MN) and to report second CSI associated with the second cell group (e.g., the SCG) to the second network node 110-2 (e.g., the SN).

In some aspects, the configuration information may indicate a set of candidate allocations of UE resources. Each candidate allocation of the set of candidate allocations may correspond to a respective possible allocation of how UE resources (e.g., BB resources, RF resources, and/or antennas of the UE 120, among other examples) are to be used across the MCG and SCG. The set of candidate allocations may be based at least in part on the plurality of sharing capability profiles indicated in the UE capability information. For example, each candidate allocation, in the set of candidate allocations, may correspond to sharing capability profile supported by the UE 120. In some aspects, the configuration information may indicate a mapping between each candidate allocation, of the set of candidate allocations, and a respective set of parameters to be used for that candidate allocation. For example, the respective set of parameters that is mapped to a candidate allocation may include parameters such as SRS resources, CSI feedback, and/or DCI sizes and/or formats to monitor, among other examples. In some aspects, the configuration information may indicate an initial or default allocation of UE resources that is selected from the set of candidate allocations.

As further shown in FIG. 10, and by reference number 1020, the UE 120 may perform channel measurements for the MCG and the SCG. For example, the first network node 110-1 may transmit the one or more first CSI-RSs via the first cell group (e.g., the MCG), and the UE 120 may perform channel measurements on the one or more first CSI-RSs. The UE 120 may determine or derive first CSI based at least in part on the channel measurements performed on the one or more first CSI-RSs. The first CSI may include one or more estimates and/or measurements of channel conditions (e.g., downlink channel conditions) on the UE channel to the first cell group (e.g., the MCG). The UE 120 may perform channel measurements for each CC of the first cell group, and the first CSI may include CSI for each CC of the first cell group. The second network node may transmit the one or more second CSI-RSs via the second cell group (e.g., the SCG), and the UE 120 may perform channel measurements on the one or more second CSI-RSs. The UE 120 may determine or derive second CSI based at least in part on the channel measurements performed on the one or more second CSI-RSs. The second CSI may include one or more estimates and/or measurements of channel conditions (e.g., downlink channel conditions) on the UE channel to the second cell group (e.g., the SCG). The UE 120 may perform channel measurements for each CC of the second cell group, and the second CSI may include CSI for each CC of the second cell group.

In some aspects, the UE 120 may transmit, and the first network node 110-1 may receive, the first CSI. For example, the UE 120 may transmit, to the first network node 110-1, a first CSI report including the first CSI. In some aspects, the UE 120 may transmit, and the second network node 110-2 may receive, the second CSI. For example, the UE 120 may transmit, to the second network node 110-2, a second CSI report including the second CSI.

As further shown in FIG. 10, and by reference number 1025, the UE 120 may transmit, and at least one of the first network node 110-1 or the second network node 110-2 may receive, UAI indicating a request to change the allocation of UE resources across the MCG (e.g., the first cell group) and the SCG (e.g., the second cell group). The UE 120 may have access to the channel conditions (e.g., the first CSI) between the UE 120 and the MN on each of the CCs configured for the MCG and the channel conditions (e.g., the second CSI) between the UE 120 and the SN on each of the CCs configured for the SCG. In some aspects, the UE 120 may determine a preference for how to allocate the UE resources across the MCG and SCG based at least in part on the channel conditions associated with the MCG and the SCG. The UE 120 may transmit the UAI indicating the request to change the allocation of UE resources based at least in part on the preference for how to allocate the UE resources across the MCG and SCG. In some examples, the UAI may request the change in the allocation of the UE resources to increase the UE resources (e.g., baseband resources, RF resource, and/or antennas, among other examples) allocated for a cell group (e.g., MCG or SCG) having the better channel conditions.

The UAI (also referred to as “enhanced UAI”) may be used not only for power saving considerations, but also for dynamic sharing of UE resources across the MCG and the SCG (e.g., to increase throughput of DC communications). Accordingly, the UAI may enable the UE 120 to request both upgrades (e.g., increases in one or more parameters) and downgrades (e.g., decreases in one or more parameters) for the configured UE resources allocated for communications associated with a cell group. In some aspects, the UAI may indicate a request for an increasing (e.g., upgrading) UE resources allocated for a first one of the MCG (e.g., the first cell group) or the SCG (e.g., the second cell group). Additionally, or alternatively, the UAI may indicate a request for decreasing (e.g., downgrading) UE 120 resources allocated for a second one of the MCG (e.g., the first cell group) or the SCG (e.g., the second cell group). In some aspects, the UAI may indicate a joint request for increasing (e.g., upgrading) the UE resources allocated for one of the MCG or the SCG and decreasing (e.g., downgrading) the UE resources allocated for the other one of the MCG or the SCG. In some aspects, the UAI may include a per cell group request (e.g., for each of the MCG and the SCG) upgrading and/or downgrading one or more UE resources (e.g., a number of layers, a number of Rx antennas, a number of resource blocks (RBs), and/or a processing time, among other examples) allocated for the cell group.

In some examples, the UE 120 may transmit the UAI message including the UAI to a deciding network node (e.g., the MN) or to both the MN and the SN. In some aspects, for fast adaptation of the allocation of the UE resources, the UE 120 may transmit the UAI via L1 signaling (e.g., UCI) or L2 signaling (e.g., a MAC-CE).

In some aspects, the UE 120 may transmit, and at least one of the first network node 110-1 or the second network node 110-2 may receive, a dynamic capability update that indicates an updated allocation of the UE resources supported by the UE 120. For example, the UE 120 may transmit the dynamic capability update as an alternative to, or in addition to, the UAI. In some examples, the UE 120 may transmit the dynamic capability update to signal a network entity new capability for a given CC (e.g., of the MCG or the SCG). In such examples, the new capability may be considered (e.g., by the first network node 110-1 or the second network node 110-2) as a preference as the UE 120. In some aspects, the UE 120 may transmit the dynamic capability update via L1 signaling (e.g., DCI), L2 signaling (e.g., a MAC-CE), or L3 signaling (e.g., an RRC message).

As further shown in FIG. 10, and by reference number 1030, the first network node 110-1 may transmit, and the UE 120 may receive, an indication of an allocation of the UE resources across the first cell group and the second cell group. Additionally, or alternatively, as shown by reference number 1030a, the second network node 110-2 may transmit, and the UE 120 may receive, the indication of the allocation of the UE resources across the first cell group and the second cell group. In some examples, the indication of the allocation of the UE resources may be transmitted to the UE 120 via the first cell group (e.g., from the first network node 110-1), via the second cell group (e.g., from the second network node 110-2), or via both the first cell group and the second cell group. In some aspects, the indication of the allocation of the UE resources may be based at least in part on the UAI transmitted by the UE 120.

In some examples, the indication of the allocation of the UE resources may indicate a change from a previous allocation of the UE resources across the first cell group and the second cell group to a new allocation of the UE resources across the first cell group and the second cell group. In some aspects, the indication of the allocation of the UE resources may include an indication of a candidate allocation, of the set of candidate allocations indicated in the configuration information, that corresponds to the new allocation. For example, the indication of the allocation of the UE resources may indicate a change from a first candidate allocation of the set of candidate allocations to a second candidate allocation of the set of candidate allocations.

In some aspects, the indication of the allocation of the UE resources may be transmitted (e.g., based at least in part on the UAI) via L1 signaling (e.g., in DCI) or L2 signaling (e.g., in a MAC-CE). In some aspects, the set of parameters that is mapped to the candidate allocation, of the set of candidate allocations, that corresponds to the new allocation may be used by the UE 120 when applying the new allocation of the UE resources.

In some aspects, in a case in which the UE 120 transmits the dynamic capability update, the indication of the allocation of the UE resources may be based at least in part on the dynamic capability update. In such examples in which the indication of the allocation of the UE resources is based on the dynamic capability update, the indication of the allocation of the UE resources may be transmitted via L1 signal (e.g., in DCI), L2 signaling (e.g., in a MAC-CE), or L3 signaling (e.g., in an RRC message). In a case in which the request for the updated allocation associated with the dynamic capability update is granted by the network (e.g., by the first network node 110-1 or the second network node 110-2), the indication of the allocation of the UE 120 resources may a change from a previous allocation of the UE resources across the first cell group and the second cell group to the updated allocation of the UE resources across the first cell group and the second cell group.

As further shown in FIG. 10, and by reference number 1035, the UE 120 may communicate with the first network node 110-1 and the second network node 110-2 via the first cell group and the second cell group, respectively, in accordance with the indicated allocation of the UE resources (e.g., baseband resources, RF resources, and/or antennas, among other examples) across the first cell group and the second cell group. In some examples, the UE 120 may apply the indicated allocation of the UE resources (e.g., the new allocation of the UE resources) across the first cell group and the second cell group for transmission of uplink communications to the first network node 110-1 (e.g., the MN) via the first cell group (e.g., the MCG) and to the second network node 110-2 (e.g., the SN) via the second cell group. In some examples, the first network node 110-1 may transmit downlink communications to the UE 120 via the first cell group and the second network node 110-2 may transmit downlink to the UE 120 via the second cell group. In such examples, the UE 120 may apply the indicated allocation of the UE resources (e.g., the new allocation of the UE resources) across the first cell group and the second cell group for reception of the downlink communications transmitted from the first network node 110-1 (e.g., the MN) via the first cell group (e.g., the MCG) and from the second network node 110-2 (e.g., the SN) via the second cell group (e.g., the SCG).

As discussed above with reference to FIG. 10, the UE 120 may transmit UAI (or a dynamic capability update) that requests a change in the allocation of the UE resources determined based at least in part on the CSI associated with the MCG and the CSI associated with the SCG. In some examples, the UAI may request the change in the allocation of the UE resources to increase the UE resources allocated for a cell group (e.g., MCG or SCG) having the better channel conditions. This enables the MN and/or the SN indicate the change in the allocation of the UE resources based at least in part on the UAI (or the dynamic capability update). As a result, downlink and uplink throughput may be enhanced/increased for the DC communications.

Although the operations discussed above with reference to FIG. 10 are described in connection with DC, the operations discussed above with reference to FIG. 10 may be similarly applied to a DS scenario. In a DS scenario, the UE 120 may be connected to two networks independently. For example, the two networks may be associated with the same or different operators. The UE 120 may have two SIMs (e.g., two SIM cards), with each SIM used for connecting to a different network. In the DS scenario, the first network node 110-1 may be associated with a first network, and the second network node 110-2 may be associated with a second network. The UE 120 may connect to the first network via a first link with the first network node 110-1 and the second network via a second link the second network node 110-2. In such examples, the UE 120 may transmit, to the first network node 110-1 and/or the second network node 110-2, UAI indicating a preference or request for changing an allocation of UE resources associated with the first network and/or the second network, as described above with reference to FIG. 10.

As indicated above, FIG. 10 is provided as an example. Other examples may differ from what is described with respect to FIG. 10.

FIG. 11 is a diagram illustrating an example 1100 associated with enhanced resource management for DC with dynamic sharing of UE resources. As shown in FIG. 11, a UE 120 may communicate with a first network node 110-1 and a second network node 110-2. In some aspects, the first network node 110-1, the second network node 110-2, and the UE 120 may be part of a wireless network (e.g., wireless network 100). The UE 120 may have established a wireless connection with the first network node 110-1 and the second network node 110-2 prior to operations shown in FIG. 11. In some aspects, the first network node 110-1 is an MN and the second network node 110-2 is an SN for dual connectivity communications with the UE 120. In such examples, a first cell group associated with the first network node 110-1 may be an MCG and a second cell group associated with the second network node 110-2 may be an SCG. In some aspects, the second network node 110-2 is the MN and the first network node 110-1 is the SN for dual connectivity communications with the UE 120. In such examples, the second cell group may be the MCG and the first cell group may be the SCG. In some aspects, the first network node 110-1 and the second network node 110-2 may be non-co-located.

In some aspects, such as in example 1100 of FIG. 11, the UE 120 may transmit, and at least one of the first network node 110-1 or the second network node 110-2 may receive, second information associated with sharing UE resources (e.g., baseband resources, RF resources, and/or antennas of the UE 120, among other examples) across the first cell group and the second cell group. In such examples, the UE 120 may communicate with the first network node 110-1 via the first cell group and the second network node 110-2 via the second cell group in accordance with an allocation of the UE resources across the first cell group and the second cell group based at least in part on the second information. In example 1100, the second information may indicate an allocation of UE resources across the first cell group and the second cell group to be used for DC communications. For example, the second information may indicate an allocation of the UE resources that is determined by the UE 120. In some aspects, the operations discussed with reference to FIG. 11 may be performed without management of the split of a data volume across the first cell group and the second cell group, as discussed above with reference to FIGS. 6-8. In some other aspects, the operations discussed with reference to FIG. 11 may be performed together with management of the split of a data volume across the first cell group and the second cell group. For example, the operations discussed with reference to FIG. 11 may be combined with the operations discussed with reference to FIG. 6, FIG. 7, or FIG. 8.

As shown in FIG. 11, and by reference number 1105, the UE 120 may transmit, and the first network node 110-1 may receive, UE capability information. For example, the UE may transmit, and the first network node 110-1 may receive, a capability report including the UE capability information. Additionally, or alternatively, the second network node 110-2 may receive the UE capability information. In some examples, the second network node 110-2 may receive the UE capability information from the first network node 110-1 (e.g., the first network node 110-1 may forward the UE capability information to the second network node 110-2). In some other examples, the second network node 110-2 may receive the UE capability information from the UE 120 (e.g., in addition to or instead of the first network node 110-1 receiving the UE capability information).

The UE capability information may indicate one or more capabilities associated with DC. For example, the UE capability information may indicate whether the UE 120 supports (e.g., is capable of) DC communication. In some aspects, the UE capability information may indicate one or more band combinations for which DC is supported by the UE 120. In some aspects, the UE capability information may indicate capabilities of the UE 120 for feature sets and/or maximum power in FR1 and FR2.

In some aspects, the UE capability information may include capability information associated with a capability of the UE 120 for sharing UE resources (e.g., baseband resources, RF resources, and/or antennas, among other examples) across the first cell group and the second cell group (e.g., sharing UE resources for communications via the first cell group and the second cell group). In some aspects, the capability information associated with the capability of the UE 120 for sharing UE resources may include a plurality of sharing capability profiles supported by the UE 120. For example, each sharing capability profile may correspond to a different sharing state (e.g., a different allocation of the UE resources for communications via different cell groups).

As further shown in FIG. 11, and by reference number 1110, in some aspects, the first network node 110-1 and the second network node 110-2 may coordinate to determine an SCG configuration for the UE 120. In some aspects, the MN (e.g., the first network node 110-1) and the SN (e.g., the second network node 110-2) may coordinate to determine the SCG configuration for the UE 120 based at least in part on the UE capability information. For example, the MN may oversee resolving dependency between an MCG configuration and the SCG configuration of the UE 120. The MN may determine the MCG configuration and a list of possible configurations for the SCG, and the MN may transmit the list of possible configurations for the SCG to the SN. The list of possible configurations for the SCG may include possible DC band combinations and/or feature sets based at least in part on the UE capability information. In some examples, the SN may select an SCG configuration from the list of possible configurations for the SCG and report the selected SCG configuration to the MN. Alternatively, the SN may negotiate with the MN about the selection of the SCG configuration. For example, the SN may initiate a modification of the list of possible SCG configurations and indicate one or more desired SCG configurations (e.g., desired band combinations and/or feature sets) outside of the list of possible SCG configurations selected by the MN. The final determination of the SCG configuration may then be made by the MN.

As further shown in FIG. 11, and by reference number 1115, the first network node 110-1 may transmit, and the UE 120 may receive, configuration information. In some examples, the MN (e.g., the first network node 110-1) may transmit the configuration information to the UE 120. In some examples, the UE 120 may receive the configuration information from the SN or from both the MN and the SN. In some aspects, the UE 120 may receive the configuration information via one or more RRC messages. Additionally, or alternatively, the UE 120 may receive the configuration information via system information (e.g., an MIB and/or an SIB, among other examples), one or more MAC-CEs, and/or DCI, among other examples.

In some aspects, the configuration information may indicate one or more candidate configurations and/or communication parameters. In some aspects, the one or more candidate configurations and/or communication parameters may be selected, activated, and/or deactivated by a subsequent indication. For example, the subsequent indication may select a candidate configuration and/or communication parameter from the one or more candidate configurations and/or communication parameters. In some aspects, the subsequent indication may include a dynamic indication, such as one or more MAC-CEs and/or one or more DCI messages, among other examples.

In some aspects, the configuration information may configure the UE 120 for DC communications. For example, the configuration information may include the MCG configuration and the SCG configuration for the UE 120. In some examples, the configuration information may indicate the CCs (or cells) in each cell group, the activated BWPs for the CCs in each cell group, and/or the number of MIMO layers to be used for each cell group, among other examples.

In some aspects, the configuration information may configure the UE 120 to perform channel measurements and report the channel measurements. For example, the configuration information may include configurations for one or more CSI-RSs to be measured by the UE 120 and configurations for one or more CSI reports to be transmitted by the UE 120. In some aspects, the configuration information may configure the UE 120 to measure one or more first CSI-RSs associated with a first cell group (e.g., the MCG) and to measure one or more second CSI-RSs associated with a second cell group (e.g., the SCG). In such examples, the configuration information may configure the UE 120 to report first CSI associated with the first cell group (e.g., the MCG) to the first network node 110-1 (e.g., the MN) and to report second CSI associated with the second cell group (e.g., the SCG) to the second network node 110-2 (e.g., the SN).

In some aspects, the configuration information may indicate a set of candidate allocations of UE resources. Each candidate allocation of the set of candidate allocations may correspond to a respective possible allocation of how UE resources (e.g., BB resources, RF resources, and/or antennas of the UE 120, among other examples) are to be used across the MCG and SCG. The set of candidate allocations may be based at least in part on the plurality of sharing capability profiles indicated in the UE capability information. For example, each candidate allocation, in the set of candidate allocations, may correspond to sharing capability profile supported by the UE 120. In some aspects, the configuration information may indicate a mapping between each candidate allocation, of the set of candidate allocations, and a respective set of parameters to be used for that candidate allocation. For example, the respective set of parameters that is mapped to a candidate allocation may include parameters such as SRS resources, CSI feedback, and/or DCI sizes and/or formats to monitor, among other examples. In some aspects, the configuration information may indicate an initial or default allocation of UE resources that is selected from the set of candidate allocations.

In some aspects, the configuration information may include configuration information associated with selecting an allocation of UE resources across the first cell group (e.g., the MCG) and the second cell group (e.g., the SCG). That is, the configuration information may configure the UE 120 to select the allocation of the UE resources (e.g., baseband resources, RF resources, and/or antennas, among other examples) across the MCG and the SCG. For example, the configuration information may configure one or more parameters and/or conditions to facilitate the selection of the allocation of the UE resources by the UE 120 and/or to constrain the solution (e.g., the selected allocation of the UE resources) within boundaries that are in control of the network. In some examples, the configuration information associated with selecting the split may define (or indicate) a metric and/or algorithm to be used by the UE 120 for selecting the allocation of the UE resources, one or more inputs to the algorithm (e.g., how to derive channel estimates to be used, which reference signals to use to derive the channel estimates, how to perform TD and/or FD filtering of the channel estimates, and/or which ranks, number of layers, and/or MCSs to consider, among other examples), and/or one or more relevant thresholds for triggering a change in the allocation of the UE resources, among other examples. In some aspects, the configuration information associated with selecting the allocation of the UE resources may be determined by the MN, the SN, or both the MN and the SN (e.g., involving negotiations and/or handshaking), and the configuration information associated with selecting the allocation of the UE resources may be transmitted to the UE 120 by the MN, the SN, or both the MN and the SN. For example, the configuration information associated with selecting the split may be signaled via L3 signaling (e.g., one or more RRC messages), L2 signaling (e.g., one or more MAC-CEs), and/or L1 signaling (e.g., DCI).

As further shown in FIG. 11, and by reference number 1120, the UE 120 may perform channel measurements for the MCG and the SCG. For example, the first network node 110-1 may transmit the one or more first CSI-RSs via the first cell group (e.g., the MCG), and the UE 120 may perform channel measurements on the one or more first CSI-RSs. The UE 120 may determine or derive first CSI based at least in part on the channel measurements performed on the one or more first CSI-RSs. The first CSI may include one or more channel estimates and/or measurements of channel conditions (e.g., downlink channel conditions) on the UE channel to the first cell group (e.g., the MCG). For example, the first CSI may include one or more channel estimates, indicated in the configuration information, that are to be used by the UE 120 for selecting the allocation of the UE resources across the first cell group and the second cell group. The UE 120 may perform channel measurements for each CC of the first cell group, and the first CSI may include CSI for each CC of the first cell group. The second network node may transmit the one or more second CSI-RSs via the second cell group (e.g., the SCG), and the UE 120 may perform channel measurements on the one or more second CSI-RSs. The UE 120 may determine or derive second CSI based at least in part on the channel measurements performed on the one or more second CSI-RSs. The second CSI may include one or more channel estimates and/or measurements of channel conditions (e.g., downlink channel conditions) on the UE channel to the second cell group (e.g., the SCG). For example, the second CSI may include one or more channel estimates, indicated in the configuration information, that are to be used by the UE 120 for selecting the allocation of the UE resources across the first cell group and the second cell group. The UE 120 may perform channel measurements for each CC of the second cell group, and the second CSI may include CSI for each CC of the second cell group.

In some aspects, the UE 120 may transmit, and the first network node 110-1 may receive, the first CSI. For example, the UE 120 may transmit, to the first network node 110-1, a first CSI report including the first CSI. In some aspects, the UE 120 may transmit, and the second network node 110-2 may receive, the second CSI. For example, the UE 120 may transmit, to the second network node 110-2, a second CSI report including the second CSI.

As further shown in FIG. 11, and by reference number 1125, the UE 120 may select an allocation of the UE resources across the MCG and the SCG. In some aspects, the UE 120 may select the allocation of the UE resources across the first cell group (e.g., the MCG) and the second cell group (e.g., the SCG) to be used for uplink and/or downlink communications. For example, the UE 120 may select the allocation of the UE resources to be applied for sharing the UE resources across the first cell group (e.g., the MCG) and the second cell group (e.g., the SCG). In some examples, the UE 120 may select the allocation of the UE resources to favor allocating UE resources for a cell group (e.g., MCG or SCG) having the better channel conditions. In some aspects, the UE 120 may determine the allocation of the UE resources based at least in part on channel estimates associated with the first cell group (e.g., the MCG) and channel estimates associated with the second cell group (e.g., the SCG). For example, the channel estimates associated with the first cell group may be included in the first CSI and the channel estimates associated with the second cell group may be included in the second CSI. In some examples, the channel estimates associated with the MCG and the SCG may be defined or indicated in the configuration information associated with selecting the allocation of the UE resources. In some aspects, the UE 120 may select/determine the allocation of the UE resources using a metric or an algorithm defined in the configuration information. In some aspects, the UE 120 may be triggered to select the allocation of the UE resources (e.g., a new allocation of the UE resources) in connection with a trigger condition for changing the allocation of the UE resources being satisfied. For example, the trigger condition for changing the allocation of the UE resources may be defined in the configuration information associated with selecting the allocation of the UE resources.

In some aspects, the selection of the allocation of the UE resources across the first cell group and the second cell group may be subject to one or more restrictions. In this case, the one or more restrictions may be a function of (e.g., based on) UE capabilities indicated in the UE capability information and/or network configurations indicated in the configuration information. For example, the UE 120 may restricted from allocating all of the transmit (Tx) and Rx antennas of the UE 120 for the SCG, and/or the UE 120 may be required to support at least a single-layer Tx/Rx when sharing the UE resources between the MCG and the SCG, among other examples.

In some aspects, the UE 120 may select the allocation of the UE resources across the first cell group and the second cell group from the set of candidate allocations indicated in the configuration information. In such examples, when the UE 120 begins applying the selected allocation, the UE 120 may also begin applying the set of parameters mapped to the selected allocation in the configuration information.

In some aspects, the UE 120 may select a time pattern for sharing the UE resources. For example, the allocation of the UE resources selected by the UE 120 may include a time pattern for switching between different allocations of the UE resources across the first cell group and the second cell group. In such examples, the selection of the time pattern by the UE 120 may be subject to one or more restrictions on the extent to which the borrow/share UE resources across the MCG and the SCG based at least in part on different factors, including TDD patterns of the CCs in the MSG and the SCG, a network configuration (e.g., indicated in the configuration information), and/or UE capabilities (e.g., indicated in the UE capability information), among other examples.

As further shown FIG. 11, and by reference number 1130, the UE 120 may transmit, and at least one of the first network node 110-1 or the second network node 110-2 may receive, an indication of the allocation of the UE resources selected by the UE 120. For example, the indication of the allocation of the UE resources may indicate an allocation of the UE resources (e.g., baseband resources, RF resources, and/or antennas, among other examples) across the first cell group (e.g., the MCG) and the second cell group (e.g., the SCG) to be applied for uplink and downlink communications. In some aspects, the UE 120 may transmit the indication of the allocation of the UE resources via L3 signaling (e.g., an RRC message), L2 signaling (e.g., a MAC-CE), or L1 signaling (e.g., UCI). In some aspects, the UE 120 may transmit the indication of the allocation of the UE resources to the MN, the SN, or both the MN and the SN.

As further shown in FIG. 11, and by reference number 1135, the first network node 110-1 may transmit, and the UE 120 may receive, an acknowledgement of the indication of the allocation of the UE resources. Additionally, or alternatively, as shown by reference number 1135a, the second network node 110-2 may transmit, and the UE 120 may receive, an acknowledgement of the indication of the allocation of the UE resources. In some aspects, the UE 120 may being applying the allocation of the UE resources selected by the UE 120 (e.g., for uplink and/or downlink communications) in connection with receiving the acknowledgement. In some aspects, in a case in which the selected allocation of the UE resources is a candidate allocation of the set of candidate allocations indicated in the configuration information, the UE 120 may also begin applying the set of parameters that is mapped to the selected candidate allocation in the configuration information.

In some aspects, the UE 120 may perform a soft level of handshaking with the first network node 110-1 and/or the second network node 110-2. For example, the UE 120 may transmit the indication of the allocation of the UE resources to a first one of the MN or the SN (e.g., in connection with a determination that the allocation of the UE resources is assigning more UE resources to the first one of the MN or the SN than to a second one of the MN or the SN). Once the indication of the allocation of the UE resources is approved by the first one of the MN or the SN (e.g., an acknowledgement of the indication is received from the first one of the MN or the SN by the UE 120), the UE 120 may then transmit the indication of the allocation of the UE resources determined by the UE 120 to the second one of the MN or the SN, or to both of the MN and the SN.

As further shown in FIG. 11, and by reference number 1140, the UE 120 may communicate with the first network node 110-1 and the second network node 110-2 via the first cell group and the second cell group, respectively, in accordance with the selected allocation of the UE resources (e.g., baseband resources, RF resources, and/or antennas, among other examples) across the first cell group and the second cell group. In some examples, the UE 120 may apply the selected allocation of the UE resources (e.g., the new allocation of the UE resources) across the first cell group and the second cell group for transmission of uplink communications to the first network node 110-1 (e.g., the MN) via the first cell group (e.g., the MCG) and to the second network node 110-2 (e.g., the SN) via the second cell group. In some examples, the first network node 110-1 may transmit downlink communications to the UE 120 via the first cell group and the second network node 110-2 may transmit downlink to the UE 120 via the second cell group. In such examples, the UE 120 may apply the selected allocation of the UE resources (e.g., the new allocation of the UE resources) across the first cell group and the second cell group for reception of the downlink communications transmitted from the first network node 110-1 (e.g., the MN) via the first cell group (e.g., the MCG) and from the second network node 110-2 (e.g., the SN) via the second cell group (e.g., the SCG).

As discussed above with reference to FIG. 11, the UE 120 may select the allocation of the UE resources across the MCG and the SCG to be applied for DC communications based at least in part on the channel conditions (e.g., the first CSI and the second CSI) for the UE 120 on the CCs of the MCG and the SCG. In some examples, the allocation of the UE resources may be selected to favor allocating UE resources for a cell group (e.g., MCG or SCG) having the better channel conditions. The UE 120 may transmit an indication of the selected allocation of the UE resources to the MN and/or the SN. As a result, downlink and uplink throughput may be enhanced/increased for the DC communications. Furthermore, because the determination of the allocation of the UE resources across the MCG and the SCG does not involve significant coordination between the MN and the SN, latency may be reduced and throughput may be further increased, as compared to the operations discussed above with reference to FIGS. 9 and 10.

Although the operations discussed above with reference to FIG. 11 are described in connection with DC, the operations discussed above with reference to FIG. 11 may be similarly applied to a DS scenario. In a DS scenario, the UE 120 may be connected to two networks independently. For example, the two networks may be associated with the same or different operators. The UE 120 may have two SIMs (e.g., two SIM cards), with each SIM used for connecting to a different network. In the DS scenario, the first network node 110-1 may be associated with a first network, and the second network node 110-2 may be associated with a second network. The UE 120 may connect to the first network via a first link with the first network node 110-1 and the second network via a second link the second network node 110-2. In such examples, the UE 120 may select an allocation of UE resources across the first network and the second network, and the UE 120 may transmit an indication of the selected allocation of UE resources across the first network and the second network to the first network node 110-1 and/or the second network node 110-2, as described above with reference to FIG. 11.

As indicated above, FIG. 11 is provided as an example. Other examples may differ from what is described with respect to FIG. 11.

In some examples in which a UE (e.g., UE 120) can share the UE resources across the MCG and the SCG, such as in examples 1100, 1000, and 900 discussed above, the sharing of the UE resources may result in situations in which the UE cannot perform proper measurements to be used to determine when to update the allocation of the UE resources. For example, in an extreme case in which the UE has moved all of the Rx antennas of the UE to the SCG, the UE would not be able to receive from the MN (e.g., via the MCG) at all. In a case in which the UE has moved most of the Rx antennas of the UE to the SCG, the UE may not be able to evaluate whether an X-layer (X>1) transmission can be supported on the MCG. In some aspects, in cases in which the remaining UE resources allocated for a cell group (e.g., the MCG or the SCG) are not sufficient for updating decisions, gaps that are similar to measurement gaps for radio resource management (RRM) may be configured for the UE to be used across the MCG and the SCG. In such examples, the gaps and the configurations on the MCG and the SCG during the gap times may be determined by the network and/or may be selected by the UE. In some other aspects, the permitted level of sharing of the UE resources may be restricted such that the remaining resources allocated for a cell group (e.g., the MCG or the SCG), in the worst case, is sufficient for re-evaluation of the selection of the allocation of the UE resources when needed. For example, the sharing of the UE resources may be subject to a restriction that all but 2 RX antennas of the UE can be shared across the MCG and the SCG. In this case, the network and the UE may understand that the measurements configuration and computation should be based on a 2 Rx assumption. In some examples, each level of resource sharing/borrowing may be a priori associated with a set of measurement configurations without the need for reconfiguration. In this case, once the UE is given a sharing state corresponding to an allocation of the UE resources, both the network and the UE will know how the measurements should be performed and reported.

In some aspects, in addition to the examples discussed above, the operations discussed with reference to FIGS. 6-11 may be similarly applied to other modes of operation in which a UE is connected to non-coordinated or loosely coordinated schedulers and/or network entities, such as multi-RAT (mRAT) DC, a dual-stack (e.g., when a UE is connected to a 6G RAN, a 5G RAN, and a 6G core network, with connectivity between the 5G RAN and the 6G core network), a sidelink+Uu connection, a sidelink+sidelink connection, and/or a WiFi+cellular connection, among other examples.

FIG. 12 is a diagram illustrating an example process 1200 performed, for example, at a UE or an apparatus of a UE, in accordance with the present disclosure. Example process 1200 is an example where the apparatus or the UE (e.g., UE 120) performs operations associated with UE information for enhancing multi-carrier communications.

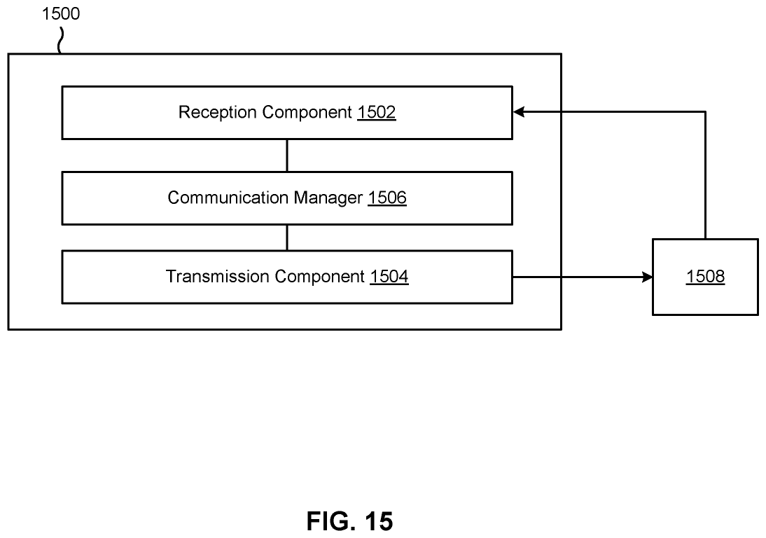

As shown in FIG. 12, in some aspects, process 1200 may include transmitting, to at least one of a first network node associated with a first cell group or a second network node associated with a second cell group, at least one of first information associated with splitting a data volume across the first cell group and the second cell group, or second information associated with sharing UE resources across the first cell group and the second cell group (block 1210). For example, the UE (e.g., using transmission component 1504 and/or communication manager 1506, depicted in FIG. 15) may transmit, to at least one of a first network node associated with a first cell group or a second network node associated with a second cell group, at least one of first information associated with splitting a data volume across the first cell group and the second cell group, or second information associated with sharing UE resources across the first cell group and the second cell group, as described above.

As further shown in FIG. 12, in some aspects, process 1200 may include communicating via the first cell group and the second cell group in accordance with at least one of a split of the data volume across the first cell group and the second cell group based at least in part on the first information, or an allocation of the UE resources across the first cell group and the second cell group based at least in part on the second information (block 1220). For example, the UE (e.g., using reception component 1502, transmission component 1504, and/or communication manager 1506, depicted in FIG. 15) may communicate via the first cell group and the second cell group in accordance with at least one of a split of the data volume across the first cell group and the second cell group based at least in part on the first information, or an allocation of the UE resources across the first cell group and the second cell group based at least in part on the second information, as described above.

Process 1200 may include additional aspects, such as any single aspect or any combination of aspects described below and/or in connection with one or more other processes described elsewhere herein.

In a first aspect, transmitting the at least one of the first information or the second information includes transmitting the first information, and communicating via the first cell group and the second cell group includes communicating via the first cell group and the second cell group in accordance with the split of the data volume across the first cell group and the second cell group based at least in part on the first information.

In a second aspect, alone or in combination with the first aspect, the first information includes UE assistance information that indicates a UE preference for splitting the data volume across the first cell group and the second cell group.

In a third aspect, alone or in combination with one or more of the first and second aspects, the UE assistance information indicates a preferred splitting threshold for splitting the data volume across the first cell group and the second cell group.

In a fourth aspect, alone or in combination with one or more of the first through third aspects, the UE assistance information indicates a request to increase or decrease a previously signaled splitting threshold for splitting the data volume across the first cell group and the second cell group.

In a fifth aspect, alone or in combination with one or more of the first through fourth aspects, the UE assistance information includes a preference to increase at least one of a maximum bandwidth associated with the first cell group or the second cell group, a maximum number of MIMO layers associated with the first cell group or the second cell group, or a maximum number of cells associated with the first cell group or the second cell group.

In a sixth aspect, alone or in combination with one or more of the first through fifth aspects, process 1200 includes receiving, from at least one of the first network node or the second network node and based at least in part on the UE assistance information, an indication of the split of the data volume across the first cell group and the second cell group.

In a seventh aspect, alone or in combination with one or more of the first through sixth aspects, the first information indicates the split of the data volume across the first cell group and the second cell group.

In an eighth aspect, alone or in combination with one or more of the first through seventh aspects, the first information includes an indication of a splitting threshold that indicates the split of the data volume across the first cell group and the second cell group for at least one of downlink communications or uplink communications.

In a ninth aspect, alone or in combination with one or more of the first through eighth aspects, transmitting the first information includes transmitting the first information via an RRC message, a MAC-CE, or UCI.

In a tenth aspect, alone or in combination with one or more of the first through ninth aspects, process 1200 includes receiving, from at least one of the first network node or the second network node, an acknowledgement of the first information.

In an eleventh aspect, alone or in combination with one or more of the first through tenth aspects, process 1200 includes selecting the split of the data volume across the first cell group and the second cell group.

In a twelfth aspect, alone or in combination with one or more of the first through eleventh aspects, selecting the split of the data volume across the first cell group and the second cell group includes selecting the split of the data volume across the first cell group and the second cell group based at least in part on channel state information associated with the first cell group and the second cell group.

In a thirteenth aspect, alone or in combination with one or more of the first through twelfth aspects, process 1200 includes receiving, from at least one of the first network node or the second network node, configuration information associated with selecting the split of the data volume across the first cell group and the second cell group.

In a fourteenth aspect, alone or in combination with one or more of the first through thirteenth aspects, selecting the split of the data volume across the first cell group and the second cell group includes selecting a splitting threshold for splitting the data volume across the first cell group and the second cell group, and process 1200 includes transmitting, to at least one of the first network node and the second network node, a buffer status report based at least in part on the splitting threshold.

In a fifteenth aspect, alone or in combination with one or more of the first through fourteenth aspects, transmitting the at least one of the first information or the second information includes transmitting the second information, and communicating via the first cell group and the second cell group includes communicating via the first cell group and the second cell group in accordance with the allocation of the UE resources across the first cell group and the second cell group based at least in part on the second information.

In a sixteenth aspect, alone or in combination with one or more of the first through fifteenth aspects, the second information includes UE capability information associated with a capability of the UE for sharing the UE resources across the first cell group and the second cell group, and process 1200 includes transmitting, to the first network node, first CSI associated with the first cell group, transmitting, to the second network node, second CSI associated with the second cell group, and receiving, from at least one of the first network node and the second network node, an indication of a change from a previous allocation of the UE resources across the first cell group and the second cell group to the allocation of the UE resources across the first cell group and the second cell group based at least in part on the UE capability information, the first CSI, and the second CSI.

In a seventeenth aspect, alone or in combination with one or more of the first through sixteenth aspects, the indication is included in an RRC message, a MAC-CE, or DCI.

In an eighteenth aspect, alone or in combination with one or more of the first through seventeenth aspects, process 1200 includes receiving configuration information indicating a mapping between each candidate allocation, of a set of candidate allocations of the UE resources, and a respective set of parameters to be used for that candidate allocation, wherein the set of candidate allocations of the UE resources is based at least in part on the UE capability information, and wherein the indication indicates a change from a first candidate allocation of the set of candidate allocations of the UE resources to a second candidate allocation of the set of candidate allocations of the UE resources.

In a nineteenth aspect, alone or in combination with one or more of the first through eighteenth aspects, the second information includes UE assistance information that indicates a request for increasing UE resources allocated for a first one of the first cell group or the second cell group.

In a twentieth aspect, alone or in combination with one or more of the first through nineteenth aspects, the UE assistance information further indicates a request for decreasing UE resources allocated for a second one or the first cell group or the second cell group.

In a twenty-first aspect, alone or in combination with one or more of the first through twentieth aspects, process 1200 includes receiving, from at least one of the first network node or the second network node and based at least in part on the UE assistance information, an indication of the allocation of the UE resources across the first cell group and the second cell group.

In a twenty-second aspect, alone or in combination with one or more of the first through twenty-first aspects, the second information includes a dynamic capability update that indicates an updated allocation of the UE resources supported by the UE, and process 1200 includes receiving, from at least one of the first network node or the second network node and based at least in part on the dynamic capability update, an indication of a change from a previous allocation of the UE resources across the first cell group and the second cell group to the allocation of the UE resources across the first cell group and the second cell group.

In a twenty-third aspect, alone or in combination with one or more of the first through twenty-second aspects, the second information indicates the allocation of the UE resources across the first cell group and the second cell group.

In a twenty-fourth aspect, alone or in combination with one or more of the first through twenty-third aspects, process 1200 includes receiving, from at least one of the first network node or the second network node, an acknowledgement of the second information.

In a twenty-fifth aspect, alone or in combination with one or more of the first through twenty-fourth aspects, process 1200 includes selecting the allocation of the UE resources across the first cell group and the second cell group based at least in part on channel state information associated with the first cell group and the second cell group.

In a twenty-sixth aspect, alone or in combination with one or more of the first through twenty-fifth aspects, process 1200 includes receiving, from at least one of the first network node or the second network node, configuration information associated with selecting the allocation of the UE resources across the first cell group and the second cell group.

In a twenty-seventh aspect, alone or in combination with one or more of the first through twenty-sixth aspects, the allocation of the UE resources across the first cell group and the second cell group includes a time pattern for switching between different allocations of the UE resources across the first cell group and the second cell group.

In a twenty-eighth aspect, alone or in combination with one or more of the first through twenty-seventh aspects, the UE resources include at least one of radio frequency resources, baseband resources, or UE antennas.

Although FIG. 12 shows example blocks of process 1200, in some aspects, process 1200 may include additional blocks, fewer blocks, different blocks, or differently arranged blocks than those depicted in FIG. 12. Additionally, or alternatively, two or more of the blocks of process 1200 may be performed in parallel.

FIG. 13 is a diagram illustrating an example process 1300 performed, for example, at a first network node or an apparatus of a first network node, in accordance with the present disclosure. Example process 1300 is an example where the apparatus or the first network node (e.g., network node 110) performs operations associated with UE information for enhancing multi-carrier communications.

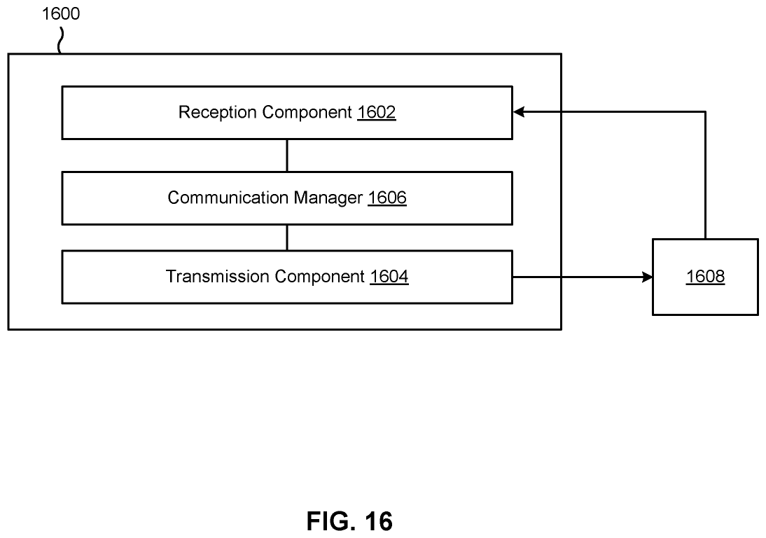

As shown in FIG. 13, in some aspects, process 1300 may include receiving, from a UE, at least one of first information associated with splitting a data volume across a first cell group associated with the first network node and a second cell group associated with a second network node, or second information associated with sharing UE resources across the first cell group and the second cell group (block 1310). For example, the first network node (e.g., using reception component 1602 and/or communication manager 1606, depicted in FIG. 16) may receive, from a UE, at least one of first information associated with splitting a data volume across a first cell group associated with the first network node and a second cell group associated with a second network node, or second information associated with sharing UE resources across the first cell group and the second cell group, as described above.

As further shown in FIG. 13, in some aspects, process 1300 may include communicating with the UE in accordance with at least one of a split of the data volume across the first cell group and the second cell group based at least in part on the first information, or an allocation of the UE resources across the first cell group and the second cell group based at least in part on the second information (block 1320). For example, the first network node (e.g., using reception component 1602, transmission component 1604, and/or communication manager 1606, depicted in FIG. 16) may communicate with the UE in accordance with at least one of a split of the data volume across the first cell group and the second cell group based at least in part on the first information, or an allocation of the UE resources across the first cell group and the second cell group based at least in part on the second information, as described above.

Process 1300 may include additional aspects, such as any single aspect or any combination of aspects described below and/or in connection with one or more other processes described elsewhere herein.

In a first aspect, receiving the at least one of the first information or the second information includes receiving the first information, and communicating with the UE includes communicating with the UE in accordance with the split of the data volume across the first cell group and the second cell group based at least in part on the first information.

In a second aspect, alone or in combination with the first aspect, the first information includes UE assistance information that indicates a UE preference for splitting the data volume across the first cell group and the second cell group.

In a third aspect, alone or in combination with one or more of the first and second aspects, the UE assistance information indicates a preferred splitting threshold for splitting the data volume across the first cell group and the second cell group.

In a fourth aspect, alone or in combination with one or more of the first through third aspects, the UE assistance information indicates a request to increase or decrease a previously signaled splitting threshold for splitting the data volume across the first cell group and the second cell group.

In a fifth aspect, alone or in combination with one or more of the first through fourth aspects, the UE assistance information includes a preference to increase at least one of a maximum bandwidth associated with the first cell group or the second cell group, a maximum number of MIMO layers associated with the first cell group or the second cell group, or a maximum number of cells associated with the first cell group or the second cell group.

In a sixth aspect, alone or in combination with one or more of the first through fifth aspects, process 1300 includes transmitting, to the UE and based at least in part on the UE assistance information, an indication of the split of the data volume across the first cell group and the second cell group.

In a seventh aspect, alone or in combination with one or more of the first through sixth aspects, the first information indicates the split of the data volume across the first cell group and the second cell group.

In an eighth aspect, alone or in combination with one or more of the first through seventh aspects, the first information includes an indication of a splitting threshold that indicates the split of the data volume across the first cell group and the second cell group for at least one of downlink communications or uplink communications.

In a ninth aspect, alone or in combination with one or more of the first through eighth aspects, receiving the first information includes receiving the first information via an RRC message, a MAC-CE, or UCI.

In a tenth aspect, alone or in combination with one or more of the first through ninth aspects, process 1300 includes transmitting, to the UE, an acknowledgement of the first information.

In an eleventh aspect, alone or in combination with one or more of the first through tenth aspects, process 1300 includes transmitting, to the UE, configuration information associated with selection, by the UE, of the split of the data volume across the first cell group and the second cell group.

In a twelfth aspect, alone or in combination with one or more of the first through eleventh aspects, receiving the at least one of the first information or the second information includes receiving the second information, and communicating with the UE includes communicating with the UE in accordance with the allocation of the UE resources across the first cell group and the second cell group based at least in part on the second information.

In a thirteenth aspect, alone or in combination with one or more of the first through twelfth aspects, the second information includes UE capability information associated with a capability of the UE for sharing the UE resources across the first cell group and the second cell group, and process 1300 includes receiving, from the UE, first CSI associated with the first cell group, obtaining, from the second network node, second CSI associated with the second cell group, and transmitting, to the UE, an indication of a change from a previous allocation of the UE resources across the first cell group and the second cell group to the allocation of the UE resources across the first cell group and the second cell group based at least in part on the UE capability information, the first CSI, and the second CSI.

In a fourteenth aspect, alone or in combination with one or more of the first through thirteenth aspects, the indication is included in an RRC message, a MAC-CE, or DCI.

In a fifteenth aspect, alone or in combination with one or more of the first through fourteenth aspects, process 1300 includes transmitting, to the UE, configuration information indicating a mapping between each candidate allocation, of a set of candidate allocations of the UE resources, and a respective set of parameters to be used for that candidate allocation, wherein the set of candidate allocations of the UE resources is based at least in part on the UE capability information, and wherein the indication indicates a change from a first candidate allocation of the set of candidate allocations of the UE resources to a second candidate allocation of the set of candidate allocations of the UE resources.

In a sixteenth aspect, alone or in combination with one or more of the first through fifteenth aspects, the second information includes UE assistance information that indicates a request for increasing UE resources allocated for a first one of the first cell group or the second cell group.

In a seventeenth aspect, alone or in combination with one or more of the first through sixteenth aspects, the UE assistance information further indicates a request for decreasing UE resources allocated for a second one or the first cell group or the second cell group.

In an eighteenth aspect, alone or in combination with one or more of the first through seventeenth aspects, process 1300 includes transmitting, to the UE and based at least in part on the UE assistance information, an indication of the allocation of the UE resources across the first cell group and the second cell group.

In a nineteenth aspect, alone or in combination with one or more of the first through eighteenth aspects, the second information includes a dynamic capability update that indicates an updated allocation of the UE resources supported by the UE, and process 1300 includes transmitting, to the UE and based at least in part on the dynamic capability update, an indication of a change from a previous allocation of the UE resources across the first cell group and the second cell group to the allocation of the UE resources across the first cell group and the second cell group.

In a twentieth aspect, alone or in combination with one or more of the first through nineteenth aspects, the second information indicates the allocation of the UE resources across the first cell group and the second cell group.

In a twenty-first aspect, alone or in combination with one or more of the first through twentieth aspects, process 1300 includes transmitting, to the UE, an acknowledgement of the second information.

In a twenty-second aspect, alone or in combination with one or more of the first through twenty-first aspects, process 1300 includes transmitting, to the UE, configuration information associated with selection, by the UE, of the allocation of the UE resources across the first cell group and the second cell group.

In a twenty-third aspect, alone or in combination with one or more of the first through twenty-second aspects, the allocation of the UE resources across the first cell group and the second cell group includes a time pattern for switching between different allocations of the UE resources across the first cell group and the second cell group.

In a twenty-fourth aspect, alone or in combination with one or more of the first through twenty-third aspects, the UE resources include at least one of radio frequency resources, baseband resources, or UE antennas.

Although FIG. 13 shows example blocks of process 1300, in some aspects, process 1300 may include additional blocks, fewer blocks, different blocks, or differently arranged blocks than those depicted in FIG. 13. Additionally, or alternatively, two or more of the blocks of process 1300 may be performed in parallel.

FIG. 14 is a diagram illustrating an example process 1400 performed, for example, at a first network node or an apparatus of a first network node, in accordance with the present disclosure. Example process 1400 is an example where the apparatus or the first network node (e.g., network node 110) performs operations associated with enhancing multi-carrier communications.

As shown in FIG. 14, in some aspects, process 1400 may include receiving, from a UE, first CSI associated with the UE and a first cell group (block 1410). For example, the first network node (e.g., using reception component 1602 and/or communication manager 1606, depicted in FIG. 16) may receive, from a UE, first CSI associated with the UE and a first cell group, as described above.

As further shown in FIG. 14, in some aspects, process 1400 may include obtaining, from a second network node, second CSI associated with the UE and a second cell group (block 1420). For example, the first network node (e.g., using reception component 1602 and/or communication manager 1606, depicted in FIG. 16) may obtain, from a second network node, second CSI associated with the UE and a second cell group, as described above.

As further shown in FIG. 14, in some aspects, process 1400 may include transmitting, to the UE, an indication of a split of a data volume across to the first cell group and the second cell group to be used for communications with the UE, wherein the split of the data volume across the first cell group and the second cell group is based at least in part on the first CSI and the second CSI (block 1430). For example, the first network node (e.g., using transmission component 1604 and/or communication manager 1606, depicted in FIG. 16) may transmit, to the UE, an indication of a split of a data volume across to the first cell group and the second cell group to be used for communications with the UE, wherein the split of the data volume across the first cell group and the second cell group is based at least in part on the first CSI and the second CSI, as described above.

Process 1400 may include additional aspects, such as any single aspect or any combination of aspects described below and/or in connection with one or more other processes described elsewhere herein.

In a first aspect, process 1400 includes determining the split of the data volume across the first cell group and the second cell group is based at least in part on the first CSI and the second CSI.

Although FIG. 14 shows example blocks of process 1400, in some aspects, process 1400 may include additional blocks, fewer blocks, different blocks, or differently arranged blocks than those depicted in FIG. 14. Additionally, or alternatively, two or more of the blocks of process 1400 may be performed in parallel.

FIG. 15 is a diagram of an example apparatus 1500 for wireless communication, in accordance with the present disclosure. The apparatus 1500 may be a UE, or a UE may include the apparatus 1500. In some aspects, the apparatus 1500 includes a reception component 1502, a transmission component 1504, and/or a communication manager 1506, which may be in communication with one another (for example, via one or more buses and/or one or more other components). In some aspects, the communication manager 1506 is the communication manager 140 described with reference to FIG. 1. As shown, the apparatus 1500 may communicate with another apparatus 1508, such as a UE or a network node (such as a CU, a DU, an RU, or a base station), using the reception component 1502 and the transmission component 1504.

In some aspects, the apparatus 1500 may be configured to perform one or more operations described herein with reference to FIGS. 6-11. Additionally, or alternatively, the apparatus 1500 may be configured to perform one or more processes described herein, such as process 1200 of FIG. 12, or a combination thereof. In some aspects, the apparatus 1500 and/or one or more components shown in FIG. 15 may include one or more components of the UE described with reference to FIG. 2. Additionally, or alternatively, one or more components shown in FIG. 15 may be implemented within one or more components described with reference to FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1502 may receive communications, such as reference signals, control information, data communications, or a combination thereof, from the apparatus 1508. The reception component 1502 may provide received communications to one or more other components of the apparatus 1500. In some aspects, the reception component 1502 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1500. In some aspects, the reception component 1502 may include one or more antennas, one or more modems, one or more demodulators, one or more MIMO detectors, one or more receive processors, one or more controllers/processors, one or more memories, or a combination thereof, of the UE described with reference to FIG. 2.

The transmission component 1504 may transmit communications, such as reference signals, control information, data communications, or a combination thereof, to the apparatus 1508. In some aspects, one or more other components of the apparatus 1500 may generate communications and may provide the generated communications to the transmission component 1504 for transmission to the apparatus 1508. In some aspects, the transmission component 1504 may perform signal processing on the generated communications (such as filtering, amplification, modulation, digital-to-analog conversion, multiplexing, interleaving, mapping, or encoding, among other examples), and may transmit the processed signals to the apparatus 1508. In some aspects, the transmission component 1504 may include one or more antennas, one or more modems, one or more modulators, one or more transmit MIMO processors, one or more transmit processors, one or more controllers/processors, one or more memories, or a combination thereof, of the UE described with reference to FIG. 2. In some aspects, the transmission component 1504 may be co-located with the reception component 1502 in one or more transceivers.

The communication manager 1506 may support operations of the reception component 1502 and/or the transmission component 1504. For example, the communication manager 1506 may receive information associated with configuring reception of communications by the reception component 1502 and/or transmission of communications by the transmission component 1504. Additionally, or alternatively, the communication manager 1506 may generate and/or provide control information to the reception component 1502 and/or the transmission component 1504 to control reception and/or transmission of communications.

The transmission component 1504 may transmit, to at least one of a first network node associated with a first cell group or a second network node associated with a second cell group, at least one of first information associated with splitting a data volume across the first cell group and the second cell group, or second information associated with sharing UE resources across the first cell group and the second cell group. The reception component 1502 and/or the transmission component 1504 may communicate via the first cell group and the second cell group in accordance with at least one of a split of the data volume across the first cell group and the second cell group based at least in part on the first information, or an allocation of the UE resources across the first cell group and the second cell group based at least in part on the second information.

The reception component 1502 may receive, from at least one of the first network node or the second network node and based at least in part on UE assistance information, an indication of the split of the data volume across the first cell group and the second cell group.

The reception component 1502 may receive, from at least one of the first network node or the second network node, an acknowledgement of the first information.

The communication manager 1506 may select the split of the data volume across the first cell group and the second cell group. For example, the communication manager 1506 may select the split of the data volume across the first cell group and the second cell group based at least in part on channel state information associated with the first cell group and the second cell group.

The reception component 1502 may receive, from at least one of the first network node or the second network node, configuration information associated with selecting the split of the data volume across the first cell group and the second cell group.

The transmission component 1504 may transmit, to at least one of the first network node or the second network node, a buffer status report based at least in part on the splitting threshold.

The transmission component 1504 may transmit, to the first network node, first CSI associated with the first cell group. The transmission component 1504 may transmit, to the second network node, second CSI associated with the second cell group. The reception component 1502 may receive, from at least one of the first network node and the second network node, an indication of a change from a previous allocation of the UE resources across the first cell group and the second cell group to the allocation of the UE resources across the first cell group and the second cell group based at least in part on the UE capability information, the first CSI, and the second CSI.

The reception component 1502 may receive configuration information indicating a mapping between each candidate allocation, of a set of candidate allocations of the UE resources, and a respective set of parameters to be used for that candidate allocation, wherein the set of candidate allocations of the UE resources is based at least in part on UE capability information, and wherein the indication indicates a change from a first candidate allocation of the set of candidate allocations of the UE resources to a second candidate allocation of the set of candidate allocations of the UE resources.

The reception component 1502 may receive, from at least one of the first network node or the second network node and based at least in part on UE assistance information, an indication of the allocation of the UE resources across the first cell group and the second cell group.

The reception component 1502 may receive, from at least one of the first network node or the second network node and based at least in part on a dynamic capability update, an indication of a change from a previous allocation of the UE resources across the first cell group and the second cell group to the allocation of the UE resources across the first cell group and the second cell group.

The reception component 1502 may receive, from at least one of the first network node or the second network node, an acknowledgement of the second information.

The communication manager 1506 may select the allocation of the UE resources across the first cell group and the second cell group based at least in part on channel state information associated with the first cell group and the second cell group.

The reception component 1502 may receive, from at least one of the first network node or the second network node, configuration information associated with selecting the allocation of the UE resources across the first cell group and the second cell group.

The number and arrangement of components shown in FIG. 15 are provided as an example. In practice, there may be additional components, fewer components, different components, or differently arranged components than those shown in FIG. 15. Furthermore, two or more components shown in FIG. 15 may be implemented within a single component, or a single component shown in FIG. 15 may be implemented as multiple, distributed components. Additionally, or alternatively, a set of (one or more) components shown in FIG. 15 may perform one or more functions described as being performed by another set of components shown in FIG. 15.

FIG. 16 is a diagram of an example apparatus 1600 for wireless communication, in accordance with the present disclosure. The apparatus 1600 may be a network node, or a network node may include the apparatus 1600. In some aspects, the apparatus 1600 includes a reception component 1602, a transmission component 1604, and/or a communication manager 1606, which may be in communication with one another (for example, via one or more buses and/or one or more other components). In some aspects, the communication manager 1606 is the communication manager 150 described with reference to FIG. 1. As shown, the apparatus 1600 may communicate with another apparatus 1608, such as a UE or a network node (such as a CU, a DU, an RU, or a base station), using the reception component 1602 and the transmission component 1604.

In some aspects, the apparatus 1600 may be configured to perform one or more operations described herein with reference to FIGS. 6-11. Additionally, or alternatively, the apparatus 1600 may be configured to perform one or more processes described herein, such as process 1300 of FIG. 13, process 1400 of FIG. 14, or a combination thereof. In some aspects, the apparatus 1600 and/or one or more components shown in FIG. 16 may include one or more components of the network node described with reference to FIG. 2. Additionally, or alternatively, one or more components shown in FIG. 16 may be implemented within one or more components described with reference to FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1602 may receive communications, such as reference signals, control information, data communications, or a combination thereof, from the apparatus 1608. The reception component 1602 may provide received communications to one or more other components of the apparatus 1600. In some aspects, the reception component 1602 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1600. In some aspects, the reception component 1602 may include one or more antennas, one or more modems, one or more demodulators, one or more MIMO detectors, one or more receive processors, one or more controllers/processors, one or more memories, or a combination thereof, of the network node described with reference to FIG. 2. In some aspects, the reception component 1602 and/or the transmission component 1604 may include or may be included in a network interface. The network interface may be configured to obtain and/or output signals for the apparatus 1600 via one or more communications links, such as a backhaul link, a midhaul link, and/or a fronthaul link.

The transmission component 1604 may transmit communications, such as reference signals, control information, data communications, or a combination thereof, to the apparatus 1608. In some aspects, one or more other components of the apparatus 1600 may generate communications and may provide the generated communications to the transmission component 1604 for transmission to the apparatus 1608. In some aspects, the transmission component 1604 may perform signal processing on the generated communications (such as filtering, amplification, modulation, digital-to-analog conversion, multiplexing, interleaving, mapping, or encoding, among other examples), and may transmit the processed signals to the apparatus 1608. In some aspects, the transmission component 1604 may include one or more antennas, one or more modems, one or more modulators, one or more transmit MIMO processors, one or more transmit processors, one or more controllers/processors, one or more memories, or a combination thereof, of the network node described with reference to FIG. 2. In some aspects, the transmission component 1604 may be co-located with the reception component 1602 in one or more transceivers.

The communication manager 1606 may support operations of the reception component 1602 and/or the transmission component 1604. For example, the communication manager 1606 may receive information associated with configuring reception of communications by the reception component 1602 and/or transmission of communications by the transmission component 1604. Additionally, or alternatively, the communication manager 1606 may generate and/or provide control information to the reception component 1602 and/or the transmission component 1604 to control reception and/or transmission of communications.

The reception component 1602 may receive, from a UE, at least one of first information associated with splitting a data volume across a first cell group associated with the network node and a second cell group associated with a second network node, or second information associated with sharing UE resources across the first cell group and the second cell group. The reception component 1602 and/or the transmission component 1604 may communicate with the UE in accordance with at least one of a split of the data volume across the first cell group and the second cell group based at least in part on the first information, or an allocation of the UE resources across the first cell group and the second cell group based at least in part on the second information.

The transmission component 1604 may transmit, to the UE and based at least in part on the UE assistance information, an indication of the split of the data volume across the first cell group and the second cell group.

The transmission component 1604 may transmit, to the UE, an acknowledgement of the first information.

The transmission component 1604 may transmit, to the UE, configuration information associated with selection, by the UE, of the split of the data volume across the first cell group and the second cell group.

The reception component 1602 may receive, from the UE, first CSI associated with the first cell group. The reception component 1602 may obtain, from the second network node, second CSI associated with the second cell group. The transmission component 1604 may transmit, to the UE, an indication of a change from a previous allocation of the UE resources across the first cell group and the second cell group to the allocation of the UE resources across the first cell group and the second cell group based at least in part on the UE capability information, the first CSI, and the second CSI

The transmission component 1604 may transmit, to the UE, configuration information indicating a mapping between each candidate allocation, of a set of candidate allocations of the UE resources, and a respective set of parameters to be used for that candidate allocation, wherein the set of candidate allocations of the UE resources is based at least in part on the UE capability information, and wherein the indication indicates a change from a first candidate allocation of the set of candidate allocations of the UE resources to a second candidate allocation of the set of candidate allocations of the UE resources.

The transmission component 1604 may transmit, to the UE and based at least in part on the UE assistance information, an indication of the allocation of the UE resources across the first cell group and the second cell group.

The transmission component 1604 may transmit, to the UE and based at least in part on the dynamic capability update, an indication of a change from a previous allocation of the UE resources across the first cell group and the second cell group to the allocation of the UE resources across the first cell group and the second cell group.

The transmission component 1604 may transmit, to the UE, an acknowledgement of the second information.

The transmission component 1604 may transmit, to the UE, configuration information associated with selection, by the UE, of the allocation of the UE resources across the first cell group and the second cell group.

The reception component 1602 may receive, from a UE, first CSI associated with the UE and a first cell group. The reception component 1602 may obtain, from a second network node, second CSI associated with the UE and a second cell group. The transmission component 1604 may transmit, to the UE, an indication of a split of a data volume across to the first cell group and the second cell group to be used for communications with the UE, wherein the split of the data volume across the first cell group and the second cell group is based at least in part on the first CSI and the second CSI.

The communication manager 1606 may determine the split of the data volume across the first cell group and the second cell group is based at least in part on the first CSI and the second CSI.

The number and arrangement of components shown in FIG. 16 are provided as an example. In practice, there may be additional components, fewer components, different components, or differently arranged components than those shown in FIG. 16. Furthermore, two or more components shown in FIG. 16 may be implemented within a single component, or a single component shown in FIG. 16 may be implemented as multiple, distributed components. Additionally, or alternatively, a set of (one or more) components shown in FIG. 16 may perform one or more functions described as being performed by another set of components shown in FIG. 16.

The following provides an overview of some Aspects of the present disclosure:

Aspect 1: A method of wireless communication performed by a user equipment (UE), comprising: transmitting, to at least one of a first network node associated with a first cell group or a second network node associated with a second cell group, at least one of: first information associated with splitting a data volume across the first cell group and the second cell group, or second information associated with sharing UE resources across the first cell group and the second cell group; and communicating via the first cell group and the second cell group in accordance with at least one of: a split of the data volume across the first cell group and the second cell group based at least in part on the first information, or an allocation of the UE resources across the first cell group and the second cell group based at least in part on the second information.

Aspect 2: The method of Aspect 1, wherein transmitting the at least one of the first information or the second information comprises transmitting the first information, and wherein communicating via the first cell group and the second cell group comprises communicating via the first cell group and the second cell group in accordance with the split of the data volume across the first cell group and the second cell group based at least in part on the first information.

Aspect 3: The method of Aspect 2, wherein the first information includes UE assistance information that indicates a UE preference for splitting the data volume across the first cell group and the second cell group.

Aspect 4: The method of Aspect 3, wherein the UE assistance information indicates a preferred splitting threshold for splitting the data volume across the first cell group and the second cell group.

Aspect 5: The method of Aspect 3, wherein the UE assistance information indicates a request to increase or decrease a previously signaled splitting threshold for splitting the data volume across the first cell group and the second cell group.

Aspect 6: The method of any of Aspects 3-5, wherein the UE assistance information includes a preference to increase at least one of: a maximum bandwidth associated with the first cell group or the second cell group, a maximum number of multiple input multiple output (MIMO) layers associated with the first cell group or the second cell group, or a maximum number of cells associated with the first cell group or the second cell group.

Aspect 7: The method of any of Aspects 3-6, further comprising: receiving, from at least one of the first network node or the second network node and based at least in part on the UE assistance information, an indication of the split of the data volume across the first cell group and the second cell group.

Aspect 8: The method of Aspect 2, wherein the first information indicates the split of the data volume across the first cell group and the second cell group.

Aspect 9: The method of Aspect 8, wherein the first information includes an indication of a splitting threshold that indicates the split of the data volume across the first cell group and the second cell group for at least one of downlink communications or uplink communications.

Aspect 10: The method of any of Aspects 8-9, wherein transmitting the first information comprises: transmitting the first information via a radio resource control (RRC) message, a medium access control (MAC) control element (MAC-CE), or uplink control information (UCI).

Aspect 11: The method of any of Aspects 8-10, further comprising: receiving, from at least one of the first network node or the second network node, an acknowledgement of the first information.

Aspect 12: The method of any of Aspects 8-11, further comprising: selecting the split of the data volume across the first cell group and the second cell group.

Aspect 13: The method of Aspect 12, wherein selecting the split of the data volume across the first cell group and the second cell group comprises selecting the split of the data volume across the first cell group and the second cell group based at least in part on channel state information associated with the first cell group and the second cell group.

Aspect 14: The method of any of Aspects 12-13, further comprising: receiving, from at least one of the first network node or the second network node, configuration information associated with selecting the split of the data volume across the first cell group and the second cell group.

Aspect 15: The method of any of Aspects 12-14, wherein selecting the split of the data volume across the first cell group and the second cell group comprises selecting a splitting threshold for splitting the data volume across the first cell group and the second cell group, and further comprising: transmitting, to at least one of the first network node and the second network node, a buffer status report based at least in part on the splitting threshold.

Aspect 16: The method of any of Aspects 1-15, wherein transmitting the at least one of the first information or the second information comprises transmitting the second information, and wherein communicating via the first cell group and the second cell group comprises communicating via the first cell group and the second cell group in accordance with the allocation of the UE resources across the first cell group and the second cell group based at least in part on the second information.

Aspect 17: The method of Aspect 16, wherein the second information includes UE capability information associated with a capability of the UE for sharing the UE resources across the first cell group and the second cell group, and further comprising: transmitting, to the first network node, first channel state information (CSI) associated with the first cell group; transmitting, to the second network node, second CSI associated with the second cell group; and receiving, from at least one of the first network node and the second network node, an indication of a change from a previous allocation of the UE resources across the first cell group and the second cell group to the allocation of the UE resources across the first cell group and the second cell group based at least in part on the UE capability information, the first CSI, and the second CSI.

Aspect 18: The method of Aspect 17, wherein the indication is included in a radio resource control (RRC) message, a medium access control (MAC) control element (MAC-CE), or downlink control information (DCI).

Aspect 19: The method of any of Aspects 17-18, further comprising: receiving configuration information indicating a mapping between each candidate allocation, of a set of candidate allocations of the UE resources, and a respective set of parameters to be used for that candidate allocation, wherein the set of candidate allocations of the UE resources is based at least in part on the UE capability information, and wherein the indication indicates a change from a first candidate allocation of the set of candidate allocations of the UE resources to a second candidate allocation of the set of candidate allocations of the UE resources.

Aspect 20: The method of Aspect 16, wherein the second information includes UE assistance information that indicates a request for increasing UE resources allocated for a first one of the first cell group or the second cell group.

Aspect 21: The method of Aspect 20, wherein the UE assistance information further indicates a request for decreasing UE resources allocated for a second one or the first cell group or the second cell group.

Aspect 22: The method of any of Aspects 20-21, further comprising: receiving, from at least one of the first network node or the second network node and based at least in part on the UE assistance information, an indication of the allocation of the UE resources across the first cell group and the second cell group.

Aspect 23: The method of Aspect 16, wherein the second information includes a dynamic capability update that indicates an updated allocation of the UE resources supported by the UE, and further comprising: receiving, from at least one of the first network node or the second network node and based at least in part on the dynamic capability update, an indication of a change from a previous allocation of the UE resources across the first cell group and the second cell group to the allocation of the UE resources across the first cell group and the second cell group.

Aspect 24: The method of Aspect 16, wherein the second information indicates the allocation of the UE resources across the first cell group and the second cell group.

Aspect 25: The method of Aspect 24, further comprising: receiving, from at least one of the first network node or the second network node, an acknowledgement of the second information.

Aspect 26: The method of any of Aspects 24-25, further comprising: selecting the allocation of the UE resources across the first cell group and the second cell group based at least in part on channel state information associated with the first cell group and the second cell group.

Aspect 27: The method of Aspect 26, further comprising: receiving, from at least one of the first network node or the second network node, configuration information associated with selecting the allocation of the UE resources across the first cell group and the second cell group.

Aspect 28: The method of any of Aspects 24-27, wherein the allocation of the UE resources across the first cell group and the second cell group includes a time pattern for switching between different allocations of the UE resources across the first cell group and the second cell group.

Aspect 29: The method of any of Aspects 16-28, wherein the UE resources include at least one of radio frequency resources, baseband resources, or UE antennas.

Aspect 30: A method of wireless communication performed by a first network node, comprising: receiving, from a user equipment (UE), at least one of: first information associated with splitting a data volume across a first cell group associated with the first network node and a second cell group associated with a second network node, or second information associated with sharing UE resources across the first cell group and the second cell group; and communicating with the UE in accordance with at least one of: a split of the data volume across the first cell group and the second cell group based at least in part on the first information, or an allocation of the UE resources across the first cell group and the second cell group based at least in part on the second information.

Aspect 31: The method of Aspect 30, wherein receiving the at least one of the first information or the second information comprises receiving the first information, and wherein communicating with the UE comprises communicating with the UE in accordance with the split of the data volume across the first cell group and the second cell group based at least in part on the first information.

Aspect 32: The method of Aspect 31, wherein the first information includes UE assistance information that indicates a UE preference for splitting the data volume across the first cell group and the second cell group.

Aspect 33: The method of Aspect 32, wherein the UE assistance information indicates a preferred splitting threshold for splitting the data volume across the first cell group and the second cell group.

Aspect 34: The method of Aspect 32, wherein the UE assistance information indicates a request to increase or decrease a previously signaled splitting threshold for splitting the data volume across the first cell group and the second cell group.

Aspect 35: The method of any of Aspects 32-34, wherein the UE assistance information includes a preference to increase at least one of: a maximum bandwidth associated with the first cell group or the second cell group, a maximum number of multiple input multiple output (MIMO) layers associated with the first cell group or the second cell group, or a maximum number of cells associated with the first cell group or the second cell group.

Aspect 36: The method of any of Aspects 32-35, further comprising: transmitting, to the UE and based at least in part on the UE assistance information, an indication of the split of the data volume across the first cell group and the second cell group.

Aspect 37: The method of Aspect 31, wherein the first information indicates the split of the data volume across the first cell group and the second cell group.

Aspect 38: The method of Aspect 37, wherein the first information includes an indication of a splitting threshold that indicates the split of the data volume across the first cell group and the second cell group for at least one of downlink communications or uplink communications.

Aspect 39: The method of any of Aspects 37-38, wherein receiving the first information comprises: receiving the first information via a radio resource control (RRC) message, a medium access control (MAC) control element (MAC-CE), or uplink control information (UCI).

Aspect 40: The method of any of Aspects 37-39, further comprising: transmitting, to the UE, an acknowledgement of the first information.

Aspect 41: The method of any of Aspects 37-40, further comprising: transmitting, to the UE, configuration information associated with selection, by the UE, of the split of the data volume across the first cell group and the second cell group.

Aspect 42: The method of any of Aspects 30-41, wherein receiving the at least one of the first information or the second information comprises receiving the second information, and wherein communicating with the UE comprises communicating with the UE in accordance with the allocation of the UE resources across the first cell group and the second cell group based at least in part on the second information.

Aspect 43: The method of Aspect 42, wherein the second information includes UE capability information associated with a capability of the UE for sharing the UE resources across the first cell group and the second cell group, and further comprising: receiving, from the UE, first channel state information (CSI) associated with the first cell group; obtaining, from the second network node, second CSI associated with the second cell group; and transmitting, to the UE, an indication of a change from a previous allocation of the UE resources across the first cell group and the second cell group to the allocation of the UE resources across the first cell group and the second cell group based at least in part on the UE capability information, the first CSI, and the second CSI.

Aspect 44: The method of Aspect 43, wherein the indication is included in a radio resource control (RRC) message, a medium access control (MAC) control element (MAC-CE), or downlink control information (DCI).

Aspect 45: The method of any of Aspects 43-44, further comprising: transmitting, to the UE, configuration information indicating a mapping between each candidate allocation, of a set of candidate allocations of the UE resources, and a respective set of parameters to be used for that candidate allocation, wherein the set of candidate allocations of the UE resources is based at least in part on the UE capability information, and wherein the indication indicates a change from a first candidate allocation of the set of candidate allocations of the UE resources to a second candidate allocation of the set of candidate allocations of the UE resources.

Aspect 46: The method of Aspect 42, wherein the second information includes UE assistance information that indicates a request for increasing UE resources allocated for a first one of the first cell group or the second cell group.

Aspect 47: The method of Aspect 46, wherein the UE assistance information further indicates a request for decreasing UE resources allocated for a second one or the first cell group or the second cell group.

Aspect 48: The method of any of Aspects 46-47, further comprising: transmitting, to the UE and based at least in part on the UE assistance information, an indication of the allocation of the UE resources across the first cell group and the second cell group.

Aspect 49: The method of Aspect 42, wherein the second information includes a dynamic capability update that indicates an updated allocation of the UE resources supported by the UE, and further comprising: transmitting, to the UE and based at least in part on the dynamic capability update, an indication of a change from a previous allocation of the UE resources across the first cell group and the second cell group to the allocation of the UE resources across the first cell group and the second cell group.

Aspect 50: The method of Aspect 42, wherein the second information indicates the allocation of the UE resources across the first cell group and the second cell group.

Aspect 51: The method of Aspect 50, further comprising: transmitting, to the UE, an acknowledgement of the second information.

Aspect 52: The method of any of Aspects 50-51, further comprising: transmitting, to the UE, configuration information associated with selection, by the UE, of the allocation of the UE resources across the first cell group and the second cell group.

Aspect 53: The method of any of Aspects 50-52, wherein the allocation of the UE resources across the first cell group and the second cell group includes a time pattern for switching between different allocations of the UE resources across the first cell group and the second cell group.

Aspect 54: The method of any of Aspects 42-53, wherein the UE resources include at least one of radio frequency resources, baseband resources, or UE antennas.

Aspect 55: A method of wireless communication performed by a first network node, comprising: receiving, from a user equipment (UE), first channel state information (CSI) associated with the UE and a first cell group; obtaining, from a second network node, second CSI associated with the UE and a second cell group; and transmitting, to the UE, an indication of a split of data volume across to the first cell group and the second cell group to be used for communications with the UE, wherein the split of the data volume across the first cell group and the second cell group is based at least in part on the first CSI and the second CSI.

Aspect 56: The method of Aspect 55, further comprising: determining the split of the data volume across the first cell group and the second cell group is based at least in part on the first CSI and the second CSI.

Aspect 57: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-56.

Aspect 58: An apparatus for wireless communication at a device, the apparatus comprising one or more memories and one or more processors coupled to the one or more memories, the one or more processors configured to cause the device to perform the method of one or more of Aspects 1-56.

Aspect 59: An apparatus for wireless communication, the apparatus comprising at least one means for performing the method of one or more of Aspects 1-56.

Aspect 60: A non-transitory computer-readable medium storing code for wireless communication, the code comprising instructions executable by one or more processors to perform the method of one or more of Aspects 1-56.

Aspect 61: A non-transitory computer-readable medium storing a set of instructions for wireless communication, the set of instructions comprising one or more instructions that, when executed by one or more processors of a device, cause the device to perform the method of one or more of Aspects 1-56.

Aspect 62: A device for wireless communication, the device comprising a processing system that includes one or more processors and one or more memories coupled with the one or more processors, the processing system configured to cause the device to perform the method of one or more of Aspects 1-56.

Aspect 63: An apparatus for wireless communication at a device, the apparatus comprising one or more memories and one or more processors coupled to the one or more memories, the one or more processors individually or collectively configured to cause the device to perform the method of one or more of Aspects 1-56.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware or a combination of hardware and at least one of software or firmware. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A may also have B). Further, the phrase “based on” is intended to mean “based on or otherwise in association with” unless explicitly stated otherwise. Also, as used herein, the term “or” is intended to be inclusive when used in a series and may be used interchangeably with “and/or,” unless explicitly stated otherwise (for example, if used in combination with “either” or “only one of”). It should be understood that “one or more” is equivalent to “at least one.”

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set.

What is claimed is:

1. A user equipment (UE) for wireless communication, comprising:
one or more memories; and
one or more processors, coupled to the one or more memories, configured to cause the UE to:
transmit, to at least one of a first network node associated with a first cell group or a second network node associated with a second cell group, at least one of:
first information associated with splitting a data volume across the first cell group and the second cell group, or
second information associated with sharing UE resources across the first cell group and the second cell group; and
communicate via the first cell group and the second cell group in accordance with at least one of:
a split of the data volume across the first cell group and the second cell group based at least in part on the first information, or
an allocation of the UE resources across the first cell group and the second cell group based at least in part on the second information.

2. The UE of claim 1, wherein the one or more processors, to cause the UE to transmit the at least one of the first information or the second information, are configured to cause the UE to transmit the first information, and
wherein the one or more processors, to cause the UE to communicate via the first cell group and the second cell group, are configured to cause the UE to communicate via the first cell group and the second cell group in accordance with the split of the data volume across the first cell group and the second cell group based at least in part on the first information.

3. The UE of claim 2, wherein the first information includes UE assistance information that indicates a UE preference for splitting the data volume across the first cell group and the second cell group.

4. The UE of claim 3, wherein the UE assistance information indicates a preferred splitting threshold for splitting the data volume across the first cell group and the second cell group.

5. The UE of claim 3, wherein the UE assistance information indicates a request to increase or decrease a previously signaled splitting threshold for splitting the data volume across the first cell group and the second cell group.

6. The UE of claim 3, wherein the one or more processors are further configured to cause the UE to:
receive, from at least one of the first network node or the second network node and based at least in part on the UE assistance information, an indication of the split of the data volume across the first cell group and the second cell group.

7. The UE of claim 2, wherein the first information indicates the split of the data volume across the first cell group and the second cell group.

8. The UE of claim 7, wherein the first information includes an indication of a splitting threshold that indicates the split of the data volume across the first cell group and the second cell group for at least one of downlink communications or uplink communications.

9. The UE of claim 7, wherein the one or more processors are further configured to cause the UE to:
receive, from at least one of the first network node or the second network node, an acknowledgement of the first information.

10. The UE of claim 7, wherein the one or more processors are further configured to cause the UE to:
select the split of the data volume across the first cell group and the second cell group.

11. The UE of claim 10, wherein the one or more processors, to cause the UE to select the split of the data volume across the first cell group and the second cell group, are configured to cause the UE to:
select the split of the data volume across the first cell group and the second cell group based at least in part on channel state information associated with the first cell group and the second cell group.

12. The UE of claim 10, wherein the one or more processors are further configured to cause the UE to:
receive, from at least one of the first network node or the second network node, configuration information associated with selecting the split of the data volume across the first cell group and the second cell group.

13. The UE of claim 1, wherein the one or more processors, to cause the UE to transmit the at least one of the first information or the second information, are configured to cause the UE to transmit the second information, and
wherein the one or more processors, to cause the UE to communicate via the first cell group and the second cell group, are configured to cause the UE to communicate via the first cell group and the second cell group in accordance with the allocation of the UE resources across the first cell group and the second cell group based at least in part on the second information.

14. The UE of claim 13, wherein the second information includes UE capability information associated with a capability of the UE for sharing the UE resources across the first cell group and the second cell group, and wherein the one or more processors are further configured to cause the UE to:
transmit, to the first network node, first channel state information (CSI) associated with the first cell group;
transmit, to the second network node, second CSI associated with the second cell group; and
receive, from at least one of the first network node and the second network node, an indication of a change from a previous allocation of the UE resources across the first cell group and the second cell group to the allocation of the UE resources across the first cell group and the second cell group based at least in part on the UE capability information, the first CSI, and the second CSI.

15. The UE of claim 14, wherein the one or more processors are further configured to cause the UE to:
receive configuration information indicating a mapping between each candidate allocation, of a set of candidate allocations of the UE resources, and a respective set of parameters to be used for that candidate allocation,
wherein the set of candidate allocations of the UE resources is based at least in part on the UE capability information, and
wherein the indication indicates a change from a first candidate allocation of the set of candidate allocations of the UE resources to a second candidate allocation of the set of candidate allocations of the UE resources.

16. The UE of claim 13, wherein the second information includes UE assistance information that indicates a request for increasing UE resources allocated for a first one of the first cell group or the second cell group.

17. The UE of claim 16, wherein the UE assistance information further indicates a request for decreasing UE resources allocated for a second one or the first cell group or the second cell group.

18. The UE of claim 16, wherein the one or more processors are further configured to cause the UE to:
receive, from at least one of the first network node or the second network node and based at least in part on the UE assistance information, an indication of the allocation of the UE resources across the first cell group and the second cell group.

19. The UE of claim 13, wherein the second information includes a dynamic capability update that indicates an updated allocation of the UE resources supported by the UE, and wherein the one or more processors are further configured to cause the UE to:
receive, from at least one of the first network node or the second network node and based at least in part on the dynamic capability update, an indication of a change from a previous allocation of the UE resources across the first cell group and the second cell group to the allocation of the UE resources across the first cell group and the second cell group.

20. The UE of claim 13, wherein the second information indicates the allocation of the UE resources across the first cell group and the second cell group.

21. The UE of claim 20, wherein the one or more processors are further configured to cause the UE to:
receive, from at least one of the first network node or the second network node, an acknowledgement of the second information.

22. The UE of claim 20, wherein the one or more processors are further configured to cause the UE to:
select the allocation of the UE resources across the first cell group and the second cell group based at least in part on channel state information associated with the first cell group and the second cell group.

23. The UE of claim 22, wherein the one or more processors are further configured to cause the UE to:
receive, from at least one of the first network node or the second network node, configuration information associated with selecting the allocation of the UE resources across the first cell group and the second cell group.

24. The UE of claim 20, wherein the allocation of the UE resources across the first cell group and the second cell group includes a time pattern for switching between different allocations of the UE resources across the first cell group and the second cell group.

25. The UE of claim 13, wherein the UE resources include at least one of radio frequency resources, baseband resources, or UE antennas.

26. A first network node for wireless communication, comprising:
one or more memories; and
one or more processors, coupled to the one or more memories, configured to cause the first network node to:
receive, from a user equipment (UE), at least one of:
first information associated with splitting a data volume across a first cell group associated with the first network node and a second cell group associated with a second network node, or
second information associated with sharing UE resources across the first cell group and the second cell group; and
communicate with the UE in accordance with at least one of:
a split of the data volume across the first cell group and the second cell group based at least in part on the first information, or
an allocation of the UE resources across the first cell group and the second cell group based at least in part on the second information.

27. The first network node of claim 26, wherein the one or more processors, to cause the first network node to receive the at least one of the first information or the second information, are configured to cause the first network node to receive the first information, and
wherein the one or more processors, to cause the first network node to communicate with the UE, are configured to cause the first network node to communicate with the UE in accordance with the split of the data volume across the first cell group and the second cell group based at least in part on the first information.

28. The first network node of claim 26, wherein the one or more processors, to cause the first network node to receive the at least one of the first information or the second information, are configured to cause the first network node to receive the second information, and
wherein the one or more processors, to cause the first network node to communicate with the UE, are configured to cause the first network node to communicate with the UE in accordance with the allocation of the UE resources across the first cell group and the second cell group based at least in part on the second information.

29. A method of wireless communication performed by a user equipment (UE), comprising:
transmitting, to at least one of a first network node associated with a first cell group or a second network node associated with a second cell group, at least one of:
first information associated with splitting a data volume across the first cell group and the second cell group, or
second information associated with sharing UE resources across the first cell group and the second cell group; and
communicating via the first cell group and the second cell group in accordance with at least one of:
a split of the data volume across the first cell group and the second cell group based at least in part on the first information, or
an allocation of the UE resources across the first cell group and the second cell group based at least in part on the second information.

30. A method of wireless communication performed by a first network node, comprising:
receiving, from a user equipment (UE), at least one of:
first information associated with splitting a data volume across a first cell group associated with the first network node and a second cell group associated with a second network node, or
second information associated with sharing UE resources across the first cell group and the second cell group; and
communicating with the UE in accordance with at least one of:
a split of the data volume across the first cell group and the second cell group based at least in part on the first information, or
an allocation of the UE resources across the first cell group and the second cell group based at least in part on the second information.
